(19) United States
(12) Patent Application Publication
(10) Pub. No.: US 2025/0293256 A1
(43) Pub. Date: Sep. 18, 2025

(54) INSULATING LAYER-FORMING LIQUID COMPOSITION, ELECTRODE AND METHOD FOR PRODUCING SAME, AND SEPARATOR AND METHOD FOR PRODUCING SAME

(71) Applicants: Minehide KUSAYANAGI, Kanagawa (JP); Dai AYA, Kanagawa (JP); Tomoya OHMURA, Kanagawa (JP); Takaaki KONNO, Kanagawa (JP); Takuya SAIGA, Kanagawa (JP); Naoki SHIRAISHI, Tokyo (JP)

(72) Inventors: Minehide KUSAYANAGI, Kanagawa (JP); Dai AYA, Kanagawa (JP); Tomoya OHMURA, Kanagawa (JP); Takaaki KONNO, Kanagawa (JP); Takuya SAIGA, Kanagawa (JP); Naoki SHIRAISHI, Tokyo (JP)

(21) Appl. No.: 19/077,267

(22) Filed: Mar. 12, 2025

(30) Foreign Application Priority Data
Mar. 15, 2024 (JP) 2024-040893

(51) Int. Cl. H01M 4/62; H01M 4/04; H01M 4/36; H01M 50/403; H01M 50/426; H01M 50/451

(52) U.S. Cl. CPC H01M 4/62; H01M 4/0404; H01M 4/366; H01M 50/403; H01M 50/426; H01M 50/451

(57) ABSTRACT

An insulating layer-forming liquid composition is provided that includes: insulating inorganic particles; a resin including at least one of a structural unit represented by general formula (1), a structural unit represented by general formula (2), or a structural unit represented by general formula (3), in an amount of 0.1% by mass or more and 5% by mass or less of the insulating inorganic particles; a resin including a structural unit represented by general formula (4), in an amount of 0.1% by mass or more and 5% by mass or less of the insulating inorganic particles; and a resin including fluorine atoms, in an amount of 1% by mass or more and 8% by mass or less of the insulating inorganic particles.

### CROSS-REFERENCE TO RELATED APPLICATION

This patent application is based on and claims priority pursuant to 35 U.S.C. § 119 (a) to Japanese Patent Application No. 2024-040893, filed on Mar. 15, 2024, in the Japan Patent Office, the entire disclosure of which is hereby incorporated by reference herein.

### BACKGROUND

### Technical Field

The present disclosure relates to an insulating layer-forming liquid composition, an electrode and a method for producing the same, and a separator and a method for producing the same.

### Related Art

Electrochemical elements such as lithium-ion secondary batteries exhibit high energy density, and are expected to be used as large-capacity power sources for electric vehicles and the like. In recent years, separators in electrochemical elements have become thinner in order to improve the volumetric energy density, and enhanced safety is being sought.

### SUMMARY

Embodiments of the present invention provides an insulating layer-forming liquid composition including:
insulating inorganic particles;
a resin including at least one of a structural unit represented by general formula (1) below, a structural unit represented by general formula (2) below, or a structural unit represented by general formula (3) below, in an amount of 0.1% by mass or more and 5% by mass or less of the insulating inorganic particles;
a resin including a structural unit represented by general formula (4) below, in an amount of 0.1% by mass or more and 5% by mass or less of the insulating inorganic particles; and
a resin including fluorine atoms, in an amount of 1% by mass or more and 8% by mass or less of the insulating inorganic particles:

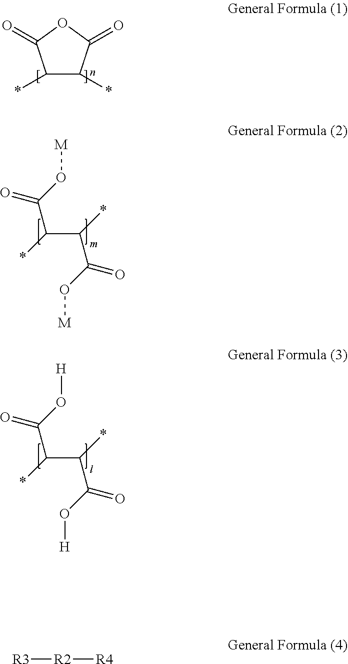

where, in general formulas (1) to (4), * represents a bonding site with an adjacent main chain structural unit, R2 represents at least one of polyurethane, polyester, polyethylene oxide, polypropylene oxide, poloxamer, polycarbonate, silicone, polybutadiene, or hydrogenated polybutadiene butane, R3 and R4 each independently represent a hydroxyl group or an amino group, M represents an ammonium salt, and n, m, and l each independently represent an integer from 2 to 500.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating an electrode according to an embodiment of the present invention;

FIG. 2A is a schematic cross-sectional view taken along line A-A′ in FIG. 1;

FIG. 2B is a schematic cross-sectional view of an electrode according to an embodiment of the present invention;

FIG. 2C is a schematic cross-sectional view of an electrode according to an embodiment of the present invention;

FIG. 3A is a schematic cross-sectional view of an electrode according to an embodiment of the present invention;

FIG. 3B is a schematic cross-sectional view of an electrode according to an embodiment of the present invention;

FIG. 4 is a schematic diagram illustrating an insulating layer on an electrode according to an embodiment of the present invention;

FIG. 5 is a schematic diagram illustrating an insulating layer on an electrode according to an embodiment of the present invention;

FIG. 6 is a schematic cross-sectional view of an electrode obtained by an insulating layer-forming liquid composition drying step according to an embodiment of the present invention;

FIG. 7 is a schematic diagram illustrating an electrode production apparatus according to an embodiment of the present invention; and

FIG. 8 is a schematic diagram illustrating an electrochemical element according to an embodiment of the present invention.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a”, “an”, and “the” are intended to include the plural forms as well, unless the context clearly indicates otherwise.

According to embodiments of the present invention, an insulating layer-forming liquid composition is provided that can produce an insulating layer having excellent film strength and an electrochemical element having excellent electrochemical properties, and has excellent ejection properties and storage stability.

From the viewpoint of improving the volumetric energy density of an electrochemical element, an insulating layer provided adjacent to the electrode composite layer is preferably applied thinly and uniformly on the substrate to be coated. For this reason, it is preferable that the insulating layer-forming liquid composition that forms the insulating particle layer includes insulating inorganic particles at a high concentration, and has a low viscosity.

The insulating layer-forming liquid composition according to an embodiment of the present invention can produce an insulating layer having excellent film strength and an electrochemical element having excellent electrochemical properties. Further, the insulating layer-forming liquid composition having excellent ejection properties and storage stability.

The details of embodiments of the present invention will be described below.

### (Insulating Layer-Forming Liquid Composition)

The insulating layer-forming liquid composition according to an embodiment of the present invention includes: insulating inorganic particles; a resin including at least one of a structural unit represented by general formula (1), a structural unit represented by general formula (2), or a structural unit represented by general formula (3); a resin including a structural unit represented by general formula (4); a resin including fluorine atoms; and if preferable, a solvent and other components.

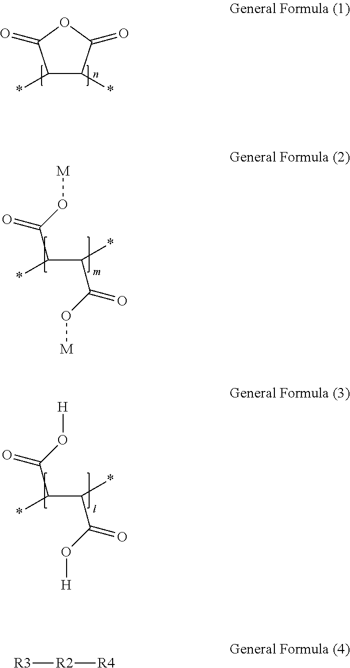

(where, in general formulas (1) to (4), * represents a bonding site with an adjacent main chain structural unit, R2 represents at least one of polyurethane, polyester, polyethylene oxide, polypropylene oxide, poloxamer, polycarbonate, silicone, polybutadiene, or hydrogenated polybutadiene butane, R3 and R4 each independently represent a hydroxyl group or an amino group, M represents an ammonium salt, and n, m, and l each independently represent an integer from 2 to 500)

Note that the dicarboxyl group and the salt of the structural unit represented by general formula (2) and the structural unit represented by general formula (3) are illustrated in a trans configuration. However, a cis configuration is also possible.

Herein, the “insulating layer-forming liquid composition” is sometimes simply referred to as a “liquid composition”.

Herein, the “resin including at least one of a structural unit represented by general formula (1), a structural unit represented by general formula (2), or a structural unit represented by general formula (3)” is sometimes referred to as a “dispersant including at least one of a structural unit represented by general formula (1), a structural unit represented by general formula (2), or a structural unit represented by general formula (3)”, a “dispersant”, or an “insulating layer dispersant”.

Herein, the “resin including a structural unit represented by general formula (4)” is sometimes referred to as a “crosslinking agent including a structural unit represented by general formula (4)”, or a “crosslinking agent”.

Herein, the “resin including fluorine atoms” is sometimes referred to as a “binder including fluorine atoms”, a “binder”, or an “insulating layer binder”.

### <Insulating Inorganic Particles>

Herein, “insulating” indicates a volume resistivity value of 10⁸ Ω·cm or more. That is, the insulating inorganic particles according to embodiments of the present invention represent inorganic particles having a volume resistivity value of 10⁸ Ω·cm or more.

The insulating inorganic particles are not particularly limited, and can be selected as appropriate according to the intended purpose as long as the volume resistivity value is 10⁸ Q·cm or more. Examples of the insulating inorganic particles include, but are not limited to, aluminum oxide (alumina), boehmite, silica, aluminum nitride, silicon nitride, cordierite, sialon, mullite, stearite, yttria, zirconia, and silicon carbide. Among such insulating inorganic particles, inorganic oxides are preferable, and from the viewpoint of the heat resistance, aluminum oxide and boehmite are more preferable, and α-alumina is even more preferable.

Note that α-alumina is known to function as a scavenger for “junk” chemical species, that is, as a scavenger for chemical species that can cause capacity fading in a lithium-ion secondary battery. Furthermore, because alumina particles have good wettability and affinity with respect to electrolytes, the cycling performance of the lithium ion secondary battery is improved. As a result of using α-alumina as the insulating inorganic particles, the redispersibility and inkjet ejection properties of the liquid composition are improved, and the heat resistance of the insulating layer is improved.

The insulating inorganic particles mentioned above may be used alone or as a combination of two or more types.

The shape of the insulating inorganic particles is not particularly limited, and can be selected as appropriate according to the intended purpose. Examples of the shape include, but are not limited to, a rectangle shape, a spherical shape, an ellipse shape, a cylinder shape, an egg shape, a dog-bone shape, and an amorphous shape.

The median diameter of the insulating inorganic particles is not particularly limited, and can be selected as appropriate according to the intended purpose, but is preferably 200 nm or more and 1,000 nm or less.

When the insulating inorganic particles have a median diameter of 200 nm or more, the particles can be prevented from floating in the air (generating mist) during inkjet ejection. Furthermore, in the insulating layer, the insulating inorganic particles can be prevented from adhering to the substrate due to loss of the fine particles.

When the insulating inorganic particles have a median diameter of 1,000 nm or less, nozzle clogging during inkjet ejection can be resolved, which improves the ejection properties. Furthermore, such a median diameter is preferable because, in the insulating layer, the thickness of the insulating layer is made uniform and homogenous (has less unevenness).

The method of measuring the median diameter of the insulating inorganic particles is not particularly limited, and can be selected as appropriate according to the intended purpose. Examples of the measurement method include, but are not limited to, the dynamic light scattering method/photon correlation method, laser diffraction, the centrifugal sedimentation method, and the induced diffraction method. More specifically, after diluting the liquid composition so that the solid content is 10% by mass or less, measurements can be performed using a concentrated particle size analyzer (FPAR-1000, manufactured by Otsuka Electronics Co., Ltd.) or a multi-analyte nanoparticle size measurement system (nanoSAQLA, manufactured by Otsuka Electronics Co., Ltd.).

The insulating inorganic particles preferably include first insulating inorganic particles having a median diameter of 200 nm or more and less than 1,000 nm, and second insulating inorganic particles having an average Stokes diameter of less than 30 nm. For example, the average Stokes diameter refers to the average value of the major axis of particles measured by observation with a transmission electron microscope (TEM).

When the second insulating inorganic particles having an average Stokes diameter of less than 30 nm are included, the energy barrier in the interaction potential energy between the particles can be sufficiently reduced. Therefore, the problem of the inorganic particles not being able to be redispersed even with reagitation when the liquid composition is left to stand for a long period of time can be resolved, and the inorganic particles have aggregated with each other.

The content of the insulating inorganic particles is not particularly limited, and can be selected as appropriate according to the intended purpose. However, from the viewpoint of making the thickness of the insulating layer uniform after drying, the content is preferably 10% by mass or more, and more preferably 20% by mass or more relative to the total amount of the liquid composition. Furthermore, from the viewpoint of the viscosity, the content is preferably 60% by mass or less relative to the total amount of the liquid composition. Also, from the viewpoint of the inkjet ejection properties, the content is more preferably 55% by mass or less relative to the total amount of the liquid composition.

The insulating inorganic particles may be synthesized as appropriate, or commercially available products may be used.

Examples of commercially available aluminum oxide serving as the insulating inorganic particles include, but are not limited to, products having the trade names AKP-15, AKP-20, AKP-30, AKP-50, AKP-53, AKP-700, AKP-3000, AA-03, AA-04, AA-05, AA-07, AA-1.5, AKP-G07, and AKP-G15 (all high-purity alumina, manufactured by Sumitomo Chemical Co., Ltd.), TM-DA, TM-DAR, and TM-5D (all manufactured by Taimei Chemical Industry Co., Ltd.), CT-3000LSSG (manufactured by Almatis), LS-502, LS-711CB, and SLS-710 (manufactured by Nippon Light Metal Co., Ltd.), and SEPal-60, and SEPal-70 (manufactured by Alteo).

Examples of commercially available boehmite serving as the insulating inorganic particles include, but are not limited to, a product having the trade name BMB-07 (manufactured by Kawai Lime Industry Co., Ltd.).

### <Dispersant>

The dispersant according to an embodiment of the present invention includes at least one of a structural unit represented by general formula (1), a structural unit represented by general formula (2), or a structural unit represented by general formula (3).

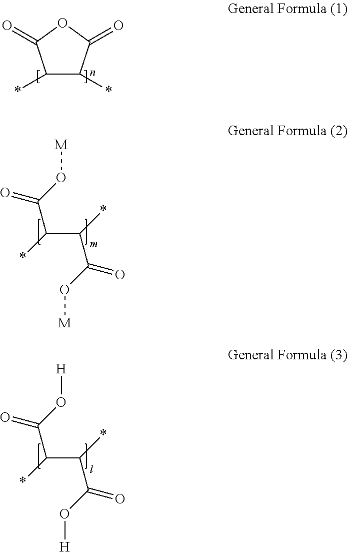

(where, in general formulas (1) to (3), * represents a bonding site with an adjacent main chain structural unit, M represents an ammonium salt, and n, m, and l each independently represent an integer from 2 to 500)

The acid anhydride group and the carboxyl group in the structural units represented by general formulas (1) to (3) provide a repulsive effect between the dispersant molecules due to steric hindrance. Therefore, by adding a dispersant having a carboxyl group to the liquid composition, because the insulating inorganic particles in the liquid composition can be uniformly dispersed as primary particles, and the dispersed state can be maintained for a long period of time without reaggregation, the storage stability improves.

Because the acid anhydride group and the carboxyl group in the structural units represented by the general formulas (1) to (3) have excellent dispersion stability in the insulating layer-forming binder, the thixotropy of the liquid composition can be reduced. Also, the carboxyl group and the acid anhydride group can improve the inkjet ejection properties due to the effects of each group.

The value of n in general formula (1) is not particularly limited, and can be selected as appropriate according to the intended purpose, but is preferably an integer from 10 to 100.

The value of m in general formula (2) is not particularly limited, and can be selected as appropriate according to the intended purpose, but is preferably an integer from 10 to 100.

The value of 1 in general formula (3) is not particularly limited, and can be selected as appropriate according to the intended purpose, but is preferably an integer from 10 to 100.

The method of confirming whether or not the dispersant in the insulating layer-forming liquid composition includes the structural units represented by general formulas (1) to (3) is not particularly limited, and can be selected as appropriate according to the intended purpose. Examples of the method include, but are not limited to, a nuclear magnetic resonance (NMR) device, and Fourier transform infrared spectroscopy (FT-IR).

The content of the dispersant in the insulating layer-forming liquid composition according to an embodiment of the present invention is 1% by mass or more and 10% by mass or less, is preferably 1.5% by mass or more and 8% by mass or less, and more preferably 2% by mass or more and 6% by mass or less relative to the total amount of the insulating inorganic particles.

When the content of the dispersant in the insulating layer-forming liquid composition is 1% by mass or more relative to the total amount of the insulating inorganic particles, the effect of dispersing the insulating inorganic particles can be sufficiently obtained, and the dispersed state can be maintained. Accordingly, the storage stability and the inkjet ejection properties can be improved. Furthermore, in the resulting insulating layer, because the surfaces of the insulating inorganic particles are covered, the loss of the insulating inorganic particles from the insulating layer can be prevented.

When the content of the dispersant in the insulating layer-forming liquid composition is 10% by mass or less relative to the total amount of the insulating inorganic particles, the thixotropy can be reduced. In addition, in the resulting insulating layer (electrochemical element), problems can be resolved such as a decrease in output due to an increase in battery resistance, and a decrease in cycle characteristics.

The molecular weight of the dispersant in the insulating layer-forming liquid composition is not particularly limited, and can be selected as appropriate according to the intended purpose. For example, the number average molecular weight is preferably 1,000 or more and 100,000 or less.

As a result of the number average molecular weight of the dispersant in the insulating layer-forming liquid composition being 1,000 or more, the dispersibility of the insulating inorganic particles improves, which also improves the storage stability.

As a result of the number average molecular weight of the dispersant in the insulating layer-forming liquid composition being 100,000 or less, excellent inkjet ejection properties can be obtained.

The method of analyzing the molecular weight of the dispersant in the insulating layer-forming liquid composition is not particularly limited, and can be selected as appropriate according to the intended purpose. For example, a measurement can be performed by gel permeation chromatography (HLC8320-GPC, manufactured by Shimadzu Corporation).

The dispersant is preferably independently dissolved in an electrolytic solvent.

As a result of the dispersant being independently dissolved in an electrolytic solvent, the resulting insulating layer has good lithium ion conductivity.

Note that the term “dissolved” used herein refers to a state in which the desired molecule is uniformly mixed in a dispersion medium.

The electrolytic solvent is not particularly limited, and can be selected as appropriate according to the intended purpose. Examples of the electrolytic solvent include, but are not limited to, non-polar solvents and mixtures containing non-polar solvents (mixed solvents).

Note that, herein, a non-polar solvent is a solvent having a bond dipole moment of 1.15 D or less.

The method of confirming whether or not the dispersant is dissolved in the electrolytic solvent is not particularly limited, and can be selected as appropriate according to the intended purpose. For example, after dissolving the dispersant in the electrolytic solvent, it can be determined that the dispersant is dissolved if no distribution is observed when the particle size distribution is evaluated. If a particle size distribution is observed, it is determined that the dispersant is dispersed.

The solubility of the dispersant in the electrolytic solvent may be confirmed under conditions in which the electrolytic solvent is a liquid. For example, the solubility in dimethyl carbonate, which is used as a non-aqueous electrolytic solvent, may be confirmed at 25° C. and a pressure of 1 atmosphere.

The dispersant may be synthesized as appropriate, or commercially available products may be used.

Examples of commercially available dispersants include, but are not limited to, MARIALIM (registered trademark) AAB-0851, MARIALIM AFB-1521, MARIALIM AKM-0531, MARIALIM AWS-0851, MARIALIM HKM-50A, MARIALIM HKM-150A, MARIALIM SC-0708A, MARIALIM SC-0505K, MARIALIM SC-1015F, AKM-1511-60 (all manufactured by NOF Corporation), DIACARNA (registered trademark) 30M (manufactured by Mitsubishi Chemical Corporation), and ISOBAM (registered trademark)-10 (manufactured by Kuraray Co., Ltd.).

### <Crosslinking Agent>

The crosslinking agent according to an embodiment of the present invention includes a structural unit represented by general formula (4).

R3-R2-R4 General Formula (4)

(where, in general formula (4), R2 represents at least one of polyurethane, polyester, polyethylene oxide, polypropylene oxide, poloxamer, polycarbonate, silicone, polybutadiene, or hydrogenated polybutadiene butane, and R3 and R4 each independently represent a hydroxyl group or an amino group)

In general formula (4), R2 may have a repeating unit. In such a case, the number of repeating units represented by R2 is not particularly limited, and can be selected as appropriate according to the intended purpose. However, from the viewpoint of preventing inhibition of crosslinking due to steric hindrance, the number of repeating units is preferably 2 to 100, and more preferably 10 to 50.

From the viewpoint of promoting Li ion conduction, R2 in general formula (4) is preferably a poloxamer. Note that the term “poloxamer” used herein refers to a block copolymer composed of polyethylene oxide and polypropylene oxide.

From the viewpoint of the crosslinking reaction becoming more likely to occur, it is preferable that the number of repeating units of polypropylene oxide is smaller than the number of repeating units of polyethylene oxide in the poloxamer.

From the viewpoint of the storage stability, it is preferable that at least one of R3 or R4 in general formula (4) is a hydroxyl group, and it is more preferable that both of R3 and R4 are hydroxyl groups.

The method of confirming whether or not the crosslinking agent in the insulating layer-forming liquid composition includes the structural units represented by general formula (4) is not particularly limited, and can be selected as appropriate according to the intended purpose. Examples of the method include, but are not limited to, a nuclear magnetic resonance (NMR) device, and Fourier transform infrared spectroscopy (FT-IR).

The content of the crosslinking agent in the insulating layer-forming liquid composition according to an embodiment of the present invention is 0.1% by mass or more and 5% by mass or less, is preferably 0.3% by mass or more and 4% by mass or less, and more preferably 0.5% by mass or more and 3% by mass or less relative to the total amount of the insulating inorganic particles.

When the content of the crosslinking agent in the insulating layer-forming liquid composition is 0.1% by mass or more relative to the total amount of the insulating inorganic particles, the problem of the dispersant and the crosslinking agent being eluted when the crosslinked resin obtained due to a reaction between the dispersant and the crosslinking agent is insufficient can be resolved, and the temperature of the resulting electrochemical element rises.

When the content of the crosslinking agent in the insulating layer-forming liquid composition is 5% by mass or less relative to the total amount of the insulating inorganic particles, in the resulting insulating layer (electrochemical element), problems can be resolved such as a decrease in output due to an increase in battery resistance caused by the resin component, and a decrease in cycle characteristics.

The molecular weight of the crosslinking agent in the insulating layer-forming liquid composition is not particularly limited, and can be selected as appropriate according to the intended purpose. For example, the number average molecular weight is preferably 200 or more and 100,000 or less.

As a result of the number average molecular weight of the crosslinking agent in the insulating layer-forming liquid composition being 200 or more, the resultant structure can be imparted with flexibility.

As a result of the number average molecular weight of the crosslinking agent in the insulating layer-forming liquid composition being 100,000 or less, a rise in the viscosity of the liquid composition can be prevented.

The method of analyzing the molecular weight of the crosslinking agent in the insulating layer-forming liquid composition is not particularly limited, and can be selected as appropriate according to the intended purpose. For example, a measurement can be performed by gel permeation chromatography (HLC8320-GPC, manufactured by Shimadzu Corporation).

The crosslinking agent is preferably independently dissolved in an electrolytic solvent.

As a result of the crosslinking agent being independently dissolved in an electrolytic solvent, the resulting insulating layer (electrochemical element) has good lithium ion conductivity.

Note that the term “dissolved” used herein refers to a state in which the desired molecule is uniformly mixed in a dispersion medium.

The method of confirming whether or not the crosslinking agent is dissolved in the electrolytic solvent is not particularly limited, and can be selected as appropriate according to the intended purpose. For example, after dissolving the crosslinking agent in the electrolytic solvent, it can be determined that the crosslinking agent is dissolved if no distribution is observed when the particle size distribution is evaluated. If a particle size distribution is observed, it is determined that the crosslinking agent is dispersed.

The solubility of the crosslinking agent in the electrolytic solvent may be confirmed under conditions in which the electrolytic solvent is a liquid. For example, the solubility in dimethyl carbonate, which is used as a non-aqueous electrolytic solvent, may be confirmed at 25° C. and a pressure of 1 atmosphere.

The crosslinking agent may be synthesized as appropriate, or commercially available products may be used.

Examples of commercially available crosslinking agents include, but are not limited to, Epan (registered trademark) 740 (manufactured by Daiichi Kogyo Seiyaku Co., Ltd., R2: poloxamer), Epan 450 (manufactured by Daiichi Kogyo Seiyaku Co., Ltd.), Jeffamine ED-2003 (manufactured by Huntsman Corporation), Jeffamine D-2000 (manufactured by Huntsman Corporation), DBE (registered trademark)-C25 (manufactured by Gelest), and DULANOL T5650E (manufactured by Asahi Kasei Corporation), ETERNACOLL (registered trademark)-PH200J (manufactured by Ube Industries Co., Ltd.), NISSO (registered trademark)-PB-G1000 (manufactured by Nippon Soda Co., Ltd.), PEG200 (manufactured by Tokyo Chemical Industry Co., Ltd.), UNILUBE 5TP-300 KB (manufactured by NOF Corporation, R2: poloxamer), NYMEEN (registered trademark) L207 (manufactured by NOF Corporation), NYMEEN DT208 (manufactured by NOF Corporation), K-FLEX UD-320-100 (manufactured by Kings Industries), K-FLEX 148 (manufactured by Kings Industries), and K-FLEX 188 (manufactured by Kings Industries).

### <Binder>

The binder according to an embodiment of the present invention includes fluorine atoms. As a result of the insulating layer binder including fluorine atoms, in a case where the insulating layer is formed on the positive electrode or on a separator facing the positive electrode, oxidation resistance can be obtained with respect to the oxidation potential of the positive electrode.

The method of analyzing whether or not the binder in the insulating layer-forming liquid composition includes fluorine is not particularly limited, and can be selected as appropriate according to the intended purpose. For example, a measurement can be performed by SEM-EDX (Phenom ProX benchtop SEM, manufactured by Thermo Fisher Scientific Inc.) or TOF-SIMS (TOF-SIMS.5, manufactured by IONTOF GmbH).

The insulating layer binder preferably includes a fluororesin.

The fluororesin is not particularly limited, and can be selected as appropriate according to the intended purpose. However, the fluororesin preferably contains at least one of PVDF (polyvinylidene difluoride), PVDF-HFP (poly(vinylidene fluoride-hexanuopropylene), poly(vinylidene fluoride-co-hexafluoropropylene)), PTFE (polytetrafluoroethylene), or PEVE (perfluoroethylvinyl ether).

The method of confirming whether or not the binder in the insulating layer-forming liquid composition includes the compounds above is not particularly limited, and can be selected as appropriate according to the intended purpose. Examples of the method include, but are not limited to, Fourier transform infrared spectroscopy (FT-IR).

From the viewpoint of improving the film strength, it is more preferable that the insulating layer binder uses a combination of a fluororesin and an acrylic resin. Furthermore, from the viewpoint of improving the dispersibility of the solid component in the insulating layer-forming liquid composition, the fluororesin and the acrylic resin more preferably have an interpenetrated polymer network structure (IPN), that is, a structure in which a plurality of polymer molecules exist independently and are entangled with each other without having a crosslinked network structure due to chemical bonds. The acrylic resin may have a crosslinked structure in addition to an interpenetrated polymer network structure.

When a combination of a fluororesin and an acrylic resin is used as the insulating layer binder, from the viewpoint of the chemical stability and the viewpoint of improving the ejection properties of the insulating layer-forming liquid composition, the content of the fluororesin is preferably 50% by mass or more, more preferably 65% by mass or more, and even more preferably 70% by mass or more relative to the total amount of the insulating layer binder.

In addition, the content of the acrylic resin is preferably 40% by mass or less, more preferably 35% by mass or less, and even more preferably 30% by mass or less relative to the total amount of the insulating layer binder.

The content of the binder in the insulating layer-forming liquid composition according to an embodiment of the present invention is 1% by mass or more and 8% by mass or less, is preferably 1.5% by mass or more and 7% by mass or less, and more preferably 2% by mass or more and 5% by mass or less relative to the total amount of the insulating inorganic particles.

When the content of the binder in the insulating layer-forming liquid composition is 1% by mass or more and 8% by mass or less relative to the insulating inorganic particles, the binder can be unevenly distributed on the surface of the insulating layer when the insulating layer is formed, which improves the abrasion strength of the insulating layer, and can reduce the element resistance of the electrochemical element.

Also, when the content of the binder in the insulating layer-forming liquid composition is 1% by mass or more relative to the total amount of the insulating inorganic particles, the binding properties between the insulating inorganic particles improve, which improves the film strength of the resulting insulating layer.

In addition, when the content of the binder in the insulating layer-forming liquid composition is 8% by mass or less relative to the total amount of the insulating inorganic particles, in the resulting insulating layer (electrochemical element), problems can be resolved such as a decrease in output due to an increase in battery resistance caused by the resin, and a decrease in cycle characteristics.

The insulating layer-forming binder is preferably dispersed independently in the electrolytic solvent.

The insulating layer-forming binder being independently dispersed in the electrolytic solvent indicates that the dispersed state is stable, and that the affinity toward the electrolytic solvent is high. Consequently, the resulting insulating layer has good lithium ion conductivity.

The method of determining whether or not the insulating layer-forming binder is dispersed in the electrolytic solvent is not particularly limited, and can be selected as appropriate according to the intended purpose. For example, the determination can be made by firstly drying an aqueous dispersion or a dispersion in a solvent to initially turn the dispersion into a solid, and confirming whether or not solid precipitates are produced when the insulating layer-forming binder is added to an electrolytic solvent (for example, dimethyl carbonate) such that the binder is 1% relative to the electrolytic solvent, and then stirred.

The insulating layer binder may be synthesized as appropriate, or commercially available products may be used.

Examples of commercially available insulating layer binders include, but are not limited to, Kynar Flex (registered trademark) LBG2200LX, Kynar Aquatec (registered trademark) ARC, Kynar Aquatec CRX, Kynar Aquatec FMA-12 (all manufactured by Arkema), LUMIFLON FE4300 (manufactured by AGC Inc.), and MPT-N8 (manufactured by Mitsubishi Pencil Co., Ltd.).

Of the binders above, commercially available products of insulating layer binders using a combination of a fluororesin and an acrylic resin having an interpenetrated polymer network structure are Kynar Aquatec ARC, Kynar Aquatec CRX, and Kynar Aquatec FMA-12 (all manufactured by Arkema).

Of the binders above, commercially available products of insulating layer binders in which the content of the fluororesin is 60% by mass or more relative to the total amount of the insulating layer binder are Kynar Aquatec ARC (manufactured by Arkema) and Kynar Aquatec CRX (manufactured by Arkema).

Of the binders above, the trade names of the commercially available insulating layer binders that disperse in an electrolytic solvent are Kynar Flex LBG2200LX, Kynar Aquatec ARC, and Kynar Aquatec CRX.

### <Solvent>

The insulating layer-forming liquid composition according to an embodiment of the present invention may include a solvent.

Herein, the solvent of the insulating layer-forming liquid composition is sometimes referred to as “insulating layer solvent”.

The insulating layer solvent is water or a water-based solvent. In the case of application to the positive electrode, deterioration of the battery characteristics due to a reaction between the active material and water is expected. Therefore, the solvent is preferably a non-aqueous solvent, which may contain a small amount of water.

In a case where the insulating layer solvent includes water, a water content in the insulating layer-forming liquid composition of less than 10% is preferable in that the water component can be removed prior to application by using a drying agent, such as molecular sieves. When the water component is removed using molecular sieves or the like, because the solid concentration increases by the amount in which the water component in the insulating layer-forming liquid composition has decreased, there is a tendency for the viscosity of the insulating layer-forming liquid composition to increase. In such a case, it is preferable to dilute the mixture with another solvent, and adjust the viscosity as appropriate. On the other hand, when no reaction that leads to deterioration of the battery characteristics will occur under the drying conditions of the application process, the mixture may be used while still including the water.

The non-aqueous solvent is not particularly limited, and can be selected as appropriate long as the solvent does not completely dissolve the insulating layer binder. Examples of the non-aqueous solvent include methanol, ethanol, n-propanol, isopropanol (IPA), n-butanol, isobutanol, tert-butanol, n-pentanol, n-hexanol, butyl acetate, ethyl lactate, ethylene carbonate, ethylene glycol diacetate, propylene glycol, ethylene glycol, isopropyl alcohol, ethylene glycol, triethylene glycol, hexylene glycol, propylene glycol, diacetone alcohol, and cyclohexanol.

These solvents may be used as a single type, or as a combination of two or more types.

The content of the solvent is not particularly limited, and can be selected as appropriate according to the intended purpose. For example, the content can be set to 30% by mass or more and 80% by mass or less relative to the total amount of the liquid composition.

### <Other Components>

The insulating layer-forming liquid composition according to an embodiment of the present invention may include, as other components, a surfactant, a pH adjuster, a rust inhibitor, a preservative, an antifungal agent, an antioxidant, a reduction inhibitor, an evaporation accelerator, a chelating agent, and the like, for the purpose of viscosity adjustment, particle size adjustment, surface tension adjustment, evaporation control of a non-aqueous solvent, additive solubility improvement, particle dispersibility improvement, sterilization, and the like.

The content of the other components is not particularly limited, and can be set as appropriate according to the content of each component in the liquid composition.

### [Viscosity]

The viscosity of the insulating layer-forming liquid composition according to an embodiment of the present invention is not particularly limited, and can be selected as appropriate according to the intended purpose. However, from the viewpoint of improving the inkjet ejection properties, the viscosity is preferably 5.0 mPa·s or more and 30 mPa·s or less, and more preferably 12 mPa·s or less at 25° C. and a pressure of 1 atmosphere.

The method of measuring the viscosity of the insulating layer-forming liquid composition according to an embodiment of the present invention is not particularly limited, and can be selected as appropriate according to the intended purpose. For example, the measurement can be performed using a b-type viscometer (TVE-25L, manufactured by Toki Sangyo Co., Ltd.) with a standard rotor 1°34′×R24.

### [Surface Tension]

The surface tension of the insulating layer-forming liquid composition according to an embodiment of the present invention is not particularly limited, and can be selected as appropriate according to the intended purpose. However, from the viewpoint of improving the inkjet ejection properties, the surface tension is preferably 25 mN/m or more and 40 mN/m or less.

### <Method for Producing Insulating Layer-Forming Liquid Composition>

The method for producing the insulating layer-forming liquid composition according to an embodiment of the present invention is not particularly limited, and can be selected as appropriate according to the intended purpose. For example, the insulating layer-forming liquid composition can be obtained by adding and dispersing, with respect to a dispersion liquid in which insulating inorganic particles and a dispersant have been dispersed in a solvent A, a solvent B in which an insulating layer-forming binder and other components have been dissolved. Note that the solvent A and the solvent B may be the same solvent, or different solvents may be used.

The preparation of the dispersion liquid can be performed in a dispersion machine after pre-stirring the solvent, the insulating inorganic particles, and the dispersant. The dispersion machine is not particularly limited, and can be selected as appropriate according to the intended purpose. Examples include, but are not limited to, a stirrer, a ball mill, a bead mill, a ring mill, a high-pressure dispersion machine, a rotary high-speed shearing device, and an ultrasonic dispersion machine.

The insulating layer-forming liquid composition is preferably used by being applied to a medium to be coated.

The medium to be coated is not particularly limited, and can be selected as appropriate according to the intended purpose. Examples of the medium to be coated include, but are not limited to, a medium (porous body) that is capable of absorbing the insulating layer-forming liquid composition. More specifically, examples of the medium to be coated include, but are not limited to, plain paper, a medium in which an ink receiving layer is formed by coating a base sheet with porous particles, a base layer used in a reflective display element, and an electrode layer used in printed electronics.

Furthermore, in a case where an electrode having an electrode composite layer formed on an electrode substrate is used as the medium to be coated, a separator-integrated electrode or the like can be produced.

### (Electrode)

The electrode according to an embodiment of the present invention includes: a substrate; an electrode composite layer provided on a portion of the substrate; and an insulating layer that covers an interface portion between a substrate-exposed portion in which the substrate is exposed, and the electrode composite layer; wherein the insulating layer includes insulating inorganic particles, a resin including fluorine atoms, a crosslinked resin including at least one of a structural unit represented by general formula (5) below or a structural unit represented by general formula (6) below, and other members and other components if preferable.

Note that the insulating layer of the electrode according to an embodiment of the present invention is formed of the insulating layer-forming liquid composition according to an embodiment of the present invention. Therefore, descriptions that overlap with descriptions under the heading (Insulating Layer-Forming Liquid Composition) herein will be omitted.

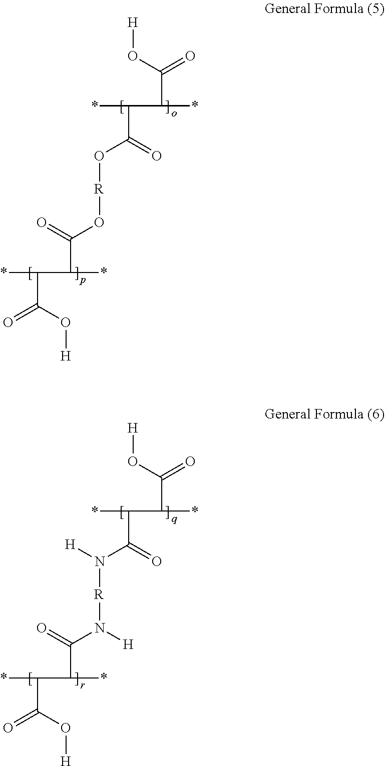

(where, in general formulas (5) and (6), * represents a bonding site with an adjacent main chain structural unit, R represents a structure of at least one of polyurethane, polyester, polyethylene oxide, polypropylene oxide, poloxamer, polycarbonate, silicone, polybutadiene, or hydrogenated polybutadiene butane, and o, p, q, and r each independently represent an integer from 2 to 500)

Here, embodiments of the present invention will be described with reference to the drawings. However, the present invention is in no way limited to the embodiments below.

Note that, in each drawing, the same components are denoted by the same reference numerals, and duplicate descriptions may be omitted. Furthermore, the number, position, shape, and the like, of the constituent members described below are not limited to those in the present embodiment, and can be set to a preferable number, position, shape, and the like, when the present embodiment is implemented.

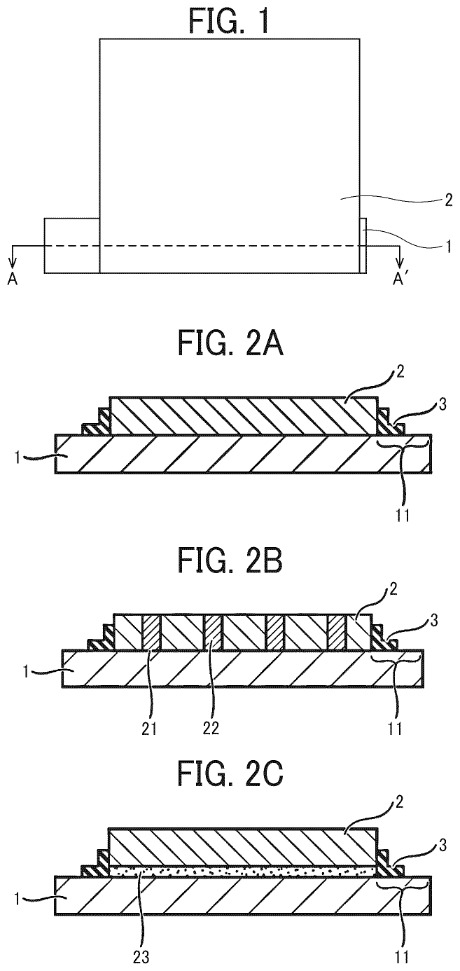

FIG. 1 is a schematic diagram illustrating an electrode according to an embodiment of the present invention. FIG. 2A is a schematic cross-sectional view taken along line A-A′in FIG. 1.

The electrode includes a substrate 1, an electrode composite layer 2 provided on a portion of the substrate 1, and an insulating layer 3. The insulating layer 3 is provided on an interface portion between a substrate-exposed portion 11, in which the substrate 1 is exposed, and the electrode composite layer 2.

Note that, in FIG. 2A, although FIG. 2A illustrates a configuration in which the electrode composite layer 2 and the insulating layer 3 are provided on one surface of the substrate 1, the electrode composite layer 2 and the insulating resin layer 3 may be provided on both opposing surfaces of the substrate 1.

### <Substrate>

The substrate is not particularly limited, and can be selected as appropriate according to the intended purpose, as long as the substrate is electronically conductive, and is stable with respect to an applied potential. Examples of the substrate include, but are not limited to, aluminum foil, copper foil, stainless steel foil, titanium foil, etched foils obtained by etching such foils to have fine holes, carbon-coated foils in which a surface layer has been coated with a carbon-containing resin layer, and perforated substrates used in lithium ion capacitors.

### <Electrode Composite Layer>

The electrode composite layer is provided on a portion of the substrate. In other words, the electrode composite layer is formed so that a substrate-exposed portion, on which the electrode composite layer is not provided, is generated for the purpose of providing the insulating layer, or for the purpose of welding leads.

The electrode composite layer (sometimes referred to as “active material layer”) is configured having an active material (negative electrode active material or positive electrode active material) as the main component. Note that, herein, the phrase “having an active material as the main component” refers to the content of the active material being 70% by mass or more relative to the entire electrode composite layer.

The electrode composite layer is composed of an electrode composite layer-forming liquid composition.

The electrode composite layer-forming liquid composition is not particularly limited, and can be selected as appropriate according to the intended purpose. For example, the electrode composite layer-forming liquid composition includes an active material (negative electrode active material or positive electrode active material), and if preferable, may include a conductive aid, an electrode composite layer binder, an electrode composite layer dispersant, a solid electrolyte, and other components.

FIG. 2B is a schematic cross-sectional view illustrating an electrode according to an embodiment of the present invention. FIG. 2C is a schematic cross-sectional view illustrating an electrode according to an embodiment of the present invention.

The electrode composite layer may have opening portions 21 as illustrated in FIG. 2B.

The number of opening portions 21 is preferably 1 or more, and is more preferably more than 1.

The opening portions 21 may completely pass through the electrode composite layer from the surface of the electrode composite layer to the surface of the substrate, or may not completely pass through to the surface of the substrate.

The opening portions 21 may be hollow, or may be filled with a material 22. When the opening portions 21 are filled with the material 22, the material 22 may be a single type of material, or may be a mixture of two or more types of materials. However, in either case, the material is different to the material constituting the electrode composite layer. From the viewpoint of improving the ion conductivity, the material 22 is preferably a material having a solid electrolyte.

An electrode composite layer having the opening portions 21 can be preferably produced by using an inkjet as an electrode composite layer-forming means, because the application control is simple.

As presented in FIG. 2C, the electrode composite layer may be provided with an adhesive layer 23 that includes a metal that alloys with lithium between the substrate 1 and the electrode composite layer 2.

Note that, when the adhesive layer 23 is provided between the substrate 1 and the electrode composite layer 2, the interface portion between the adhesive layer 23 and the substrate-exposed portion 11 is considered to be an interface portion in the present disclosure.

### <<Active Material>>

As the active material, a positive electrode active material or a negative electrode active material can be used. Note that the positive electrode active material or the negative electrode active material may use a single type of material, or a combination of two or more types of materials.

### -Positive Electrode Active Material-

The positive electrode active material is not particularly limited, as long as the material is capable of reversibly intercalating and releasing alkali metal ions, and alkali metal-containing transition metal compounds can be used.

Examples of the alkali metal-containing transition metal compound include, but are not limited to, lithium-containing transition metal compounds such as composite oxides including lithium, and one or more elements selected from a group consisting of cobalt, manganese, nickel, chromium, iron, and vanadium.

Examples of lithium-containing transition metal compounds include, but are not limited to, lithium cobalt oxide, lithium nickel oxide, and lithium manganese oxide.

As the alkali metal-containing transition metal compound, a polyanion-based compound having XO₄ tetrahedra (X=P, S, As, Mo, W, Si, and the like) in the crystal structure can be used. Among such alkali metal-containing transition metal compounds, lithium-containing transition metal phosphate compounds, such as lithium iron phosphate and lithium vanadium phosphate, are preferable from the viewpoint of the cycle characteristics, and lithium vanadium phosphate is more preferable from the viewpoint of the lithium diffusion coefficient and the output characteristics.

In the case where a polyanion-based compound is used, from the viewpoint of the electronic conductivity, it is preferable that the surface of the compound is coated with a conductive aid such as a carbon material to form a composite.

It is preferable that at least a portion of the surface of the alkali metal-containing transition metal compound is covered with an ion conductive oxide. The ion conductive oxide is preferably a lithium ion conductive oxide.

The lithium ion conductive oxide is not particularly limited, and can be selected as appropriate according to the intended purpose. Examples of the lithium ion conductive oxide include, but are not limited to, oxides represented by the general formula LiₓAO_{y} (where A represents B, C, Al, Si, P, S, Ti, Zr, Nb, Mo, Ta, Sc, V, Y, Ca, Sr, Ba, Hf, Ta, Cr or W, and x and y are positive numbers).

Specific examples of the lithium ion conductive oxide include, but are not limited to, Li₃BO₃, LiBO₂, Li₂CO₃, LiAlO₂, Li₄SiO₄, Li₂SiO₃, Li₃PO₄, Li₂SO₄, Li₂TiO₃, Li₄Ti₅O₁₂, Li₂ Ti₂O₅, Li₂ZrO₃, LiNbO₃, LiTaO₃, Li₂MoO₄, and Li₂WO₄. Among these lithium ion conductive oxides, Li₄Ti₅O₁₂, Li₂ZrO₃, and LiNbO₃ are preferable.

Furthermore, the lithium ion conductive oxide may be a composite oxide. As the composite oxide, any combination of lithium ion conductive oxides can be used, and examples include, but are not limited to, Li₄SiO₄—Li₃BO₃ and Li₄SiO₄—Li₃PO₄.

### -Negative Electrode Active Material-

The negative electrode active material is not particularly limited, and can be selected as appropriate according to the intended purpose as long as the material is capable of reversibly storing and releasing alkali metal ions. For example, a carbon material including graphite having a graphite-type crystal structure can be used.

Examples of carbon materials include, but are not limited to, natural graphite, spherical or fibrous artificial graphite, non-graphitizable carbon (hard carbon), and graphitizable carbon (soft carbon).

Examples of materials other than carbon materials include, but are not limited to, lithium titanate and titanium oxide.

From the viewpoint of increasing the energy density of a lithium ion battery, high capacity materials such as silicone, tin, silicone alloys, tin alloys, silicone oxide, silicone nitride, and tin oxide can also be preferably used as the negative electrode active material.

### <<Conductive Aid>>

The conductive aid is not particularly limited, and can be selected as appropriate according to the intended purpose. For example, carbon materials such as carbon black produced by a furnace method, an acetylene method, a gasification method, and the like, and carbon nanofibers, carbon nanotubes, graphene, and graphite particles, can be used.

As conductive aids other than carbon materials, for example, metal particles and metal fibers of aluminum and the like, can be used. Note that the conductive aid may be combined in advance with the active material.

The content of the conductive aid relative to the active material is not particularly limited, and can be set as appropriate according to the intended purpose. However, the content is preferably 10% by mass or less, and more preferably 8% by mass or less.

When the content of the conductive aid relative to the active material is 10% by mass or less, the stability of the electrode composite layer-forming liquid composition improves, which is preferable.

When the content of the conductive aid relative to the active material is 8% by mass or less, the stability of the electrode composite layer-forming liquid composition improves even further, which is preferable.

### <<Electrode Composite Layer Binder>>

The electrode mixture layer binder is not particularly limited, and can be selected as appropriate according to the intended purpose, as long as the electrode composite layer binder can bind negative electrode materials to each other, positive electrode materials to each other, a negative electrode material and a negative electrode substrate, or a positive electrode material and a positive electrode substrate. Note that, in a case where the electrode composite layer-forming liquid composition is used for inkjet ejection, from the viewpoint of preventing clogging of the nozzle of the liquid ejection head, the electrode composite layer binder is preferably a binder that does not readily cause the viscosity of the electrode composite layer-forming liquid composition to increase.

Note that, herein, the “binder” or “insulating layer binder” in the insulating layer-forming liquid composition, and the “electrode composite layer binder” in the electrode composite layer-forming liquid composition are distinguished.

As the electrode composite layer binder, a polymer compound can be used.

Examples of the polymer compound include, but are not limited to, thermoplastic resins such as polyvinylidene fluoride (PVDF), acrylic resin, polyethylene, polypropylene, polyurethane, nylon, polytetrafluoroethylene, polyphenylene sulfide, polyethylene terephthalate, and polybutylene terephthalate, polyamide compounds, polyimide compounds, polyamideimide, ethylene-propylene-butadiene rubber (EPBR), styrene-butadiene rubber (SBR), nitrile butadiene rubber (NBR), isoprene rubber, polyisobutene, polyethylene glycol (PEO), polymethylmethacrylate (PMMA), and polyethylene vinyl acetate (PEVA).

The content of the electrode composite layer binder relative to the active material is not particularly limited, and can be set as appropriate according to the intended purpose. However, the content is preferably 1% by mass or more and 15% by mass or less, and more preferably 3% by mass or more and 10% by mass or less. When the content of the electrode composite layer binder is 1% by mass or more relative to the active material, the active material can be firmly bound to the substrate, which is preferable.

### <<Electrode Composite Layer Dispersant>>

The electrode composite layer dispersant is not particularly limited as long as the electrode composite layer dispersant can improve the dispersibility of the active material in the electrode composite layer-forming liquid composition. Examples of the electrode composite layer dispersant include, but are not limited to, polymer dispersants such as polyethylene oxide-based dispersants, polypropylene oxide-based dispersants, polycarboxylic acid-based dispersants, naphthalenesulfonic acid formalin condensate-based dispersants, polyethylene glycol-based dispersants, polycarboxylic acid partial alkyl ester-based dispersants, polyether-based dispersants, and polyalkylenepolyamine-based dispersants; low-molecular weight dispersants such as alkylsulfonic acid-based dispersants, quaternary ammonium-based higher alcohol alkylene oxide-based dispersants, polyhydric alcohol ester-based dispersants, and alkylpolyamine-based dispersants; and inorganic dispersants such as polyphosphate-based dispersants.

Note that, herein, the “dispersant” or “insulating layer dispersant” in the insulating layer-forming liquid composition, and the “electrode composite layer dispersant” in the electrode composite layer-forming liquid composition are distinguished.

### <<Solid Electrolyte>>

The solid electrolyte is not particularly limited as long as the solid electrolyte is electronically insulating, and exhibits ion conductivity. From the viewpoint of high ion conductivity, the solid electrolyte is preferably a sulfide solid electrolyte or an oxide solid electrolyte.

Examples of the sulfide solid electrolyte include, but are not limited to, Li₁₀GeP₂S₁₂, and Li₆PS₅X (X=F, Cl, Br, I) having an argyrodite crystal structure.

Examples of the oxide-based solid electrolyte include, but are not limited to LLZ (Li₇La₃Zr₂O₁₂) having a garnet-type crystal structure, LATP (Li₁₊ₓAlₓTi₂₀ₓ(PO₄)₃) (0.1≤x≤0.4) having a NASICON-type crystal structure, LLT (Li_{0.33}La_{0.55}TiO₃) having a perovskite-type crystal structure, and amorphous LIPON (Li_{2.9}PO_{3.3}N_{0.4}).

The solid electrolytes mentioned above may be used alone or as a combination of two or more types.

In a case where the electrode composite layer is a positive electrode composite layer, the average thickness of the positive electrode composite layer is not particularly limited, and can be selected as appropriate according to the intended purpose. However, the average thickness is preferably 10 μm or more and 300 μm or less, and more preferably 40 μm or more and 150 μm or less.

When the average thickness of the positive electrode composite layer is 10 μm or more, the energy density of the electrochemical element is improved.

When the average thickness of the positive electrode composite layer is 300 μm or less, the load characteristics of the electrochemical element are improved.

In a case where the electrode composite layer is a negative electrode composite layer, the average thickness of the negative electrode composite layer is not particularly limited, and can be selected as appropriate according to the intended purpose. However, the average thickness is preferably 10 μm or more and 450 μm or less, and more preferably 20 μm or more and 100 μm or less.

When the average thickness of the negative electrode composite layer is 10 μm or more, the energy density of the electrochemical element is improved.

When the average thickness of the negative electrode composite layer is 450 μm or less, the cycle characteristics of the electrochemical element are improved.

The electrode composite layer may be formed on both surfaces of the substrate (positive electrode substrate and/or negative electrode substrate). Note that, in order to increase the charging and discharging capacity of the electrode, the electrode may be laminated in multiple layers. The number of laminated layers of the positive electrode and negative electrode is not particularly limited, and can be increased if preferable.

### <Insulating Layer>

The insulating layer of the electrode according to an embodiment of the present invention is provided covering the interface portion between the substrate-exposed portion, in which the substrate is exposed, and the electrode composite layer.

The insulating layer includes insulating inorganic particles, a resin including fluorine atoms, a crosslinked resin including at least one of a structural unit represented by general formula (5) or a structural unit represented by general formula (6), and other components if preferable.

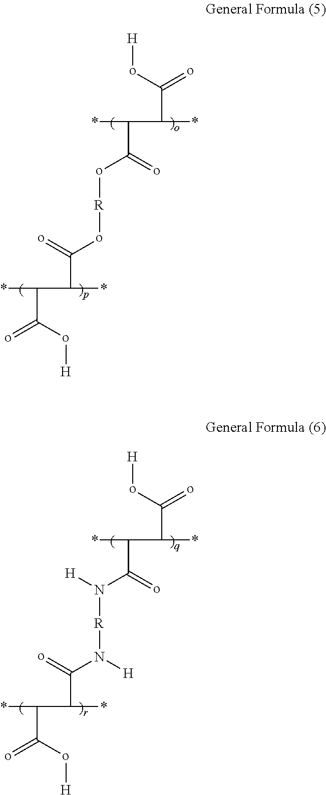

(where, in general formulas (5) and (6), * represents a bonding site with an adjacent main chain structural unit, R represents a structure of at least one of polyurethane, polyester, polyethylene oxide, polypropylene oxide, poloxamer, polycarbonate, silicone, polybutadiene, or hydrogenated polybutadiene butane, and o, p, q, and r each independently represent an integer from 2 to 500)

The dispersant and crosslinking agent in the insulating layer-forming liquid composition react in an insulating layer-forming liquid composition secondary drying step performed when forming the insulating layer, which forms a crosslinked resin including the structural unit represented by general formula (5) or the structural unit represented by general formula (6). The crosslinked resin is a resin in which the main chains of the polymer's molecules are linked by chemical bonds, and has a three-dimensional steric structure. Because the crosslinked resin including the structural unit represented by general formula (5) or the structural unit represented by general formula (6) does not dissolve in non-aqueous electrolytic solvent, an increase in the resistance of the electrolytic solution in the electrochemical element can be prevented.

The crosslinked resin improves the film strength of the insulating layer obtained by performing secondary drying of the insulating layer-forming liquid composition.

The value of o in general formula (5) is not particularly limited, and can be selected as appropriate according to the intended purpose, but is preferably an integer from 10 to 100.

The value of p in general formula (5) is not particularly limited, and can be selected as appropriate according to the intended purpose, but is preferably an integer from 10 to 100.

The value of q in general formula (6) is not particularly limited, and can be selected as appropriate according to the intended purpose, but is preferably an integer from 10 to 100.

The value of r in general formula (6) is not particularly limited, and can be selected as appropriate according to the intended purpose, but is preferably an integer from 10 to 100.

The method of confirming whether or not the crosslinked resin in the insulating layer includes the structural units represented by general formulas (5) and (6) is not particularly limited, and can be selected as appropriate according to the intended purpose. Examples of the method include, but are not limited to, infrared spectroscopy (IR). More specifically, it is confirmed whether or not the peaks at 1,782 cm⁻¹ and 1,858 cm⁻¹, which are presumed to be derived from bonds having the structural unit represented by general formula (1) in the crosslinked resin including the structural unit represented by general formula (5), are reduced compared to the peaks observed before the insulating layer-forming liquid composition secondary drying step. Furthermore, it is confirmed whether or not the peak at 1,734 cm⁻¹, which is presumed to be due to C=O stretching vibrations of —COOR, —COOH, and the like, has increased.

Because the peak presumed to be derived from the bonds of the crosslinked resin having the repeating structural units represented by general formulas (2) and (3) coincides with a peak at 1734 cm⁻¹, the presence or absence of the reaction cannot be confirmed by IR analysis. However, the determination can be made according to the presence or absence of solubility in a non-aqueous electrolytic solution.

The content of the crosslinked resin is not particularly limited, and can be selected as appropriate according to the content of the dispersant and crosslinking agent in the insulating layer-forming liquid composition. However, the content is preferably 1.5% by mass or more and 10% by mass or less, more preferably 2% by mass or more and 8% by mass or less, and even more preferably 2.5% by mass or more and 6% by mass or less relative to the total amount of the insulating inorganic particles.

The basis weight of the insulating layer relative to the electrode composite layer is not particularly limited, and can be selected as appropriate according to the intended purpose. However, the basis weight is preferably 0.3 mg/cm² or more and 1.5 mg/cm² or less, more preferably 0.4 mg/cm² or more and 1.5 mg/cm² or less, and even more preferably 0.5 mg/cm² or more and 1.5 mg/cm² or less.

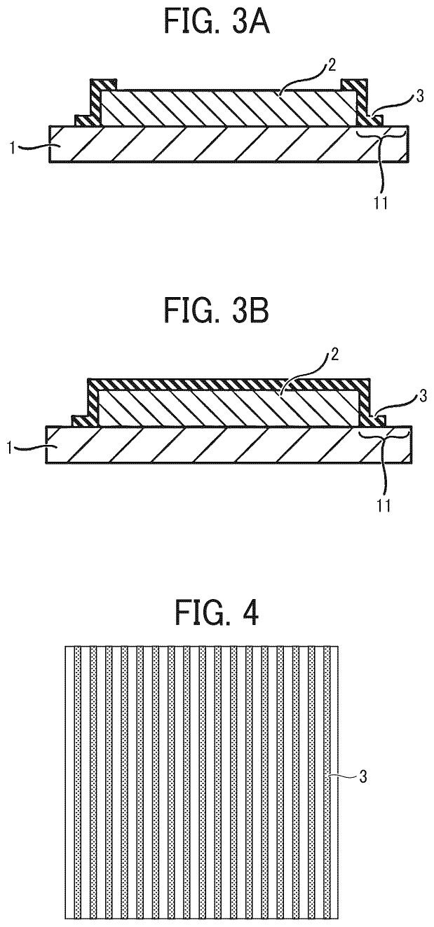

Here, FIG. 3A is a schematic cross-sectional view of an electrode according to an embodiment of the present invention. FIG. 3B is a schematic cross-sectional view of an electrode according to an embodiment of the present invention.

As illustrated in FIG. 3A, the insulating layer 3 may be provided on an interface portion, and an end portion of the electrode composite layer 2. As illustrated in FIG. 3B, the insulating layer 3 may be provided on an interface portion, and an upper surface of the electrode composite layer 2.

In a case where the insulating layer 3 is provided on the upper surface of the electrode composite layer 2, the coverage rate of the upper surface of the electrode composite layer 2 by the insulating layer 3 is preferably 70% or more, more preferably 80% or more, and even more preferably 90% or more. In other words, in a case where the insulating layer 3 is provided on the upper surface of the electrode composite layer 2, an exposed region may exist on the upper surface of the electrode composite layer 2 that is not covered by the insulating layer 3.

As a result of adopting a mode in which the insulating layer 3 is provided on the electrode composite layer 2, an insulating layer with a small thickness and having uniformity can be prepared when applied using an inkjet, and the stability of the battery is improved.

In a case where the insulating layer is provided on the end portion of the electrode composite layer, the average thickness of the insulating layer is not particularly limited, and can be selected as appropriate according to the intended purpose. However, the average thickness is preferably 1 μm or more and 20 μm or less, and more preferably 3 μm or more and 10 μm or less.

When the average thickness of the insulating layer is 1 μm or more, sufficient insulation properties can be obtained, which is preferable.

When the average thickness of the insulating layer is 20 μm or less, problems occurring when the liquid composition is applied can be resolved, namely damage to the electrode composite layer caused by the weight of the liquid composition itself, and unevenness caused by flowing of the liquid composition.

In a case where the insulating layer is provided on the upper surface of the electrode composite layer, the average thickness of the insulating layer is not particularly limited, and can be selected as appropriate according to the intended purpose. However, from the viewpoint of improving the stability of the battery, the average thickness is preferably 0.5 μm or more and 24 μm or less.

The method of measuring the average thickness of the insulating layer is not particularly limited, and can be selected as appropriate according to the intended purpose. For example, the measurement can be performed using a Digimatic Micrometer (manufactured by Mitutoyo Corporation).

The width of the insulating layer in FIG. 3A is not particularly limited, and can be selected as appropriate according to the battery configuration. However, the width is preferably 2 mm or more and 30 mm or less.

Note that the “width” of the insulating layer refers to the distance, in a cross-sectional view when the electrode is cut in thickness direction of the electrode and in a direction parallel to the length direction of the electrode, from one end portion to the other end portion (length direction of the electrode) of the upper surface of the insulating layer that opposes the substrate surface making contact with the electrode composite layer.

When the width of the insulating layer is 2 mm or more, a problem in which it is difficult for the insulating layer to follow the meandering of the electrode composite layer, and the substrate-exposed portion cannot be covered with the insulating layer can be resolved.

When the width of the insulating layer is 30 mm or less, problems such as interference with the welding of the leads, and an excessively large battery size relative to the battery capacity can be resolved.

Note that the width of the insulating layer protruding onto the substrate in FIG. 3B can be set as appropriate within a range that does not interfere with the welding of the leads.

The covering width of the insulating layer with respect to the electrode composite layer in FIG. 3A is not particularly limited, and can be selected as appropriate according to the intended purpose. However, the covering width is preferably 0.1 mm or more and 5 mm or less.

Note that the “covering width” herein refers to the distance, in a cross-sectional view when the electrode is cut in the thickness direction of the electrode and in a direction parallel to the length direction of the electrode, from one end portion to the other end portion (length direction of the electrode) of the surface that opposes the substrate surface making contact with the electrode composite layer, in which the electrode composite layer and the insulating layer make contact with each other.

When the covering width of the insulating layer is 0.1 mm or more, a problem in which it is difficult for the insulating layer to follow the meandering of the electrode composite layer, and the substrate-exposed portion cannot be covered with the insulating layer can be resolved.

When the covering width is 5 mm or less, the insulating layer can be prevented from adversely affecting the battery capacity.

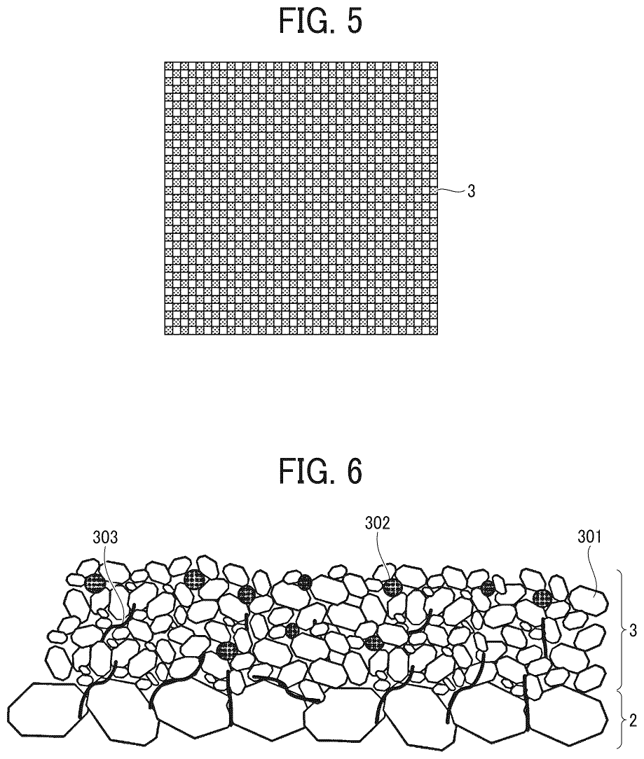

Here, FIG. 4 is a schematic diagram illustrating an insulating layer on an electrode according to an embodiment of the present invention. FIG. 5 is a schematic diagram illustrating an insulating layer on an electrode according to an embodiment of the present invention.

The shape of the insulating layer 3 provided on the substrate and the electrode composite layer is not particularly limited, and can be selected as appropriate according to the intended purpose. For example, the shape can be that of a solid film, a line pattern as illustrated in FIG. 4, or a lattice pattern as illustrated in FIG. 5.

The shape of the insulating layer 3 provided on the substrate and the electrode composite layer can, for example, be drawn based on bitmap information. Bitmap information refers to digital image information used in conventional digital printing.

The shape of the electrode is not particularly limited, and can be selected as appropriate according to the intended purpose. Examples of the shape include, but are not limited to, a flat plate shape.

The size of the electrode is not particularly limited, and can be selected as appropriate according to the intended purpose. The positive electrode and the negative electrode may have different sizes.

### (Method for Producing Electrode, and Electrode Production Apparatus)

The method for producing an electrode according to an embodiment of the present invention includes an insulating layer-forming step. The insulating layer-forming step includes an insulating layer-forming liquid composition application step, and if preferable, an electrode composite layer-forming step, an insulating layer-forming liquid composition drying step, and other steps.

The electrode production apparatus according to an embodiment of the present invention includes an insulating layer-forming device. The insulating layer-forming device includes an insulating layer-forming liquid composition application unit, and if preferable, an electrode composite layer-forming unit, an insulating layer-forming liquid composition drying unit, and other units.

### <Electrode Composite Layer-Forming Step and Electrode Composite Layer-Forming Device>

The electrode composite layer-forming step is a step of forming the electrode composite layer on a portion of the substrate. The electrode composite layer-forming step preferably includes an electrode composite layer-forming liquid composition application step, and an electrode composite layer-forming liquid composition drying step.

The electrode composite layer-forming device is a device that forms the electrode composite layer on a portion of the substrate. The electrode composite layer-forming device preferably includes an electrode composite layer-forming liquid composition application unit, and an electrode composite layer-forming liquid composition drying unit.

The electrode composite layer-forming step can be preferably carried out by the electrode composite layer-forming device.

### <<Electrode Composite Layer-Forming Liquid Composition Application Step and Electrode Composite Layer-Forming Liquid Composition Application Means>>

The electrode composite layer-forming liquid composition application step is a step of applying the electrode composite layer-forming liquid composition onto a portion of the substrate.

The electrode composite layer-forming liquid composition application unit is a unit that applies the electrode composite layer-forming liquid composition onto a portion of the substrate.

The electrode composite layer-forming liquid composition application step is preferably carried out by the electrode composite layer-forming liquid composition application unit.

In a case where the positive electrode is produced, a positive electrode composite layer is formed by applying the electrode composite layer-forming liquid composition (positive electrode composite layer-forming liquid composition) on a positive electrode substrate.

In a case where the negative electrode is produced, a negative electrode composite layer is formed by applying the electrode composite layer-forming liquid composition (negative electrode composite layer-forming liquid composition) on a negative electrode substrate.

The electrode composite layer-forming liquid composition application unit is not particularly limited, and can be selected as appropriate according to the intended purpose. Examples thereof include, but are not limited to, those employing a dip coating method, a spray coating method, a spin coating method, a bar coating method, a slot die coating method, a doctor blade coating method, an offset printing method, a gravure printing method, a flexographic printing method, a letterpress printing method, a screen printing method, a liquid ejection method, and an electrophotographic printing method by a liquid development method. Among these methods, the liquid ejection method is preferable because the droplet ejection position and ejection amount can be precisely controlled.

In a case where the liquid ejection method is used, the electrode composite layer-forming liquid composition is ejected from a liquid ejection head onto the substrate.

Examples of the method of ejecting the electrode composite layer-forming liquid composition include, but are not limited to, a method of applying mechanical energy to the electrode composite layer-forming liquid composition, and a method of applying thermal energy to the electrode composite layer-forming liquid composition. Among such methods, in a case where a non-aqueous solvent is used, the method is preferably a method of applying mechanical energy to the electrode composite layer-forming liquid composition, and the method is more preferably an inkjet method.

Note that, in a case where the liquid ejection method is used, a known liquid ejection device can be used.

### <<Electrode Composite Layer-Forming Liquid Composition Drying Step and Electrode Composite Layer-Forming Liquid Composition Drying Unit>>

The electrode composite layer-forming liquid composition drying step is a step of drying the electrode composite layer-forming liquid composition that has been applied onto the substrate.

The electrode composite layer-forming liquid composition drying unit is a unit that dries the electrode composite layer-forming liquid composition that has been applied onto the substrate.

The electrode composite layer-forming liquid composition drying step is preferably carried out by the electrode composite layer-forming liquid composition drying unit.

The electrode composite layer-forming liquid composition drying unit and step are not particularly limited, and can be selected as appropriate according to the intended purpose. Examples thereof include, but are not limited to, methods that heat the coated surface using a resistance heater, an infrared heater, a fan heater, or the like, and methods that perform drying from the rear surface of the coated surface using a hot plate, a drum heater, or the like.

Among such methods, from the viewpoint of uniformly heating and drying the coated surface, it is preferable to use a resistance heater, an infrared heater, or a fan heater that can dry the coated surface without making contact with the coated surface.

The heating mechanisms mentioned above may be used alone or as a combination of two or more types.

The heating temperature of the electrode composite layer-forming liquid composition drying step is not particularly limited, and can be selected as appropriate according to the intended purpose. However, from the viewpoint of protecting the substrate and the active material of the electrode composite layer, the temperature is preferably 70° C. or higher and 150° C. or lower.

### <<Insulating Layer-Forming Step and Insulating Layer-Forming Device>>

The insulating layer-forming step is a step of forming the insulating layer covering an interface portion between the substrate-exposed portion, in which the substrate is exposed, and the electrode composite layer. The insulating layer-forming step preferably includes an insulating layer-forming liquid composition application step, and an insulating layer-forming liquid composition drying step.

The insulating layer-forming device is a device that forms the insulating layer covering an interface portion between the substrate-exposed portion, in which the substrate is exposed, and the electrode composite layer. The insulating layer-forming device preferably includes an insulating layer-forming liquid composition application unit, and an insulating layer-forming liquid composition drying unit.

The insulating layer-forming step can be preferably carried out by the insulating layer-forming device.

### <<Insulating Layer-Forming Liquid Composition Application Step and Insulating Layer-Forming Liquid Composition Application Unit>>

The insulating layer-forming liquid composition application step is a step of applying the insulating layer-forming liquid composition to an interface portion between the substrate-exposed portion, in which the substrate is exposed, and the electrode composite layer.

The insulating layer-forming liquid composition application unit is a unit that applies the insulating layer-forming liquid composition to an interface portion between the substrate-exposed portion, in which the substrate is exposed, and the electrode composite layer.

The insulating layer-forming liquid composition application step can be preferably carried out by the insulating layer-forming liquid composition application unit.

As the insulating layer-forming liquid composition application step and unit, the same steps and units as those described under the heading <<Electrode Composite Layer-Forming Liquid Composition Application Step and Electrode Composite Layer-Forming Liquid Composition Application Unit>>can be used.

### <<Insulating Layer-Forming Liquid Composition Drying Step and Insulating Layer-Forming Liquid Composition Drying Unit>>

The insulating layer-forming liquid composition drying step is a step of drying the applied insulating layer-forming liquid composition.

The insulating layer-forming liquid composition drying unit is a unit that dries the applied insulating layer-forming liquid composition.

The insulating layer-forming liquid composition drying step can be preferably carried out by the insulating layer-forming liquid composition drying unit.

Here, FIG. 6 is a schematic cross-sectional view of an electrode obtained by an insulating layer-forming liquid composition drying step according to an embodiment of the present invention.

In the insulating layer-forming liquid composition drying step, as a result of a difference in the specific gravity between an insulating layer binder 302 included in the insulating layer-forming liquid composition and insulating inorganic particles 301, the insulating layer binder 302 can be unevenly distributed toward the surface of the insulating layer 3 (see FIG. 6).

Herein, the “surface of the insulating layer” refers to a region (surface side region) on the opposite side to the substrate 2 (in the thickness direction of the insulating layer) when an imaginary line, which is based on the surface of the insulating layer in the cross-section of the electrode that is opposing the substrate, is drawn at half the average thickness of the insulating layer. Furthermore, the region on the substrate 2 side of the imaginary line is defined as a substrate side region.

The uneven distribution rate of the insulating layer binder is not particularly limited, and can be selected as appropriate according to the intended purpose. However, the amount of the binder in the substrate region is preferably 30% or less, and more preferably 10% or less relative to the amount of the binder in the surface side region.

The method of confirming whether or not the insulating layer binder is unevenly distributed toward the surface of the insulating layer is not particularly limited, and can be selected as appropriate according to the intended purpose. For example, the confirmation can be made by measuring the abrasion strength and the 90 degree peel strength. More specifically, the confirmation can be made according to whether or not particles do not adhere when the insulating layer is rubbed with a rubber glove, and the peel strength is 30 N/m or more and 250 N/m or less.

In a case where the medium to which the insulating layer-forming liquid composition is to be coated is a porous body such as the electrode composite layer or the like, in the process from application of the liquid composition to drying, the dispersant and a crosslinking agent 303 become unevenly distributed at the interface between the lower portion of the insulating layer and the upper portion of the electrode composite layer when the solvent contained in the liquid composition permeates into the electrode composite layer. As a result, the binding function of the insulating layer at the electrode composite layer interface after forming the crosslinked resin can be improved.

In a case where the substrate in the insulating layer-forming liquid composition application step is a porous body, from the viewpoint of preventing deterioration and the like of the porous body due to the liquid component including the resin dissolved in the solvent in the applied insulating layer-forming liquid composition permeating too much from the surface of the porous body due to a capillary action, and in a case where the substrate in the insulating layer-forming liquid composition application step is a metal foil, from the viewpoint of preventing the applied insulating layer-forming liquid composition from becoming uneven due to aggregation and the like, the time from the insulating layer-forming liquid composition application step to the insulating layer-forming liquid composition drying step is preferably 2 minutes or less, and more preferably 2 seconds or more and 1 minute or less.

The insulating layer-forming liquid composition drying unit and step are not particularly limited, and can be selected as appropriate according to the intended purpose.

Examples include, but are not limited to, methods that heat the coated surface using a resistance heater, an infrared heater, a fan heater, or the like, and methods that perform drying from the rear surface of the coated surface using a hot plate, a drum heater, or the like. From the viewpoint of uniformly heating and drying the coated surface, it is preferable to use a resistance heater, an infrared heater, or a fan heater that can dry the coated surface without making contact with the coated surface.

The heating mechanisms mentioned above may be used alone or as a combination of two or more types.

The insulating layer-forming liquid composition drying step preferably includes an insulating layer-forming liquid composition primary drying step, an insulating layer-forming liquid composition primary dried product processing step, and an insulating layer-forming liquid composition secondary drying step.

### -Insulating Layer-Forming Liquid Composition Primary Drying Step-

The insulating layer-forming liquid composition primary drying step is a step of drying the insulating layer-forming liquid composition after the insulating layer-forming liquid composition application step.

In a case where the insulating layer-forming liquid composition primary drying step is performed by heating, the heating temperature is not particularly limited, and can be selected as appropriate according to the intended purpose. However, from the viewpoint of protecting the substrate and the active material of the electrode composite layer, the temperature is preferably 70° C. or higher and 150° C. or lower.

The heating temperature in the insulating layer-forming liquid composition primary drying step is preferably 70° C. or higher, because the strength of the insulating layer improves.

The heating temperature in the insulating layer-forming liquid composition primary drying step is preferably 150° C. or lower because air bubbles resulting from bumping at the surface of the insulating layer can be prevented.

### -Insulating Layer-Forming Liquid Composition Primary Dried Product Processing Step-

The insulating layer-forming liquid composition primary dried product processing step is a step that is carried out after the insulating layer-forming liquid composition primary drying step, and examples include, but are not limited to, a winding step.

### -Insulating Layer-Forming Liquid Composition Secondary Drying Step-

The insulating layer-forming liquid composition secondary drying step is a step of re-drying the insulating layer-forming liquid composition after the insulating layer-forming liquid composition primary dried product processing step.

In a case where the insulating layer-forming liquid composition secondary drying step is performed by heating, the heating temperature is not particularly limited, and can be selected as appropriate according to the intended purpose. However, from the viewpoint of improving the film strength, the heating temperature is preferably 100° C. or higher, and more preferably 120° C. or higher in the case of a positive electrode, and is preferably 60° C. or higher in the case of a separator.

In the insulating layer-forming liquid composition secondary drying step, from the viewpoint of shortening the time it takes for the reaction that produces the crosslinked resin to occur, a higher drying temperature is more preferable, and the drying is preferably performed under a vacuum environment.

### <Other Steps and Other Devices>

The other steps are not particularly limited, and can be selected as appropriate according to the intended purpose. Examples of the other steps include, but are not limited to, a cutting step of cutting the electrode into a desired size by a punching process or the like.

The other devices are not particularly limited, and can be selected as appropriate according to the intended purpose. Examples of the other devices include, but are not limited to, a cutting device that cuts the electrode into a desired size by a punching process or the like.

The other steps can be preferably carried out by the other devices.

Here, an electrode production apparatus according to an embodiment of the present invention will be described with reference to the drawings. However, the present invention is in no way limited to the embodiments below.

Note that, in each drawing, the same components are denoted by the same reference numerals, and duplicate descriptions may be omitted. Furthermore, the number, position, shape, and the like, of the constituent members described below are not limited to those in the present embodiment, and can be set to a preferable number, position, shape, and the like, when the present embodiment is implemented.

Here, FIG. 7 is a schematic diagram illustrating an electrode production apparatus according to an embodiment of the present invention.

The electrode production apparatus 10 includes a printing unit 20, a heating unit 30, and a transport unit 40. Note that the printing unit 20 is an example of the electrode composite layer-forming liquid composition application unit and/or the insulating layer-forming liquid composition application unit that constitutes the electrode production apparatus according to the present embodiment. Further, the heating unit 30 is an example of the electrode composite layer-forming liquid composition drying unit and/or the insulating layer-forming liquid composition drying unit that constitutes the electrode production apparatus according to the present embodiment.

The printing unit 20 applies the electrode composite layer-forming liquid composition and/or the insulating layer-forming liquid composition P onto a medium 50 to be coated, and forms the electrode composite layer and/or the insulating layer. The printing unit 20 includes a storage container 20A that stores the electrode composite layer-forming liquid composition and/or the insulating layer-forming liquid composition P, a printing device 20B that applies the electrode composite layer-forming liquid composition and/or the insulating layer-forming liquid composition P onto the medium 50 to be coated, and a supply tube 20C that supplies the electrode composite layer-forming liquid composition and/or the insulating layer-forming liquid composition P that is stored in the storage container 20A to the printing device 20B.

At the time of printing, the printing unit 20 supplies the electrode composite layer-forming liquid composition and/or the insulating layer-forming liquid composition P that is stored in the storage container 20A to the printing device 20B, and ejects the electrode composite layer-forming liquid composition and/or the insulating layer-forming liquid composition P from the printing device 20B onto the medium 50 to be coated. As a result, the electrode composite layer-forming liquid composition and/or the insulating layer-forming liquid composition P is applied onto the medium 50 to be coated, and the electrode composite layer and/or the insulating layer is formed in the form of a thin-film.

The storage container 20A can be arbitrarily selected as long as the storage container 20A can stably store the electrode composite layer-forming liquid composition and/or the insulating layer-forming liquid composition P. Note that the storage container 20A may be integrated with the electrode production apparatus 10, or may be detachable from the electrode production apparatus 10. Moreover, the storage container 20A may be a container used for filling a storage container that is integrated with the electrode production apparatus 10, or a container used for filling a storage container that is detachable from the electrode production apparatus 10.

The printing device 20B is not particularly limited as long as the printing device 20B is capable of applying the electrode composite layer-forming liquid composition and/or the insulating layer-forming liquid composition P. For example, any printing device can be used according to the various printing methods used, such as a spin coating method, a casting method, a micro gravure coating method, a gravure coating method, a bar coating method, a roll coating method, a wire bar coating method, a dip coating method, a slit coating method, a capillary coating method, a spray coating method, a nozzle coating method, a gravure printing method, a screen printing method, a flexographic printing method, an offset printing method, a reversal printing method, and an inkjet printing method. Among such methods, a printing device corresponding to the inkjet printing method is preferably used in that non-contact formation or printing of a thin film on a thin-layer medium 50 to be coated can be performed, material costs can be reduced, waste materials can be reduced, and the like.

The supply tube 20C can be arbitrarily selected as long as the supply tube 20C can stably supply the electrode composite layer-forming liquid composition and/or the insulating layer-forming liquid composition P.

The heating unit 30 heats the electrode composite layer-forming liquid composition and/or the insulating layer-forming liquid composition P to obtain the electrode composite layer or the insulating layer. The heating unit 30 includes a heating device 30A.

The heating device 30A removes the solvent remaining in the electrode composite layer-forming liquid composition and/or the insulating layer-forming liquid composition P by heating and drying the electrode composite layer-forming liquid composition and/or the insulating layer-forming liquid composition P. As a result, the electrode composite layer-forming liquid composition and/or the insulating layer-forming liquid composition P on the medium 50 to be coated becomes the electrode composite layer and/or the insulating layer.

Furthermore, the heating temperature and the heating time can be selected as appropriate according to the boiling point of the solvent included in the electrode composite layer-forming liquid composition and/or the insulating layer-forming liquid composition P, the thickness of the formed film, and the like.

The transport unit 40 sequentially transports the medium 50 to be coated from the printing unit 20 to the heating unit 30 at a preset speed. The transport unit 40 may be any unit as long as the transport unit 40 can transport the medium 50 to be coated. For example, a conveyor belt or the like can be used.

The material of the medium 50 to be coated may be any material, irrespective of whether the material is transparent or opaque. That is, as a transparent base material of the medium 50 to be coated, a glass base material, a resin film base material such as various plastic films, a composite base material of the above base materials, and the like, can be used. As an opaque base material, various base materials such as a silicon base material, a metal base material such as stainless steel, and a laminate of the above base materials can be used.

Note that the medium 50 to be coated may be a recording medium such as plain paper, glossy paper, special paper, or cloth. The recording medium may be a low-permeability base material (low absorption base material). The base material having low permeability refers to a base material having a surface with low water permeability, absorptivity, or adsorptivity, and also includes materials having a large number of internal cavities, but no outer openings. Examples of the low permeability base material include, but are not limited to, coated paper used in commercial printing, and recording media such as paperboard prepared by blending waste paper pulp in the middle layer and back layer, and then applying a surface coating.

The medium 50 to be coated may be a porous resin sheet used as an insulating layer for an electricity storage element or a power generation element.

The shape of the medium 50 to be coated may be a curved or uneven shape, and any base material that can be applied to the printing unit 20 can be used.

### (Electrochemical Element)

The electrochemical element according to an embodiment of the present invention includes an electrode.

Note that, because the same electrode as that described herein under the heading (Electrode) can be used, duplicate descriptions will be omitted.

Here, an electrochemical element according to an embodiment of the present invention will be described with reference to the drawings.

However, the present invention is in no way limited to the embodiment below.

Note that, in each drawing, the same components are denoted by the same reference numerals, and duplicate descriptions may be omitted. Furthermore, the number, position, shape, and the like, of the constituent members described below are not limited to those in the present embodiment, and can be set to a preferable number, position, shape, and the like, when the present embodiment is implemented.

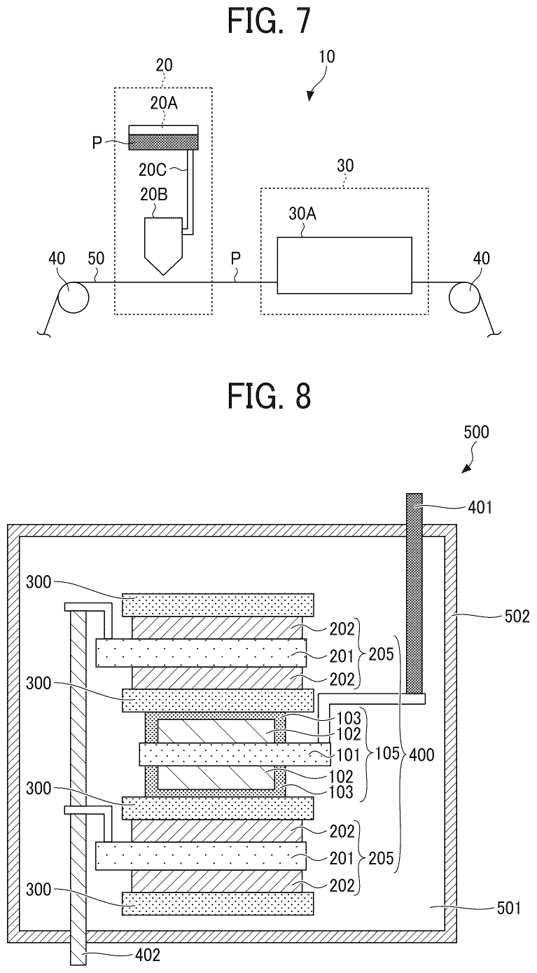

FIG. 8 is a schematic diagram illustrating an electrochemical element according to an embodiment of the present invention.

An electrochemical element 500 has an electrolyte layer 501 constituted by a non-aqueous electrolyte formed on a laminated electrode 400, and is sealed by an exterior casing 502. In the electrochemical element 500, lead wires 401 and 402 are drawn out to the outside of the exterior casing 502.

In the laminated electrode 400, a negative electrode 205 and a positive electrode 105 are laminated with a separator 300 interposed therebetween. Here, the negative electrode 205 is laminated on both sides of the positive electrode 105. Furthermore, the lead wire 402 is connected to a negative electrode substrate 201, and the lead wire 401 is connected to a positive electrode substrate 101.

In the positive electrode 105, a positive electrode composite layer 102 and an insulating layer 103 are successively formed on both surfaces of the positive electrode substrate 101.

The negative electrode 205 is formed with negative electrode composite layers 202 on both sides of the negative electrode substrate 201.

Note that the number of negative electrodes 205 and the number of positive electrodes 105 in the laminated electrode 400 may be the same, or different.

The shape of the electrochemical element using the electrode is not particularly limited. Examples of the shape include, but are not limited to, a laminate type in which flat electrodes are laminated, a cylinder type in which a sheet electrode and a separator are spirally formed, a cylinder type with an inside-out structure in which a pellet electrode and a separator are combined, and a coin type in which a pellet electrode and a separator are laminated.

The electrochemical element 500 may include other members if preferable.

### <<Non-Aqueous Electrolyte>>

A non-aqueous electrolytic solution or a solid electrolyte can be used as the non-aqueous electrolyte.

### --Non-Aqueous Electrolytic Solution--

The non-aqueous electrolytic solution is an electrolytic solution in which an electrolyte salt is dissolved in a non-aqueous solvent.

The non-aqueous solvent is not particularly limited, and can be selected as appropriate according to the intended purpose. For example, it is preferable to use an aprotic organic solvent as the non-aqueous solvent. As the aprotic organic solvent, a carbonate-based organic solvent such as a chain carbonate or a cyclic carbonate can be used. Among these carbonate-based organic solvents, a chain carbonate is preferable due to the high solubility of electrolyte salts in chain carbonates. The aprotic organic solvent preferably has low viscosity.

Examples of chain carbonates include, but are not limited to, dimethyl carbonate (DMC), diethyl carbonate (DEC), and methyl ethyl carbonate (EMC).

The content of the chain carbonate in the non-aqueous solvent is preferably 50% by mass or more. When the content of the chain carbonate in the non-aqueous solvent is 50% by mass or more, even when the non-aqueous solvent other than the chain carbonate is a cyclic substance with a high dielectric constant (for example, a cyclic carbonate or a cyclic ester), the content of the cyclic substance is kept low. Therefore, even if a non-aqueous electrolytic solution having a high concentration of 2 M or more is prepared, the viscosity of the non-aqueous electrolytic solution is kept low. Therefore, good permeation of the non-aqueous electrolytic solution into the electrode and ion diffusion are obtained.

Examples of cyclic carbonates include, but are not limited to, propylene carbonate (PC), ethylene carbonate (EC), butylene carbonate (BC), and vinylene carbonate (VC).

Note that, examples of non-aqueous solvents other than the carbonate-based organic solvent that can be used include, but are not limited to, ester-based organic solvents such as cyclic esters and chain esters, and ether-based organic solvents such as cyclic ethers and chain ethers.

Examples of cyclic esters include, but are not limited to, γ-butyrolactone (γBL), 2-methyl-γ-butyrolactone, acetyl-γ-butyrolactone, and γ-valerolactone.

Examples of chain esters include, but are not limited to, propionic acid alkyl esters, malonic acid dialkyl esters, acetic acid alkyl esters (for example, methyl acetate (MA) and ethyl acetate), and formic acid alkyl esters (for example, methyl formate (MF) and ethyl formate).

Examples of cyclic ethers include, but are not limited to, tetrahydrofuran, alkyltetrahydrofuran, alkoxytetrahydrofuran, dialkoxytetrahydrofuran, 1,3-dioxolane, alkyl-1,3-dioxolane, and 1,4-dioxolane.

Examples of chain ethers include, but are not limited to, 1,2-dimethoxyethane (DME), diethyl ether, ethylene glycol dialkyl ether, diethylene glycol dialkyl ether, triethylene glycol dialkyl ether, and tetraethylene glycol dialkyl ether.

The electrolyte salt in the non-aqueous electrolytic solution is not particularly limited as long as the electrolyte salt has high ion conductivity, and is soluble in the non-aqueous solvent.

The electrolyte salt in the non-aqueous electrolytic solution preferably includes a halogen atom.

Examples of the cation included in the electrolyte salt includes, but are not limited to, lithium ions.

Examples of the anion included in the electrolyte salt include, but are not limited to, BF₄⁻, PF₆⁻, AsF₆⁻, CF₃SO₃⁻, (CF₃SO₂)₂N⁻, and (C₂F₅SO₂)₂N⁻.

The lithium salt is not particularly limited and can be selected as appropriate according to the intended purpose. Examples of the lithium salt include, but are not limited to, lithium hexafluorophosphate (LiPF₆), lithium tetrafluoroborate (LiBF₄), lithium hexafluoroarsenate (LiAsF₆), lithium trifluoromethasulfonate (LiCF₃SO₃), lithium bis(trifluoromethylsulfonyl)imide (LiN(C₃SO₂)₂), and lithium bis(pentafuluoroethylsulfonyl)imide (LiN(C₂F₅SO₂)₂). Among these lithium salts, LiPF₆ is preferable from the viewpoint of the ionic conductivity, and LiBF₄ is preferable in terms of the stability.

Note that the electrolyte salt of the non-aqueous electrolytic solution may be used singly or in combination of two or more.

The concentration of the electrolyte salt in the non-aqueous electrolytic solution is not particularly limited, and can be selected as appropriate according to the intended purpose. However, in a case where the electrochemical element is a swing-type element, the concentration is preferably 1 mol/L to 2 mol/L. Further, in a case where the non-aqueous electrochemical element is a reserve-type element, the concentration is preferably 2 mol/L to 4 mol/L.

### <Separator>

If preferable, a separator is provided between the negative electrode and the positive electrode in order to prevent short circuiting between the negative electrode and the positive electrode.

The separator is, for example, a porous film having communicating pores that insulate and isolate the positive electrode and the negative electrode used in the electrochemical element, such as a secondary battery.

Examples of the separator include, but are not limited to, paper such as kraft paper, vinylon mixed paper, and synthetic pulp mixed paper; polyolefin non-woven fabric such as cellophane, polyethylene graft films, and polypropylene melt-blown non-woven fabrics; polyamide non-woven fabrics, glass fiber non-woven fabrics, and a micropore films.

The size of the separator is not particularly limited, as long as the separator can be used in the electrochemical element.

The separator may have a single-layer structure, or a laminated structure.

Note that the separator is included in a case where an aqueous electrolytic solution or a non-aqueous electrolytic solution is used as the electrolyte. However, the separator can be omitted in a case where a solid electrolyte or a gel electrolyte is used.

### <Exterior Casing>

The exterior casing is not particularly limited, and a known exterior casing can be selected as appropriate according to the intended purpose as long as the exterior casing can seal the electrode, the electrolyte, the separator, or the solid electrolyte.

### [Applications of Electrochemical Element]

The electrochemical element can be preferably used as a secondary battery.

The applications of the electrochemical element are not particularly limited, and examples include, but are not limited to, notebook computers, pen input computers, mobile computers, e-book players, mobile phones, mobile fax machines, mobile copiers, mobile printers, headphone stereos, video movie players, LCD televisions, handheld cleaners, portable CD players, mini disc players, transceivers, electronic notebooks, electronic calculators, memory cards, mobile tape recorders, radios, backup power supplies, motors, lighting equipment, toys, game equipment, clocks, strobe lights, cameras, and vehicles.

### (Secondary Battery)

A secondary battery according to an embodiment of the present invention includes an electrochemical element.

Note that, because the same electrochemical element as that described herein under the heading (Electrochemical Element) can be used, duplicate descriptions will be omitted.

### (Separator)

A separator according to an embodiment of the present invention includes a separator substrate, and an insulating layer provided on the separator substrate, wherein the insulating layer includes insulating inorganic particles, a resin including fluorine atoms, a crosslinked resin including at least one of a structural unit represented by general formula (5) or a structural unit represented by general formula (6), and other components and other members if preferable.

Note that, because the separator according to an embodiment of the present invention is the same as that described herein under the heading (Electrode) except for using a separator substrate as the substrate, duplicate descriptions will be omitted.

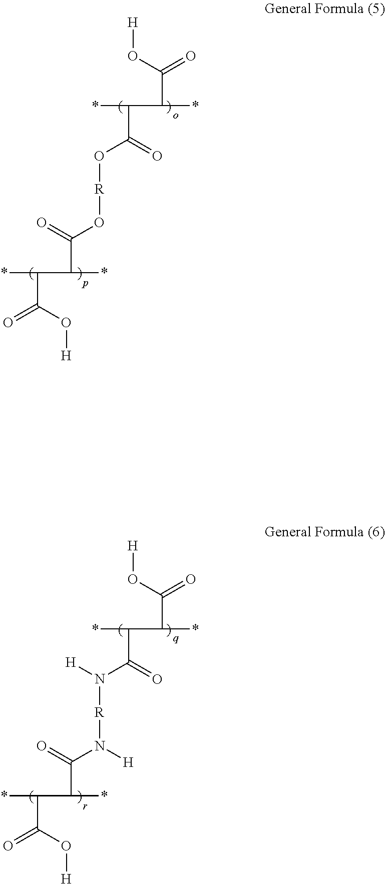

(where, in general formulas (5) and (6), * represents a bonding site with an adjacent main chain structural unit, R represents a structure of at least one of polyurethane, polyester, polyethylene oxide, polypropylene oxide, poloxamer, polycarbonate, silicone, polybutadiene, or hydrogenated polybutadiene butane, and o, p, q, and r each independently represent an integer from 2 to 500)

### (Method for Producing Separator)

The method for producing a separator according to an embodiment of the present invention includes an insulating layer-forming step, wherein the insulating layer-forming step includes an insulating layer-forming liquid composition application step of applying an insulating layer-forming liquid composition on a separator substrate, and other steps if preferable.

Note that, because the method for producing a separator according to an embodiment of the present invention is the same as that described herein under the heading (Method for Producing Electrode) except for using a separator substrate as the substrate, duplicate descriptions will be omitted.

### EXAMPLES

The present invention is described in detail below by way of Examples and Comparative Examples. However, the present invention is not limited to the Examples. Note that, in the following Examples and Comparative Examples, the term “parts” refers to “parts by mass” and the “%” refers to “% by mass”, unless otherwise specified.

### Example 1

### <Preparation of Insulating Layer-Forming Liquid Composition>

A pre-dispersion liquid obtained by mixing 30.0 parts of α-alumina (CT3000LSSG, manufactured by Almatis) as insulating inorganic particles, 0.9 parts of SC-0505K (manufactured by NOF Corporation) as a dispersant, 0.3 parts of DBE-C25 (manufactured by Gelest) as a crosslinking agent, 3.5 parts of Kynar Aquatec ARC (manufactured by Arkema) as a binder, and 65.3 parts of ethyl lactate as a solvent were placed in a glass ball mill pot together with 5 mm @ zirconium beads. The insulating layer-forming liquid composition was obtained by placing the sealed pot on a mill rotating table, and dispersing the mixture. Note that the rotation speed of the pot during dispersion was 35 rpm, and the dispersion was determined to have been completed when the viscosity change reached a steady state.

### <Production of Negative Electrode>

A negative electrode composite layer-forming liquid composition was prepared by mixing 97 parts of graphite (manufactured by JFE Chemical Corporation, model number BTM-DMP), 1 part by mass of a thickener (carboxymethyl cellulose, manufactured by Daiichi Kogyo Seiyaku Co., Ltd., model number CELLOGEN HS-6), 2 parts by mass of polymeric styrene butadiene rubber (manufactured by JSR, model number TRD-104A), and 100 parts by mass of water as a solvent.

The negative electrode composite layer-forming liquid composition was applied onto a negative electrode substrate made of copper (manufactured by Furukawa Electric Co., Ltd., model number NC-WS, foil thickness 10 μm) and then dried to obtain a negative electrode having a negative electrode composite layer formed on both surfaces with a coating amount per unit area (area density) of 9 mg/cm² on each surface. At this time, the thickness of the negative electrode was 216 μm, and the volumetric density of the negative electrode was 0.91 g/cm³.

Next, the negative electrode was pressed with a roll press machine such that the volumetric density of the negative electrode was 1.6 g/cm³, and the negative electrode to be used was obtained.

### <Production of Positive Electrode>

A mixture of 92 parts of lithium nickel oxide (NCM) (manufactured by Beijing Easpring Material Technology Co., Ltd., model number ME6E) as a positive electrode active material, 3 parts of Ketjen black (manufactured by Lion Corporation, model number 600JD) as a conductive material, and 5 parts of PVDF (polyvinylidene fluoride, manufactured by Solvay, model number Solef 5130) as an electrode composite layer binder was prepared, and the mixture was dispersed in N-methylpyrrolidone (NMP) (manufactured by Mitsubishi Chemical Corporation) to produce a slurry. The slurry was applied onto a positive electrode substrate made of aluminum (manufactured by UACJ Corporation, model number 1N30) and then dried to obtain a positive electrode having a positive electrode composite layer formed on both surfaces with a coating amount per unit area (area density) of 15.0 mg/cm². Next, the positive electrode was subjected to compression molding using a roll press machine such that the volumetric density of the positive electrode was 3.4 g/cm³, and was used as the positive electrode.

### <Formation of Insulating Layer>

The insulating layer-forming liquid composition was applied onto the substrate to be coated (the positive electrode composite layer, the separator, and the substrate). The coating was performed using an inkjet or bar coater, and then the dispersion medium was volatilized in a hot air drying oven heated to 120° C. to form an insulating layer with an average thickness of about 3 μm (insulating layer-forming liquid composition primary drying step). Then, the insulating layer-forming liquid composition secondary drying step was carried out by heating to 120° C. under a reduced pressure of 0.1 MPa as measured by a differential pressure gauge by using a vacuum oven, and holding the conditions for 12 hours.

### Examples 2 to 199 and Comparative Examples 1 to 5

The insulating layer-forming liquid compositions and insulating layers were produced in the same manner as in Example 1, except for changes to the composition of the insulating layer-forming liquid composition as presented in Tables 1 to 15.

The details of the materials used in each of the Examples and Comparative Examples is as follows.

### -Insulating Inorganic Particles-

CT-3000LSSG (manufactured by Almatis)
BMB-07 (Kawai Lime Industry Co., Ltd.)

### -Dispersant-

SC-0505K (manufactured by NOF Corporation)
SC-0708A (manufactured by NOF Corporation)
AKM0531 (manufactured by NOF Corporation)
AKM0531 (60% aqueous solution) (dispersion liquid of AKM0531 diluted with water to a concentration of 60%, manufactured by NOF Corporation)
HKM-50A (manufactured by NOF Corporation)

### -Comparative Dispersant-

CMCNa (carboxymethylcellulose sodium, manufactured by Kanto Chemical Co., Ltd.)
   -Crosslinking agent-
DBE-C25 (manufactured by Gelest)
K-FLEX UD-320-100 (manufactured by Kings Industries Inc.)
epan 740 (manufactured by Daiichi Kogyo Seiyaku Co., Ltd., R2: poloxamer)
K-FLEX 148 (manufactured by Kings Industries Inc.)
Jeffamine ED-2003 (manufactured by Huntsman Corporation)

### -Binder-

Kynar Aquatec ARC (manufactured by Arkema)
Kynar Aquatec CRX (manufactured by Arkema)
Kynar Flex LBG-2200LX (manufactured by Arkema)
Lumiflon FE4300 (manufactured by AGC Inc.)
MPT-N8 (manufactured by Mitsubishi Pencil Co., Ltd.)
BM-900B (manufactured by Zeon Corporation)
Kynar Aquatec FMA-12 (manufactured by Arkema)

### -Comparative Binder-

Polymaron 1343S (manufactured by Arakawa Chemical Industries Ltd.)
AC Polyethylene 629 (Honeywell Inc.)

### -Dispersion Medium Material-

EL (ethyl lactate, manufactured by Kanto Chemical Co., Ltd.)
H₂O sol. (H₂O: IPA: PG=2:1:1 solution)

TABLE 1

| | | Insulating layer-forming liquid composition | | | | | | | | |
|---|---|---|---|---|---|---|---|---|---|---|
| | | Insulating inorganic | | | Dispersant | | | | | |
| | | particles | | | | | | Solubility in | Crosslinking | |
| | | | | Content | | Structural | Content | electrolytic | agent | |
| | | | | [% by | | unit | [% by | solution when | | Structural |
| | | Material | Type | mass] | Material | included | mass] | dried | Material | unit included |
| Example | 1 | CT3000LSSG | α-alumina | 30 | SC-0505K | (1) | 0.9 | Good | DBE-C25 | (4) |
| | | | | | | | | | | R2: Silicone |
| | | | | | | | | | | R3, R4: Hydroxyl group |
| | 2 | CT3000LSSG | α-alumina | 30 | SC-0505K | (1) | 0.9 | Good | DBE-C25 | (4) |
| | | | | | | | | | | R2: Silicone |
| | | | | | | | | | | R3, R4: Hydroxyl group |
| | 3 | CT3000LSSG | α-alumina | 30 | SC-0505K | (1) | 0.9 | Good | DBE-C25 | (4) |
| | | | | | | | | | | R2: Silicone |
| | | | | | | | | | | R3, R4: Hydroxyl group |
| | 4 | CT3000LSSG | α-alumina | 30 | SC-0505K | (1) | 0.9 | Good | DBE-C25 | (4) |
| | | | | | | | | | | R2: Silicone |
| | | | | | | | | | | R3, R4: Hydroxyl group |
| | 5 | CT3000LSSG | α-alumina | 30 | SC-0505K | (1) | 0.9 | Good | DBE-C25 | (4) |
| | | | | | | | | | | R2: Silicone |
| | | | | | | | | | | R3, R4: Hydroxyl group |
| | 6 | BMB-07 | Boehmite | 30 | SC-0505K | (1) | 0.9 | Good | DBE-C25 | (4) |
| | | | | | | | | | | R2: Silicone |
| | | | | | | | | | | R3, R4: Hydroxyl group |
| | 7 | BMB-07 | Boehmite | 30 | SC-0505K | (1) | 0.9 | Good | DBE-C25 | (4) |
| | | | | | | | | | | R2: Silicone |
| | | | | | | | | | | R3, R4: Hydroxyl group |
| | 8 | BMB-07 | Boehmite | 30 | SC-0505K | (1) | 0.9 | Good | DBE-C25 | (4) |
| | | | | | | | | | | R2: Silicone |
| | | | | | | | | | | R3, R4: Hydroxyl group |
| | 9 | BMB-07 | Boehmite | 30 | SC-050SK | (1) | 0.9 | Good | DBE-C25 | (4) |
| | | | | | | | | | | R2: Silicone |
| | | | | | | | | | | R3, R4: Hydroxyl group |
| | 10 | BMB-07 | Boehmite | 30 | SC-0505K | (1) | 0.9 | Good | DBE-C25 | (4) |
| | | | | | | | | | | R2: Silicone |
| | | | | | | | | | | R3, R4: Hydroxyl group |
| | 11 | CT3000LSSG | α-alumina | 30 | SC-0708A | (1) | 0.9 | Good | DBE-C25 | (4) |
| | | | | | | | | | | R2: Silicone |
| | | | | | | | | | | R3, R4: Hydroxyl group |
| | 12 | CT3000LSSG | α-alumina | 30 | SC-0708A | (1) | 0.9 | Good | DBE-C25 | (4) |
| | | | | | | | | | | R2: Silicone |
| | | | | | | | | | | R3, R4: Hydroxyl group |
| | 13 | CT3000LSSG | α-alumina | 30 | SC-0708A | (1) | 0.9 | Good | DBE-C25 | (4) |
| | | | | | | | | | | R2: Silicone |
| | | | | | | | | | | R3, R4: Hydroxyl group |
| | 14 | CT3000LSSG | α-alumina | 30 | SC-0708A | (1) | 0.9 | Good | DBE-C25 | (4) |
| | | | | | | | | | | R2: Silicone |
| | | | | | | | | | | R3, R4: Hydroxyl group |
| | 15 | CT3000LSSG | α-alumina | 30 | SC-0708A | (1) | 0.9 | Good | DBE-C25 | (4) |
| | | | | | | | | | | R2: Silicone |
| | | | | | | | | | | R3, R4: Hydroxyl group |

| | | Insulating layer-forming liquid composition | | | | | | | |
|---|---|---|---|---|---|---|---|---|---|
| | | Crosslinking | | | | | | | |
| | | agent | Binder | | | | Dispersion medium | | |
| | | Content | | | Content | Dispersibility | | Content | Total |
| | | [% by | | | [% by | in electrolytic | | [% by | [% by |
| | | mass] | Material | Type | mass] | solution | Material | mass] | mass] |
| Example | 1 | 0.3 | ARC | PVDF-HFP:Acrylic IPN | 3.5 | Good | EL | 65.3 | 100 |
| | | | | (PVDF:Acrylic = 7:3) | | | | | |
| | 2 | 0.3 | CRX | PVDF-HFP:Acrylic IPN | 3.5 | Good | EL | 65.3 | 100 |
| | | | | (PVDF:Acrylic = 7:3) | | | | | |
| | 3 | 0.3 | LBG-2200LX | PVDF-HFP | 5.6 | Good | EL | 63.2 | 100 |
| | 4 | 0.3 | FE4300 | FEVE | 3.0 | Poor | EL | 65.8 | 100 |
| | 5 | 0.3 | MPT-N8 | PTFE | 3.5 | Poor | EL | 65.3 | 100 |
| | 6 | 0.3 | ARC | PVDF-HFP:Acrylic IPN | 3.5 | Good | EL | 65.3 | 100 |
| | | | | (PVDF:Acrylic = 7:3) | | | | | |
| | 7 | 0.3 | CRX | PVDF-HFP:Acrylic IPN | 3.5 | Good | EL | 65.3 | 100 |
| | | | | (PVDF:Acrylic = 7:3) | | | | | |
| | 8 | 0.3 | LBG-2200LX | PVDF-HFP | 5.6 | Good | EL | 63.2 | 100 |
| | 9 | 0.3 | FE4300 | FEVE | 3.0 | Poor | EL | 65.8 | 100 |
| | 10 | 0.3 | MPT-N8 | PTFE | 3.5 | Poor | EL | 65.3 | 100 |
| | 11 | 0.3 | ARC | PVDF-HFP:Acrylic IPN | 3.5 | Good | EL | 65.3 | 100 |
| | | | | (PVDF:Acrylic = 7:3) | | | | | |
| | 12 | 0.3 | CRX | PVDF-HFP:Acrylic IPN | 3.5 | Good | EL | 65.3 | 100 |
| | | | | (PVDF:Acrylic = 7:3) | | | | | |
| | 13 | 0.3 | LBG-2200LX | PVDF-HFP | 5.6 | Good | EL | 63.2 | 100 |
| | 14 | 0.3 | FE4300 | FEVE | 3.0 | Poor | EL | 65.8 | 100 |
| | 15 | 0.3 | MPT-N8 | PTFE | 3.5 | Poor | EL | 65.3 | 100 |

TABLE 2

| | | Insulating layer-forming liquid composition | | | | | | | | |
|---|---|---|---|---|---|---|---|---|---|---|
| | | Insulating inorganic | | | Dispersant | | | | | |
| | | particles | | | | | | Solubility in | Crosslinking | |
| | | | | Content | | Structural | Content | electrolytic | agent | |
| | | | | [% by | | unit | [% by | solution when | | Structural |
| | | Material | Type | mass] | Material | included | mass] | dried | Material | unit included |
| Example | 16 | BMB-07 | Boehmite | 30 | SC-0708A | (1) | 0.9 | Good | DBE-C25 | (4) |
| | | | | | | | | | | R2: Silicone |
| | | | | | | | | | | R3, R4: Hydroxyl group |
| | 17 | BMB-07 | Boehmite | 30 | SC-0708A | (1) | 0.9 | Good | DBE-C25 | (4) |
| | | | | | | | | | | R2: Silicone |
| | | | | | | | | | | R3, R4: Hydroxyl group |
| | 18 | BMB-07 | Boehmite | 30 | SC-0708A | (1) | 0.9 | Good | DBE-C25 | (4) |
| | | | | | | | | | | R2: Silicone |
| | | | | | | | | | | R3, R4: Hydroxyl group |
| | 19 | BMB-07 | Boehmite | 30 | SC-0708A | (1) | 0.9 | Good | DBE-C25 | (4) |
| | | | | | | | | | | R2: Silicone |
| | | | | | | | | | | R3, R4: Hydroxyl group |
| | 20 | BMB-07 | Boehmite | 30 | SC-0708A | (1) | 0.9 | Good | DBE-C25 | (4) |
| | | | | | | | | | | R2: Silicone |
| | | | | | | | | | | R3, R4: Hydroxyl group |
| | 21 | CT3000LSSG | α-alumina | 30 | AKM-0531 | (1) | 0.9 | Good | DBE-C25 | (4) |
| | | | | | | | | | | R2: Silicone |
| | | | | | | | | | | R3, R4: Hydroxyl group |
| | 22 | CT3000LSSG | α-alumina | 30 | AKM-0531 | (1) | 0.9 | Good | DBE-C25 | (4) |
| | | | | | | | | | | R2: Silicone |
| | | | | | | | | | | R3, R4: Hydroxyl group |
| | 23 | CT3000LSSG | α-alumina | 30 | AKM-0531 | (1) | 0.9 | Good | DBE-C25 | (4) |
| | | | | | | | | | | R2: Silicone |
| | | | | | | | | | | R3, R4: Hydroxyl group |
| | 24 | CT3000LSSG | α-alumina | 30 | AKM-0531 | (1) | 0.9 | Good | DBE-C25 | (4) |
| | | | | | | | | | | R2: Silicone |
| | | | | | | | | | | R3, R4: Hydroxyl group |
| | 25 | CT3000LSSG | α-alumina | 30 | AKM-0531 | (1) | 0.9 | Good | DBE-C25 | (4) |
| | | | | | | | | | | R2: Silicone |
| | | | | | | | | | | R3, R4: Hydroxyl group |
| | 26 | BMB-07 | Boehmite | 30 | AKM-0531 | (1) | 0.9 | Good | DBE-C25 | (4) |
| | | | | | | | | | | R2: Silicone |
| | | | | | | | | | | R3, R4: Hydroxyl group |
| | 27 | BMB-07 | Boehmite | 30 | AKM-0531 | (1) | 0.9 | Good | DBE-C25 | (4) |
| | | | | | | | | | | R2: Silicone |
| | | | | | | | | | | R3, R4: Hydroxyl group |
| | 28 | BMB-07 | Boehmite | 30 | AKM-0531 | (1) | 0.9 | Good | DBE-C25 | (4) |
| | | | | | | | | | | R2: Silicone |
| | | | | | | | | | | R3, R4: Hydroxyl group |
| | 29 | BMB-07 | Boehmite | 30 | AKM-0531 | (1) | 0.9 | Good | DBE-C25 | (4) |
| | | | | | | | | | | R2: Silicone |
| | | | | | | | | | | R3, R4: Hydroxyl group |
| | 30 | BMB-07 | Boehmite | 30 | AKM-0531 | (1) | 0.9 | Good | DBE-C25 | (4) |
| | | | | | | | | | | R2: Silicone |
| | | | | | | | | | | R3, R4: Hydroxyl group |

| | | Insulating layer-forming liquid composition | | | | | | | |
|---|---|---|---|---|---|---|---|---|---|
| | | Crosslinking | | | | | | | |
| | | agent | Binder | | | | Dispersion medium | | |
| | | Content | | | Content | Dispersibility | | Content | Total |
| | | [% by | | | [% by | in electrolytic | | [% by | [% by |
| | | mass] | Material | Type | mass] | solution | Material | mass] | mass] |
| Example | 16 | 0.3 | ARC | PVDF-HFP:Acrylic IPN | 3.5 | Good | EL | 65.3 | 100 |
| | | | | (PVDF:Acrylic = 7:3) | | | | | |
| | 17 | 0.3 | CRX | PVDF-HFP:Acrylic IPN | 3.5 | Good | EL | 65.3 | 100 |
| | | | | (PVDF:Acrylic = 7:3) | | | | | |
| | 18 | 0.3 | LBG-2200LX | PVDF-HFP | 5.6 | Good | EL | 63.2 | 100 |
| | 19 | 0.3 | FE4300 | FEVE | 3.0 | Poor | EL | 65.8 | 100 |
| | 20 | 0.3 | MPT-N8 | PTFE | 3.5 | Poor | EL | 65.3 | 100 |
| | 21 | 0.3 | ARC | PVDF-HFP:Acrylic IPN | 3.5 | Good | EL | 65.3 | 100 |
| | | | | (PVDF:Acrylic = 7:3) | | | | | |
| | 22 | 0.3 | CRX | PVDF-HFP:Acrylic IPN | 3.5 | Good | EL | 65.3 | 100 |
| | | | | (PVDF:Acrylic = 7:3) | | | | | |
| | 23 | 0.3 | LBG-2200LX | PVDF-HFP | 5.6 | Good | EL | 63.2 | 100 |
| | 24 | 0.3 | FE4300 | FEVE | 3.0 | Poor | EL | 65.8 | 100 |
| | 25 | 0.3 | MPT-N8 | PTFE | 3.5 | Poor | EL | 65.3 | 100 |
| | 26 | 0.3 | ARC | PVDF-HFP:Acrylic IPN | 3.5 | Good | EL | 65.3 | 100 |
| | | | | (PVDF:Acrylic = 7:3) | | | | | |
| | 27 | 0.3 | CRX | PVDF-HFP:Acrylic IPN | 3.5 | Good | EL | 65.3 | 100 |
| | | | | (PVDF:Acrylic = 7:3) | | | | | |
| | 28 | 0.3 | LBG-2200LX | PVDF-HFP | 5.6 | Good | EL | 63.2 | 100 |
| | 29 | 0.3 | FE4300 | FEVE | 3.0 | Poor | EL | 65.8 | 100 |
| | 30 | 0.3 | MPT-N8 | PTFE | 3.5 | Poor | EL | 65.3 | 100 |

TABLE 3

| | | Insulating layer-forming liquid composition | | | | | | | | |
|---|---|---|---|---|---|---|---|---|---|---|
| | | Insulating inorganic | | | Dispersant | | | | | |
| | | particles | | | | | | Solubility in | Crosslinking | |
| | | | | Content | | Structural | Content | electrolytic | agent | |
| | | | | [% by | | unit | [% by | solution when | | Structural |
| | | Material | Type | mass] | Material | included | mass] | dried | Material | unit included |
| Example | 31 | CT3000LSSG | α-alumina | 30 | HKM-50A | (2)or(3) | 1.8 | Good | DBE-C25 | (4) |
| | | | | | | | | | | R2: Silicone |
| | | | | | | | | | | R3, R4: Hydroxyl group |
| | 32 | CT3000LSSG | α-alumina | 30 | HKM-50A | (2)or(3) | 1.8 | Good | DBE-C25 | (4) |
| | | | | | | | | | | R2: Silicone |
| | | | | | | | | | | R3, R4: Hydroxyl group |
| | 33 | CT3000LSSG | α-alumina | 30 | HKM-50A | (2)or(3) | 1.8 | Good | DBE-C25 | (4) |
| | | | | | | | | | | R2: Silicone |
| | | | | | | | | | | R3, R4: Hydroxyl group |
| | 34 | CT3000LSSG | α-alumina | 30 | HKM-50A | (2)or(3) | 1.8 | Good | DBE-C25 | (4) |
| | | | | | | | | | | R2: Silicone |
| | | | | | | | | | | R3, R4: Hydroxyl group |
| | 35 | BMB-07 | Boehmite | 30 | HKM-50A | (2)or(3) | 1.8 | Good | DBE-C25 | (4) |
| | | | | | | | | | | R2: Silicone |
| | | | | | | | | | | R3, R4: Hydroxyl group |
| | 36 | BMB-07 | Boehmite | 30 | HKM-50A | (2)or(3) | 1.8 | Good | DBE-C25 | (4) |
| | | | | | | | | | | R2: Silicone |
| | | | | | | | | | | R3, R4: Hydroxyl group |
| | 37 | BMB-07 | Boehmite | 30 | HKM-50A | (2)or(3) | 1.8 | Good | DBE-C25 | (4) |
| | | | | | | | | | | R2: Silicone |
| | | | | | | | | | | R3, R4: Hydroxyl group |
| | 38 | BMB-07 | Boehmite | 30 | HKM-50A | (2)or(3) | 1.8 | Good | DBE-C25 | (4) |
| | | | | | | | | | | R2: Silicone |
| | | | | | | | | | | R3, R4: Hydroxyl group |
| | 39 | CT3000LSSG | α-alumina | 30 | AKM-0531 | (1), (2)or(3) | 1.5 | Good | DBE-C25 | (4) |
| | | | | | (60% aqueous | | | | | R2: Silicone |
| | | | | | solution) | | | | | R3, R4: Hydroxyl group |
| | 40 | CT3000LSSG | α-alumina | 30 | AKM-0531 | (1), (2)or(3) | 1.5 | Good | DBE-C25 | (4) |
| | | | | | (60% aqueous | | | | | R2: Silicone |
| | | | | | solution) | | | | | R3, R4: Hydroxyl group |
| | 41 | CT3000LSSG | α-alumina | 30 | AKM-0531 | (1), (2)or(3) | 1.5 | Good | DBE-C25 | (4) |
| | | | | | (60% aqueous | | | | | R2: Silicone |
| | | | | | solution) | | | | | R3, R4: Hydroxyl group |
| | 42 | CT3000LSSG | α-alumina | 30 | AKM-0531 | (1), (2)or(3) | 1.5 | Good | DBE-C25 | (4) |
| | | | | | (60% aqueous | | | | | R2: Silicone |
| | | | | | solution) | | | | | R3, R4: Hydroxyl group |
| | 43 | BMB-07 | Boehmite | 30 | AKM-0531 | (1), (2)or(3) | 1.5 | Good | DBE-C25 | (4) |
| | | | | | (60% aqueous | | | | | R2: Silicone |
| | | | | | solution) | | | | | R3, R4: Hydroxyl group |
| | 44 | BMB-07 | Boehmite | 30 | AKM-0531 | (1), (2)or(3) | 1.5 | Good | DBE-C25 | (4) |
| | | | | | (60% aqueous | | | | | R2: Silicone |
| | | | | | solution) | | | | | R3, R4: Hydroxyl group |
| | 45 | BMB-07 | Boehmite | 30 | AKM-0531 | (1), (2)or(3) | 1.5 | Good | DBE-C25 | (4) |
| | | | | | (60% aqueous | | | | | R2: Silicone |
| | | | | | solution) | | | | | R3, R4: Hydroxyl group |

| | | Insulating layer-forming liquid composition | | | | | | | |
|---|---|---|---|---|---|---|---|---|---|
| | | Crosslinking | | | | | | | |
| | | agent | Binder | | | | Dispersion medium | | |
| | | Content | | | Content | Dispersibility | | Content | Total |
| | | [% by | | | [% by | in electrolytic | | [% by | [% by |
| | | mass] | Material | Type | mass] | solution | Material | mass] | mass] |
| Example | 31 | 0.3 | ARC | PVDF-HFP:Acrylic IPN | 3.5 | Good | H₂O sol. | 64.4 | 100 |
| | | | | (PVDF:Acrylic = 7:3) | | | | | |
| | 32 | 0.3 | CRX | PVDF-HFP:Acrylic IPN | 3.5 | Good | H₂O sol. | 64.4 | 100 |
| | | | | (PVDF:Acrylic = 7:3) | | | | | |
| | 33 | 0.3 | LBG-2200LX | PVDF-HFP | 5.6 | Good | H₂O sol. | 62.4 | 100 |
| | 34 | 0.3 | FE4300 | FEVE | 3.0 | Poor | H₂O sol. | 64.9 | 100 |
| | 35 | 0.3 | ARC | PVDF-HPP:Acrylic IPN | 3.5 | Good | H₂O sol. | 64.4 | 100 |
| | | | | (PVDF:Acrylic = 7:3) | | | | | |
| | 36 | 0.3 | CRX | PVDF-HFP:Acrylic IPN | 3.5 | Good | H₂O sol. | 64.4 | 100 |
| | | | | (PVDF:Acrylic = 7:3) | | | | | |
| | 37 | 0.3 | LBG-2200LX | PVDF-HFP | 5.6 | Good | H₂O sol. | 62.4 | 100 |
| | 38 | 0.3 | FE4300 | FEVE | 3.0 | Poor | H₂O sol. | 64.9 | 100 |
| | 39 | 0.3 | ARC | PVDF-HFP:Acrylic IPN | 3.5 | Good | H₂O sol. | 64.7 | 100 |
| | | | | (PVDF:Acrylic = 7:3) | | | | | |
| | 40 | 0.3 | CRX | PVDF-HFP:Acrylic IPN | 3.5 | Good | H₂O sol. | 64.7 | 100 |
| | | | | (PVDF:Acrylic = 7:3) | | | | | |
| | 41 | 0.3 | LBG-2200LX | PVDF-HFP | 5.6 | Good | H₂O sol. | 62.6 | 100 |
| | 42 | 0.3 | FE4300 | FEVE | 3.0 | Poor | H₂O sol. | 65.2 | 100 |
| | 43 | 0.3 | ARC | PVDF-HFP:Acrylic IPN | 3.5 | Good | H₂O sol. | 64.7 | 100 |
| | | | | (PVDF:Acrylic = 7:3) | | | | | |
| | 44 | 0.3 | CRX | PVDF-HPP:Acrylic IPN | 3.5 | Good | H₂O sol. | 64.7 | 100 |
| | | | | (PVDF:Acrylic = 7:3) | | | | | |
| | 45 | 0.3 | LBG-2200LX | PVDF-HFP | 5.6 | Good | H₂O sol. | 62.6 | 100 |

TABLE 4

| | | Insulating layer-forming liquid composition | | | | | | | | |
|---|---|---|---|---|---|---|---|---|---|---|
| | | Insulating inorganic | | | Dispersant | | | | | |
| | | particles | | | | | | Solubility in | Crosslinking | |
| | | | | Content | | Structural | Content | electrolytic | agent | |
| | | | | [% by | | unit | [% by | solution when | | Structural |
| | | Material | Type | mass] | Material | included | mass] | dried | Material | unit included |
| Example | 46 | BMB-07 | Boehmite | 30 | AKM-0531 | (1), (2)or(3) | 1.5 | Good | DBE-C25 | (4) |
| | | | | | (60% aqueous | | | | | R2: Silicone |
| | | | | | solution) | | | | | R3, R4: Hydroxyl group |
| | 47 | CT3000LSSG | α-alumina | 30 | SC-0505K | (1) | 0.9 | Good | UD-320 | (4) |
| | | | | | | | | | | R2: Urethane |
| | | | | | | | | | | R3, R4: Hydroxyl group |
| | 48 | CT3000LSSG | α-alumina | 30 | SC-0505K | (1) | 0.9 | Good | UD-320 | (4) |
| | | | | | | | | | | R2: Urethane |
| | | | | | | | | | | R3, R4: Hydroxyl group |
| | 49 | CT3000LSSG | α-alumina | 30 | SC-0505K | (1) | 0.9 | Good | UD-320 | (4) |
| | | | | | | | | | | R2: Urethane |
| | | | | | | | | | | R3, R4: Hydroxyl group |
| | 50 | CT3000LSSG | α-alumina | 30 | SC-0505K | (1) | 0.9 | Good | UD-320 | (4) |
| | | | | | | | | | | R2: Urethane |
| | | | | | | | | | | R3, R4: Hydroxyl group |
| | 51 | CT3000LSSG | α-alumina | 30 | SC-0505K | (1) | 0.9 | Good | UD-320 | (4) |
| | | | | | | | | | | R2: Urethane |
| | | | | | | | | | | R3, R4: Hydroxyl group |
| | 52 | BMB-07 | Boehmite | 30 | SC-0505K | (1) | 0.9 | Good | UD-320 | (4) |
| | | | | | | | | | | R2: Urethane |
| | | | | | | | | | | R3, R4: Hydroxyl group |
| | 53 | BMB-07 | Boehmite | 30 | SC-0505K | (1) | 0.9 | Good | UD-320 | (4) |
| | | | | | | | | | | R2: Urethane |
| | | | | | | | | | | R3, R4: Hydroxyl group |
| | 54 | BMB-07 | Boehmite | 30 | SC-0505K | (1) | 0.9 | Good | UD-320 | (4) |
| | | | | | | | | | | R2: Urethane |
| | | | | | | | | | | R3, R4: Hydroxyl group |
| | 55 | BMB-07 | Boehmite | 30 | SC-0505K | (1) | 0.9 | Good | UD-320 | (4) |
| | | | | | | | | | | R2: Urethane |
| | | | | | | | | | | R3, R4: Hydroxyl group |
| | 56 | BMB-07 | Boehmite | 30 | SC-0505K | (1) | 0.9 | Good | UD-320 | (4) |
| | | | | | | | | | | R2: Urethane |
| | | | | | | | | | | R3, R4: Hydroxyl group |
| | 57 | CT3000LSSG | α-alumina | 30 | SC-0708A | (1) | 0.9 | Good | UD-320 | (4) |
| | | | | | | | | | | R2: Urethane |
| | | | | | | | | | | R3, R4: Hydroxyl group |
| | 58 | CT3000LSSG | α-alumina | 30 | SC-0708A | (1) | 0.9 | Good | UD-320 | (4) |
| | | | | | | | | | | R2: Urethane |
| | | | | | | | | | | R3, R4: Hydroxyl group |
| | 59 | CT3000LSSG | α-alumina | 30 | SC-0708A | (1) | 0.9 | Good | UD-320 | (4) |
| | | | | | | | | | | R2: Urethane |
| | | | | | | | | | | R3, R4: Hydroxyl group |
| | 60 | CT3000LSSG | α-alumina | 30 | SC-0708A | (1) | 0.9 | Good | UD-320 | (4) |
| | | | | | | | | | | R2: Urethane |
| | | | | | | | | | | R3, R4: Hydroxyl group |

| | | Insulating layer-forming liquid composition | | | | | | | |
|---|---|---|---|---|---|---|---|---|---|
| | | Crosslinking | | | | | | | |
| | | agent | Binder | | | | Dispersion medium | | |
| | | Content | | | Content | Dispersibility | | Content | Total |
| | | [% by | | | [% by | in electrolytic | | [% by | [% by |
| | | mass] | Material | Type | mass] | solution | Material | mass] | mass] |
| Example | 46 | 0.3 | FE4300 | FEVE | 3.0 | Poor | H₂O sol. | 65.2 | 100 |
| | 47 | 0.3 | ARC | PVDF-HFP:Acrylic IPN | 3.5 | Good | EL | 65.3 | 100 |
| | | | | (PVDF:Acrylic = 7:3) | | | | | |
| | 48 | 0.3 | CRX | PVDF-HFP:Acrylic IPN | 3.5 | Good | EL | 65.3 | 100 |
| | | | | (PVDF:Acrylic = 7:3) | | | | | |
| | 49 | 0.3 | LBG-2200LX | PVDF-HFP | 5.6 | Good | EL | 63.2 | 100 |
| | 50 | 0.3 | FE4300 | FEVE | 3.0 | Poor | EL | 65.8 | 100 |
| | 51 | 0.3 | MPT-N8 | PTFE | 3.5 | Poor | EL | 65.3 | 100 |
| | 52 | 0.3 | ARC | PVDF-HFP:Acrylic IPN | 3.5 | Good | EL | 65.3 | 100 |
| | | | | (PVDF:Acrylic = 7:3) | | | | | |
| | 53 | 0.3 | CRX | PVDF-HFP:Acrylic IPN | 3.5 | Good | EL | 65.3 | 100 |
| | | | | (PVDF:Acrylic = 7:3) | | | | | |
| | 54 | 0.3 | LBG-2200LX | PVDF-HFP | 5.6 | Good | EL | 63.2 | 100 |
| | 55 | 0.3 | FE4300 | FEVE | 3.0 | Poor | EL | 65.8 | 100 |
| | 56 | 0.3 | MPT-N8 | PTFE | 3.5 | Poor | EL | 65.3 | 100 |
| | 57 | 0.3 | ARC | PVDF-HFP:Acrylic IPN | 3.5 | Good | EL | 65.3 | 100 |
| | | | | (PVDF:Acrylic = 7:3) | | | | | |
| | 58 | 0.3 | CRX | PVDF-HFP:Acrylic IPN | 3.5 | Good | EL | 65.3 | 100 |
| | | | | (PVDF:Acrylic = 7:3) | | | | | |
| | 59 | 0.3 | LBG-2200LX | PVDF-HFP | 5.6 | Good | EL | 63.2 | 100 |
| | 60 | 0.3 | FE4300 | FEVE | 3.0 | Poor | EL | 65.8 | 100 |

TABLE 5

| | | Insulating layer-forming liquid composition | | | | | | | | |
|---|---|---|---|---|---|---|---|---|---|---|
| | | Insulating inorganic | | | Dispersant | | | | | |
| | | particles | | | | | | Solubility in | Crosslinking | |
| | | | | Content | | Structural | Content | electrolytic | agent | |
| | | | | [% by | | unit | [% by | solution when | | Structural |
| | | Material | Type | mass] | Material | included | mass] | dried | Material | unit included |
| Example | 61 | CT3000LSSG | α-alumina | 30 | SC-0708A | (1) | 0.9 | Good | UD-320 | (4) |
| | | | | | | | | | | R2: Urethane |
| | | | | | | | | | | R3, R4: Hydroxyl group |
| | 62 | BMB-07 | Boehmite | 30 | SC-0708A | (1) | 0.9 | Good | UD-320 | (4) |
| | | | | | | | | | | R2: Urethane |
| | | | | | | | | | | R3, R4: Hydroxyl group |
| | 63 | BMB-07 | Boehmite | 30 | SC-0708A | (1) | 0.9 | Good | UD-320 | (4) |
| | | | | | | | | | | R2: Urethane |
| | | | | | | | | | | R3, R4: Hydroxyl group |
| | 64 | BMB-07 | Boehmite | 30 | SC-0708A | (1) | 0.9 | Good | UD-320 | (4) |
| | | | | | | | | | | R2: Urethane |
| | | | | | | | | | | R3, R4: Hydroxyl group |
| | 65 | BMB-07 | Boehmite | 30 | SC-0708A | (1) | 0.9 | Good | UD-320 | (4) |
| | | | | | | | | | | R2: Urethane |
| | | | | | | | | | | R3, R4: Hydroxyl group |
| | 66 | BMB-07 | Boehmite | 30 | SC-0708A | (1) | 0.9 | Good | UD-320 | (4) |
| | | | | | | | | | | R2: Urethane |
| | | | | | | | | | | R3, R4: Hydroxyl group |
| | 67 | CT3000LSSG | α-alumina | 30 | AKM-0531 | (1) | 0.9 | Good | UD-320 | (4) |
| | | | | | | | | | | R2: Urethane |
| | | | | | | | | | | R3, R4: Hydroxyl group |
| | 68 | CT3000LSSG | α-alumina | 30 | AKM-0531 | (1) | 0.9 | Good | UD-320 | (4) |
| | | | | | | | | | | R2: Urethane |
| | | | | | | | | | | R3, R4: Hydroxyl group |
| | 69 | CT3000LSSG | α-alumina | 30 | AKM-0531 | (1) | 0.9 | Good | UD-320 | (4) |
| | | | | | | | | | | R2: Urethane |
| | | | | | | | | | | R3, R4: Hydroxyl group |
| | 70 | CT3000LSSG | α-alumina | 30 | AKM-0531 | (1) | 0.9 | Good | UD-320 | (4) |
| | | | | | | | | | | R2: Urethane |
| | | | | | | | | | | R3, R4: Hydroxyl group |
| | 71 | CT3000LSSG | α-alumina | 30 | AKM-0531 | (1) | 0.9 | Good | UD-320 | (4) |
| | | | | | | | | | | R2: Urethane |
| | | | | | | | | | | R3, R4: Hydroxyl group |
| | 72 | BMB-07 | Boehmite | 30 | AKM-0531 | (1) | 0.9 | Good | UD-320 | (4) |
| | | | | | | | | | | R2: Urethane |
| | | | | | | | | | | R3, R4: Hydroxyl group |
| | 73 | BMB-07 | Boehmite | 30 | AKM-0531 | (1) | 0.9 | Good | UD-320 | (4) |
| | | | | | | | | | | R2: Urethane |
| | | | | | | | | | | R3, R4: Hydroxyl group |
| | 74 | BMB-07 | Boehmite | 30 | AKM-0531 | (1) | 0.9 | Good | UD-320 | (4) |
| | | | | | | | | | | R2: Urethane |
| | | | | | | | | | | R3, R4: Hydroxyl group |
| | 75 | BMB-07 | Boehmite | 30 | AKM-0531 | (1) | 0.9 | Good | UD-320 | (4) |
| | | | | | | | | | | R2: Urethane |
| | | | | | | | | | | R3, R4: Hydroxyl group |

| | | Insulating layer-forming liquid composition | | | | | | | |
|---|---|---|---|---|---|---|---|---|---|
| | | Crosslinking | | | | | | | |
| | | agent | Binder | | | | Dispersion medium | | |
| | | Content | | | Content | Dispersibility | | Content | Total |
| | | [% by | | | [% by | in electrolytic | | [% by | [% by |
| | | mass] | Material | Type | mass] | solution | Material | mass] | mass] |
| Example | 61 | 0.3 | MPT-N8 | PTFE | 3.5 | Poor | EL | 65.3 | 100 |
| | 62 | 0.3 | ARC | PVDF-HFP:Acrylic IPN | 3.5 | Good | EL | 65.3 | 100 |
| | | | | (PVDF:Acrylic = 7:3) | | | | | |
| | 63 | 0.3 | CRX | PVDF-HFP:Acrylic IPN | 3.5 | Good | EL | 65.3 | 100 |
| | | | | (PVDF:Acrylic = 7:3) | | | | | |
| | 64 | 0.3 | LBG-2200LX | PVDF-HFP | 5.6 | Good | EL | 63.2 | 100 |
| | 65 | 0.3 | FE4300 | FEVE | 3.0 | Poor | EL | 65.8 | 100 |
| | 66 | 0.3 | MPT-N8 | PTFE | 3.5 | Poor | EL | 65.3 | 100 |
| | 67 | 0.3 | ARC | PVDF-HFP:Acrylic IPN | 3.5 | Good | EL | 65.3 | 100 |
| | | | | (PVDF:Acrylic = 7:3) | | | | | |
| | 68 | 0.3 | CRX | PVDF-HFP:Acrylic IPN | 3.5 | Good | EL | 65.3 | 100 |
| | | | | (PVDF:Acrylic = 7:3) | | | | | |
| | 69 | 0.3 | LBG-2200LX | PVDF-HFP | 5.6 | Good | EL | 63.2 | 100 |
| | 70 | 0.3 | FE4300 | FEVE | 3.0 | Poor | EL | 65.8 | 100 |
| | 71 | 0.3 | MPT-N8 | PTFE | 3.5 | Poor | EL | 65.3 | 100 |
| | 72 | 0.3 | ARC | PVDF-HFP:Acrylic IPN | 3.5 | Good | EL | 65.3 | 100 |
| | | | | (PVDF:Acrylic = 7:3) | | | | | |
| | 73 | 0.3 | CRX | PVDF-HFP:Acrylic IPN | 3.5 | Good | EL | 65.3 | 100 |
| | | | | (PVDF:Acrylic = 7:3) | | | | | |
| | 74 | 0.3 | LBG-2200LX | PVDF-HFP | 5.6 | Good | EL | 63.2 | 100 |
| | 75 | 0.3 | FE4300 | FEVE | 3.0 | Poor | EL | 65.8 | 100 |

TABLE 6

| | | Insulating layer-forming liquid composition | | | | | | | | |
|---|---|---|---|---|---|---|---|---|---|---|
| | | Insulating inorganic | | | Dispersant | | | | | |
| | | particles | | | | | | Solubility in | Crosslinking | |
| | | | | Content | | Structural | Content | electrolytic | agent | |
| | | | | [% by | | unit | [% by | solution when | | Structural |
| | | Material | Type | mass] | Material | included | mass] | dried | Material | unit included |
| Example | 76 | BMB-07 | Boehmite | 30 | AKM-0531 | (1) | 0.9 | Good | UD-320 | (4) |
| | | | | | | | | | | R2: Urethane |
| | | | | | | | | | | R3, R4: Hydroxyl group |
| | 77 | CT3000LSSG | α-alumina | 30 | HKM-50A | (2)or(3) | 1.8 | Good | UD-320 | (4) |
| | | | | | | | | | | R2: Urethane |
| | | | | | | | | | | R3, R4: Hydroxyl group |
| | 78 | CT3000LSSG | α-alumina | 30 | HKM-50A | (2)or(3) | 1.8 | Good | UD-320 | (4) |
| | | | | | | | | | | R2: Urethane |
| | | | | | | | | | | R3, R4: Hydroxyl group |
| | 79 | CT3000LSSG | α-alumina | 30 | HKM-50A | (2)or(3) | 1.8 | Good | UD-320 | (4) |
| | | | | | | | | | | R2: Urethane |
| | | | | | | | | | | R3, R4: Hydroxyl group |
| | 80 | CT3000LSSG | α-alumina | 30 | HKM-50A | (2)or(3) | 1.8 | Good | UD-320 | (4) |
| | | | | | | | | | | R2: Urethane |
| | | | | | | | | | | R3, R4: Hydroxyl group |
| | 81 | BMB-07 | Boehmite | 30 | HKM-50A | (2)or(3) | 1.8 | Good | UD-320 | (4) |
| | | | | | | | | | | R2: Urethane |
| | | | | | | | | | | R3, R4: Hydroxyl group |
| | 82 | BMB-07 | Boehmite | 30 | HKM-50A | (2)or(3) | 1.8 | Good | UD-320 | (4) |
| | | | | | | | | | | R2: Urethane |
| | | | | | | | | | | R3, R4: Hydroxyl group |
| | 83 | BMB-07 | Boehmite | 30 | HKM-50A | (2)or(3) | 1.8 | Good | UD-320 | (4) |
| | | | | | | | | | | R2: Urethane |
| | | | | | | | | | | R3, R4: Hydroxyl group |
| | 84 | BMB-07 | Boehmite | 30 | HKM-50A | (2)or(3) | 1.8 | Good | UD-320 | (4) |
| | | | | | | | | | | R2: Urethane |
| | | | | | | | | | | R3, R4: Hydroxyl group |
| | 85 | CT3000LSSG | α-alumina | 30 | AKM-0531 | (1), (2)or(3) | 1.5 | Good | UD-320 | (4) |
| | | | | | (60% aqueous | | | | | R2: Urethane |
| | | | | | solution) | | | | | R3, R4: Hydroxyl group |
| | 86 | CT3000LSSG | α-alumina | 30 | AKM-0531 | (1), (2)or(3) | 1.5 | Good | UD-320 | (4) |
| | | | | | (60% aqueous | | | | | R2: Urethane |
| | | | | | solution) | | | | | R3, R4: Hydroxyl group |
| | 87 | CT3000LSSG | α-alumina | 30 | AKM-0531 | (1), (2)or(3) | 1.5 | Good | UD-320 | (4) |
| | | | | | (60% aqueous | | | | | R2: Urethane |
| | | | | | solution) | | | | | R3, R4: Hydroxyl group |
| | 88 | CT3000LSSG | α-alumina | 30 | AKM-0531 | (1), (2)or(3) | 1.5 | Good | UD-320 | (4) |
| | | | | | (60% aqueous | | | | | R2: Urethane |
| | | | | | solution) | | | | | R3, R4: Hydroxyl group |
| | 89 | BMB-07 | Boehmite | 30 | AKM-0531 | (1), (2)or(3) | 1.5 | Good | UD-320 | (4) |
| | | | | | (60% aqueous | | | | | R2: Urethane |
| | | | | | solution) | | | | | R3, R4: Hydroxyl group |
| | 90 | BMB-07 | Boehmite | 30 | AKM-0531 | (1), (2)or(3) | 1.5 | Good | UD-320 | (4) |
| | | | | | (60% aqueous | | | | | R2: Urethane |
| | | | | | solution) | | | | | R3, R4: Hydroxyl group |

| | | Insulating layer-forming liquid composition | | | | | | | |
|---|---|---|---|---|---|---|---|---|---|
| | | Crosslinking | | | | | | | |
| | | agent | Binder | | | | Dispersion medium | | |
| | | Content | | | Content | Dispersibility | | Content | Total |
| | | [% by | | | [% by | in electrolytic | | [% by | [% by |
| | | mass] | Material | Type | mass] | solution | Material | mass] | mass] |
| Example | 76 | 0.3 | MPT-N8 | PTFE | 3.5 | Poor | EL | 65.3 | 100 |
| | 77 | 0.3 | ARC | PVDF-HFP:Acrylic IPN | 3.5 | Good | H₂O sol. | 64.4 | 100 |
| | | | | (PVDF:Acrylic = 7:3) | | | | | |
| | 78 | 0.3 | CRX | PVDF-HFP:Acrylic IPN | 3.5 | Good | H₂O sol. | 64.4 | 100 |
| | | | | (PVDF:Acrylic = 7:3) | | | | | |
| | 79 | 0.3 | LBG-2200LX | PVDF-HFP | 5.6 | Good | H₂O sol. | 62.4 | 100 |
| | 80 | 0.3 | FE4300 | FEVE | 3.0 | Poor | H₂O sol. | 64.9 | 100 |
| | 81 | 0.3 | ARC | PVDF-HFP:Acrylic IPN | 3.5 | Good | H₂O sol. | 64.4 | 100 |
| | | | | (PVDF:Acrylic = 7:3) | | | | | |
| | 82 | 0.3 | CRX | PVDF-HFP:Acrylic IPN | 3.5 | Good | H₂O sol. | 64.4 | 100 |
| | | | | (PVDF:Acrylic = 7:3) | | | | | |
| | 83 | 0.3 | LBG-2200LX | PVDF-HFP | 5.6 | Good | H₂O sol. | 62.4 | 100 |
| | 84 | 0.3 | FE4300 | FEVE | 3.0 | Poor | H₂O sol. | 64.9 | 100 |
| | 85 | 0.3 | ARC | PVDF-HFP:Acrylic IPN | 3.5 | Good | H₂O sol. | 64.7 | 100 |
| | | | | (PVDF:Acrylic = 7:3) | | | | | |
| | 86 | 0.3 | CRX | PVDF-HFP:Acrylic IPN | 3.5 | Good | H₂O sol. | 64.7 | 100 |
| | | | | (PVDF:Acrylic = 7:3) | | | | | |
| | 87 | 0.3 | LBG-2200LX | PVDF-HFP | 5.6 | Good | H₂O sol. | 62.6 | 100 |
| | 88 | 0.3 | FE4300 | FEVE | 3.0 | Poor | H₂O sol. | 65.2 | 100 |
| | 89 | 0.3 | ARC | PVDF-HFP:Acrylic IPN | 3.5 | Good | H₂O sol. | 64.7 | 100 |
| | | | | (PVDF:Acrylic = 7:3) | | | | | |
| | 90 | 0.3 | CRX | PVDF-HFP:Acrylic IPN | 3.5 | Good | H₂O sol. | 64.7 | 100 |
| | | | | (PVDF:Acrylic = 7:3) | | | | | |

TABLE 7

| | | Insulating layer-forming liquid composition | | | | | | | | |
|---|---|---|---|---|---|---|---|---|---|---|
| | | Insulating inorganic | | | Dispersant | | | | | |
| | | particles | | | | | | Solubility in | Crosslinking | |
| | | | | Content | | Structural | Content | electrolytic | agent | |
| | | | | [% by | | unit | [% by | solution when | | Structural |
| | | Material | Type | mass] | Material | included | mass] | dried | Material | unit included |
| Example | 91 | BMB-07 | Boehmite | 30 | AKM-0531 | (1), (2)or(3) | 1.5 | Good | UD-320 | (4) |
| | | | | | (60% aqueous | | | | | R2: Urethane |
| | | | | | solution) | | | | | R3, R4: Hydroxyl group |
| | 92 | BMB-07 | Boehmite | 30 | AKM-0531 | (1), (2)or(3) | 1.5 | Good | UD-320 | (4) |
| | | | | | (60% aqueous | | | | | R2: Urethane |
| | | | | | solution) | | | | | R3, R4: Hydroxyl group |
| | 93 | CT3000LSSG | α-alumina | 30 | SC-0505K | (1) | 0.9 | Good | epan740 | (4) |
| | | | | | | | | | | R2: Poloxamer |
| | | | | | | | | | | R3, R4: Hydroxyl group |
| | 94 | CT3000LSSG | α-alumina | 30 | SC-0505K | (1) | 0.9 | Good | epan740 | (4) |
| | | | | | | | | | | R2: Poloxamer |
| | | | | | | | | | | R3, R4: Hydroxyl group |
| | 95 | CT3000LSSG | α-alumina | 30 | SC-0505K | (1) | 0.9 | Good | epan740 | (4) |
| | | | | | | | | | | R2: Poloxamer |
| | | | | | | | | | | R3, R4: Hydroxyl group |
| | 96 | CT3000LSSG | α-alumina | 30 | SC-0505K | (1) | 0.9 | Good | epan740 | (4) |
| | | | | | | | | | | R2: Poloxamer |
| | | | | | | | | | | R3, R4: Hydroxyl group |
| | 97 | CT3000LSSG | α-alumina | 30 | SC-0505K | (1) | 0.9 | Good | epan740 | (4) |
| | | | | | | | | | | R2: Poloxamer |
| | | | | | | | | | | R3, R4: Hydroxyl group |
| | 98 | BMB-07 | Boehmite | 30 | SC-0505K | (1) | 0.9 | Good | epan740 | (4) |
| | | | | | | | | | | R2: Poloxamer |
| | | | | | | | | | | R3, R4: Hydroxyl group |
| | 99 | BMB-07 | Boehmite | 30 | SC-0505K | (1) | 0.9 | Good | epan740 | (4) |
| | | | | | | | | | | R2: Poloxamer |
| | | | | | | | | | | R3, R4: Hydroxyl group |
| | 100 | BMB-07 | Boehmite | 30 | SC-0505K | (1) | 0.9 | Good | epan740 | (4) |
| | | | | | | | | | | R2: Poloxamer |
| | | | | | | | | | | R3, R4: Hydroxyl group |
| | 101 | BMB-07 | Boehmite | 30 | SC-0505K | (1) | 0.9 | Good | epan740 | (4) |
| | | | | | | | | | | R2: Poloxamer |
| | | | | | | | | | | R3, R4: Hydroxyl group |
| | 102 | BMB-07 | Boehmite | 30 | SC-0505K | (1) | 0.9 | Good | epan740 | (4) |
| | | | | | | | | | | R2: Poloxamer |
| | | | | | | | | | | R3, R4: Hydroxyl group |
| | 103 | CT3000LSSG | α-alumina | 30 | SC-0708A | (1) | 0.9 | Good | epan740 | (4) |
| | | | | | | | | | | R2: Poloxamer |
| | | | | | | | | | | R3, R4: Hydroxyl group |
| | 104 | CT3000LSSG | α-alumina | 30 | SC-0708A | (1) | 0.9 | Good | epan740 | (4) |
| | | | | | | | | | | R2: Poloxamer |
| | | | | | | | | | | R3, R4: Hydroxyl group |
| | 105 | CT3000LSSG | α-alumina | 30 | SC-0708A | (1) | 0.9 | Good | epan740 | (4) |
| | | | | | | | | | | R2: Poloxamer |
| | | | | | | | | | | R3, R4: Hydroxyl group |

| | | Insulating layer-forming liquid composition | | | | | | | |
|---|---|---|---|---|---|---|---|---|---|
| | | Crosslinking | | | | | | | |
| | | agent | Binder | | | | Dispersion medium | | |
| | | Content | | | Content | Dispersibility | | Content | Total |
| | | [% by | | | [% by | in electrolytic | | [% by | [% by |
| | | mass] | Material | Type | mass] | solution | Material | mass] | mass] |
| Example | 91 | 0.3 | LBG-2200LX | PVDF-HFP | 5.6 | Good | H₂O sol. | 62.6 | 100 |
| | 92 | 0.3 | FE4300 | FEVE | 3.0 | Poor | H₂O sol. | 65.2 | 100 |
| | 93 | 0.3 | ARC | PVDF-HFP:Acrylic IPN | 3.5 | Good | EL | 65.3 | 100 |
| | | | | (PVDF:Acrylic = 7:3) | | | | | |
| | 94 | 0.3 | CRX | PVDF-HFP:Acrylic IPN | 3.5 | Good | EL | 65.3 | 100 |
| | | | | (PVDF:Acrylic = 7:3) | | | | | |
| | 95 | 0.3 | LBG-2200LX | PVDF-HFP | 5.6 | Good | EL | 63.2 | 100 |
| | 96 | 0.3 | FE4300 | FEVE | 3.0 | Poor | EL | 65.8 | 100 |
| | 97 | 0.3 | MPT-N8 | PTFE | 3.5 | Poor | EL | 65.3 | 100 |
| | 98 | 0.3 | ARC | PVDF-HFP:Acrylic IPN | 3.5 | Good | EL | 65.3 | 100 |
| | | | | (PVDF:Acrylic = 7:3) | | | | | |
| | 99 | 0.3 | CRX | PVDF-HFP:Acrylic IPN | 3.5 | Good | EL | 65.3 | 100 |
| | | | | (PVDF:Acrylic = 7:3) | | | | | |
| | 100 | 0.3 | LBG-2200LX | PVDF-HFP | 5.6 | Good | EL | 63.2 | 100 |
| | 101 | 0.3 | FE4300 | FEVE | 3.0 | Poor | EL | 65.8 | 100 |
| | 102 | 0.3 | MPT-N8 | PTFE | 3.5 | Poor | EL | 65.3 | 100 |
| | 103 | 0.3 | ARC | PVDF-HFP:Acrylic IPN | 3.5 | Good | EL | 65.3 | 100 |
| | | | | (PVDF:Acrylic = 7:3) | | | | | |
| | 104 | 0.3 | CRX | PVDF-HFP:Acrylic IPN | 3.5 | Good | EL | 65.3 | 100 |
| | | | | (PVDF:Acrylic = 7:3) | | | | | |
| | 105 | 0.3 | LBG-2200LX | PVDF-HFP | 5.6 | Good | EL | 63.2 | 100 |

TABLE 8

| | | Insulating layer-forming liquid composition | | | | | | | | |
|---|---|---|---|---|---|---|---|---|---|---|
| | | Insulating inorganic | | | Dispersant | | | | | |
| | | particles | | | | | | Solubility in | Crosslinking | |
| | | | | Content | | Structural | Content | electrolytic | agent | |
| | | | | [% by | | unit | [% by | solution when | | Structural |
| | | Material | Type | mass] | Material | included | mass] | dried | Material | unit included |
| Example | 106 | CT3000LSSG | α-alumina | 30 | SC-0708A | (1) | 0.9 | Good | epan740 | (4) |
| | | | | | | | | | | R2: Poloxamer |
| | | | | | | | | | | R3, R4: Hydroxyl group |
| | 107 | CT3000LSSG | α-alumina | 30 | SC-0708A | (1) | 0.9 | Good | epan740 | (4) |
| | | | | | | | | | | R2: Poloxamer |
| | | | | | | | | | | R3, R4: Hydroxyl group |
| | 108 | BMB-07 | Boehmite | 30 | SC-0708A | (1) | 0.9 | Good | epan740 | (4) |
| | | | | | | | | | | R2: Poloxamer |
| | | | | | | | | | | R3, R4: Hydroxyl group |
| | 109 | BMB-07 | Boehmite | 30 | SC-0708A | (1) | 0.9 | Good | epan740 | (4) |
| | | | | | | | | | | R2: Poloxamer |
| | | | | | | | | | | R3, R4: Hydroxyl group |
| | 110 | BMB-07 | Boehmite | 30 | SC-0708A | (1) | 0.9 | Good | epan740 | (4) |
| | | | | | | | | | | R2: Poloxamer |
| | | | | | | | | | | R3, R4: Hydroxyl group |
| | 111 | BMB-07 | Boehmite | 30 | SC-0708A | (1) | 0.9 | Good | epan740 | (4) |
| | | | | | | | | | | R2: Poloxamer |
| | | | | | | | | | | R3, R4: Hydroxyl group |
| | 112 | BMB-07 | Boehmite | 30 | SC-0708A | (1) | 0.9 | Good | epan740 | (4) |
| | | | | | | | | | | R2: Poloxamer |
| | | | | | | | | | | R3, R4: Hydroxyl group |
| | 113 | CT3000LSSG | α-alumina | 30 | AKM-0531 | (1) | 0.9 | Good | epan740 | (4) |
| | | | | | | | | | | R2: Poloxamer |
| | | | | | | | | | | R3, R4: Hydroxyl group |
| | 114 | CT3000LSSG | α-alumina | 30 | AKM-0531 | (1) | 0.9 | Good | epan740 | (4) |
| | | | | | | | | | | R2: Poloxamer |
| | | | | | | | | | | R3, R4: Hydroxyl group |
| | 115 | CT3000LSSG | α-alumina | 30 | AKM-0531 | (1) | 0.9 | Good | epan740 | (4) |
| | | | | | | | | | | R2: Poloxamer |
| | | | | | | | | | | R3, R4: Hydroxyl group |
| | 116 | CT3000LSSG | α-alumina | 30 | AKM-0531 | (1) | 0.9 | Good | epan740 | (4) |
| | | | | | | | | | | R2: Poloxamer |
| | | | | | | | | | | R3, R4: Hydroxyl group |
| | 117 | CT3000LSSG | α-alumina | 30 | AKM-0531 | (1) | 0.9 | Good | epan740 | (4) |
| | | | | | | | | | | R2: Poloxamer |
| | | | | | | | | | | R3, R4: Hydroxyl group |
| | 118 | BMB-07 | Boehmite | 30 | AKM-0531 | (1) | 0.9 | Good | epan740 | (4) |
| | | | | | | | | | | R2: Poloxamer |
| | | | | | | | | | | R3, R4: Hydroxyl group |
| | 119 | BMB-07 | Boehmite | 30 | AKM-0531 | (1) | 0.9 | Good | epan740 | (4) |
| | | | | | | | | | | R2: Poloxamer |
| | | | | | | | | | | R3, R4: Hydroxyl group |
| | 120 | BMB-07 | Boehmite | 30 | AKM-0531 | (1) | 0.9 | Good | epan740 | (4) |
| | | | | | | | | | | R2: Poloxamer |
| | | | | | | | | | | R3, R4: Hydroxyl group |

| | | Insulating layer-forming liquid composition | | | | | | | |
|---|---|---|---|---|---|---|---|---|---|
| | | Crosslinking | | | | | | | |
| | | agent | Binder | | | | Dispersion medium | | |
| | | Content | | | Content | Dispersibility | | Content | Total |
| | | [% by | | | [% by | in electrolytic | | [% by | [% by |
| | | mass] | Material | Type | mass] | solution | Material | mass] | mass] |
| Example | 106 | 0.3 | FE4300 | FEVE | 3.0 | Poor | EL | 65.8 | 100 |
| | 107 | 0.3 | MPT-N8 | PTFE | 3.5 | Poor | EL | 65.3 | 100 |
| | 108 | 0.3 | ARC | PVDF-HFP:Acrylic IPN | 3.5 | Good | EL | 65.3 | 100 |
| | | | | (PVDF:Acrylic = 7:3) | | | | | |
| | 109 | 0.3 | CRX | PVDF-HFP:Acrylic IPN | 3.5 | Good | EL | 65.3 | 100 |
| | | | | (PVDF:Acrylic = 7:3) | | | | | |
| | 110 | 0.3 | LBG-2200LX | PVDF-HFP | 5.6 | Good | EL | 63.2 | 100 |
| | 111 | 0.3 | FE4300 | FEVE | 3.0 | Poor | EL | 65.8 | 100 |
| | 112 | 0.3 | MPT-N8 | PTFE | 3.5 | Poor | EL | 65.3 | 100 |
| | 113 | 0.3 | ARC | PVDF-HFP:Acrylic IPN | 3.5 | Good | EL | 65.3 | 100 |
| | | | | (PVDF:Acrylic = 7:3) | | | | | |
| | 114 | 0.3 | CRX | PVDF-HFP:Acrylic IPN | 3.5 | Good | EL | 65.3 | 100 |
| | | | | (PVDF:Acrylic = 7:3) | | | | | |
| | 115 | 0.3 | LBG-2200LX | PVDF-HFP | 5.6 | Good | EL | 63.2 | 100 |
| | 116 | 0.3 | FE4300 | FEVE | 3.0 | Poor | EL | 65.8 | 100 |
| | 117 | 0.3 | MPT-N8 | PTFE | 3.5 | Poor | EL | 65.3 | 100 |
| | 118 | 0.3 | ARC | PVDF-HFP:Acrylic IPN | 3.5 | Good | EL | 65.3 | 100 |
| | | | | (PVDF:Acrylic = 7:3) | | | | | |
| | 119 | 0.3 | CRX | PVDF-HFP:Acrylic IPN | 3.5 | Good | EL | 65.3 | 100 |
| | | | | (PVDF:Acrylic = 7:3) | | | | | |
| | 120 | 0.3 | LBG-2200LX | PVDF-HFP | 5.6 | Good | EL | 63.2 | 100 |

TABLE 9

| | | Insulating layer-forming liquid composition | | | | | | | | |
|---|---|---|---|---|---|---|---|---|---|---|
| | | Insulating inorganic | | | Dispersant | | | | | |
| | | particles | | | | | | Solubility in | Crosslinking | |
| | | | | Content | | Structural | Content | electrolytic | agent | |
| | | | | [% by | | unit | [% by | solution when | | Structural |
| | | Material | Type | mass] | Material | included | mass] | dried | Material | unit included |
| Example | 121 | BMB-07 | Boehmite | 30 | AKM-0531 | (1) | 0.9 | Good | epan740 | (4) |
| | | | | | | | | | | R2: Poloxamer |
| | | | | | | | | | | R3, R4: Hydroxyl group |
| | 122 | BMB-07 | Boehmite | 30 | AKM-0531 | (1) | 0.9 | Good | epan740 | (4) |
| | | | | | | | | | | R2: Poloxamer |
| | | | | | | | | | | R3, R4: Hydroxyl group |
| | 123 | CT3000LSSG | α-alumina | 30 | HKM-50A | (2)or(3) | 1.8 | Good | epan740 | (4) |
| | | | | | | | | | | R2: Poloxamer |
| | | | | | | | | | | R3, R4: Hydroxyl group |
| | 124 | CT3000LSSG | α-alumina | 30 | HKM-50A | (2)or(3) | 1.8 | Good | epan740 | (4) |
| | | | | | | | | | | R2: Poloxamer |
| | | | | | | | | | | R3, R4: Hydroxyl group |
| | 125 | CT3000LSSG | α- alumina | 30 | HKM-50A | (2)or(3) | 1.8 | Good | epan740 | (4) |
| | | | | | | | | | | R2: Poloxamer |
| | | | | | | | | | | R3, R4: Hydroxyl group |
| | 126 | CT3000LSSG | α-alumina | 30 | HKM-50A | (2)or(3) | 1.8 | Good | epan740 | (4) |
| | | | | | | | | | | R2: Poloxamer |
| | | | | | | | | | | R3, R4: Hydroxyl group |
| | 127 | BMB-07 | Boehmite | 30 | HKM-50A | (2)or(3) | 1.8 | Good | epan740 | (4) |
| | | | | | | | | | | R2: Poloxamer |
| | | | | | | | | | | R3, R4: Hydroxyl group |
| | 128 | BMB-07 | Boehmite | 30 | HKM-50A | (2)or(3) | 1.8 | Good | epan740 | (4) |
| | | | | | | | | | | R2: Poloxamer |
| | | | | | | | | | | R3, R4: Hydroxyl group |
| | 129 | BMB-07 | Boehmite | 30 | HKM-50A | (2)or(3) | 1.8 | Good | epan740 | 4) |
| | | | | | | | | | | R2: Poloxamer |
| | | | | | | | | | | R3, R4: Hydroxyl group |
| | 130 | BMB-07 | Boehmite | 30 | HKM-50A | (2)or(3) | 1.8 | Good | epan740 | (4) |
| | | | | | | | | | | R2: Poloxamer |
| | | | | | | | | | | R3, R4: Hydroxyl group |
| | 131 | CT3000LSSG | α-alumina | 30 | AKM-0531 | (1), | 1.5 | Good | epan740 | (4) |
| | | | | | (60% aqueous | (2)or(3) | | | | R2: Poloxamer |
| | | | | | solution) | | | | | R3, R4: Hydroxyl group |
| | 132 | CT3000LSSG | α-alumina | 30 | AKM-0531 | (1), | 1.5 | Good | epan740 | (4) |
| | | | | | (60% aqueous | (2)or(3) | | | | R2: Poloxamer |
| | | | | | solution) | | | | | R3, R4: Hydroxyl group |
| | 133 | CT3000LSSG | α-alumina | 30 | AKM-0531 | (1), | 1.5 | Good | epan740 | (4) |
| | | | | | (60% aqueous | (2)or(3) | | | | R2: Poloxamer |
| | | | | | solution) | | | | | R3, R4: Hydroxyl group |
| | 134 | CT3000LSSG | α-alumina | 30 | AKM-0531 | (1), | 1.5 | Good | epan740 | (4) |
| | | | | | (60% aqueous | (2)or(3) | | | | R2: Poloxamer |
| | | | | | solution) | | | | | R3, R4: Hydroxyl group |
| | 135 | BMB-07 | Boehmite | 30 | AKM-0531 | (1), | 1.5 | Good | epan740 | (4) |
| | | | | | (60% aqueous | (2)or(3) | | | | R2: Poloxamer |
| | | | | | solution) | | | | | R3, R4: Hydroxyl group |

| | | Insulating layer-forming liquid composition | | | | | | | |
|---|---|---|---|---|---|---|---|---|---|
| | | Crosslinking | | | | | | | |
| | | agent | Binder | | | | Dispersion medium | | |
| | | Content | | | Content | Dispersibility | | Content | Total |
| | | [% by | | | [% by | in electrolytic | | [% by | [% by |
| | | mass] | Material | Type | mass] | solution | Material | mass] | mass] |
| Example | 121 | 0.3 | FE4300 | FEVE | 3.0 | Poor | EL | 65.8 | 100 |
| | 122 | 0.3 | MPT-N8 | PTFE | 3.5 | Poor | EL | 65.3 | 100 |
| | 123 | 0.3 | ARC | PVDF-HFP:Acrylic IPN | 3.5 | Good | H₂O sol. | 64.4 | 100 |
| | | | | (PVDF:Acrylic = 7:3) | | | | | |
| | 124 | 0.3 | CRX | PVDF-HFP:Acrylic IPN | 3.5 | Good | H₂O sol. | 64.4 | 100 |
| | | | | (PVDF:Acrylic = 7:3) | | | | | |
| | 125 | 0.3 | LBG-2200LX | PVDF-HFP | 5.6 | Good | H₂O sol. | 62.4 | 100 |
| | 126 | 0.3 | FE4300 | FEVE | 3.0 | Poor | H₂O sol. | 64.9 | 100 |
| | 127 | 0.3 | ARC | PVDF-HFP:Acrylic IPN | 3.5 | Good | H₂O sol. | 64.4 | 100 |
| | | | | (PVDF:Acrylic = 7:3) | | | | | |
| | 128 | 0.3 | CRX | PVDF-HFP:Acrylic IPN | 3.5 | Good | H₂O sol. | 64.4 | 100 |
| | | | | (PVDF:Acrylic = 73) | | | | | |
| | 129 | 0.3 | LBG-2200LX | PVDF-HFP | 5.6 | Good | H₂O sol. | 62.4 | 100 |
| | 130 | 0.3 | FE4300 | FEVE | 3.0 | Poor | H₂O sol. | 64.9 | 100 |
| | 131 | 0.3 | ARC | PVDF-HFP:Acrylic IPN | 3.5 | Good | H₂O sol. | 64.7 | 100 |
| | | | | (PVDF:Acrylic = 7:3) | | | | | |
| | 132 | 0.3 | CRX | PVDF-HFP:Acrylic IPN | 3.5 | Good | H₂O sol. | 64.7 | 100 |
| | | | | (PVDF:Acrylic = 7:3) | | | | | |
| | 133 | 0.3 | LBG-2200LX | PVDF-HFP | 5.6 | Good | H₂O sol. | 62.6 | 100 |
| | 134 | 0.3 | FE4300 | FEVE | 3.0 | Poor | H₂O sol. | 65.2 | 100 |
| | 135 | 0.3 | ARC | PVDF-HPP:Acrylic IPN | 3.5 | Good | H₂O sol. | 64.7 | 100 |
| | | | | (PVDF:Acrylic = 7:3) | | | | | |

TABLE 10

| | | Insulating layer-forming liquid composition | | | | | | | | |
|---|---|---|---|---|---|---|---|---|---|---|
| | | Insulating inorganic | | | Dispersant | | | | | |
| | | particles | | | | | | Solubility in | Crosslinking | |
| | | | | Content | | Structural | Content | electrolytic | agent | |
| | | | | [% by | | unit | [% by | solution when | | Structural |
| | | Material | Type | mass] | Material | included | mass] | dried | Material | unit included |
| Example | 136 | BMB-07 | Boehmite | 30 | AKM-0531 | (1), | 1.5 | Good | epan740 | (4) |
| | | | | | (60% | 2)or(3) | | | | R2: Poloxamer |
| | | | | | aqueous | | | | | R3, R4: Hydroxyl group |
| | | | | | solution) | | | | | |
| | 137 | BMB-07 | Boehmite | 30 | AKM-0531 | (1), | 1.5 | Good | epan740 | (4) |
| | | | | | (60% | (2)or(3) | | | | R2: Poloxamer |
| | | | | | aqueous | | | | | R3, R4: Hydroxyl group |
| | | | | | solution) | | | | | |
| | 138 | BMB-07 | Boehmite | 30 | AKM-0531 | (1), | 1.5 | Good | epan740 | (4) |
| | | | | | (60% | (2)or(3) | | | | R2: Poloxamer |
| | | | | | aqueous | | | | | R3, R4: Hydroxyl group |
| | | | | | solution) | | | | | |
| | 139 | CT3000LSSG | α-alumina | 30 | SC-0505K | (1) | 0.9 | Good | K-FLEX | (4) |
| | | | | | | | | | 148 | R2: Polyester |
| | | | | | | | | | | R3, R4: Hydroxyl group |
| | 140 | CT3000LSSG | α-alumina | 30 | SC-0505K | (1) | 0.9 | Good | K-FLEX | (4) |
| | | | | | | | | | 148 | R2: Polyester |
| | | | | | | | | | | R3, R4: Hydroxyl group |
| | 141 | CT3000LSSG | α-alumina | 30 | SC-0505K | (1) | 0.9 | Good | K-FLEX | (4) |
| | | | | | | | | | 148 | R2: Polyester |
| | | | | | | | | | | R3, R4: Hydroxyl group |
| | 142 | CT3000LSSG | α-alumina | 30 | SC-0505K | (1) | 0.9 | Good | K-FLEX | (4) |
| | | | | | | | | | 148 | R2: Polyester |
| | | | | | | | | | | R3, R4: Hydroxyl group |
| | 143 | CT3000LSSG | α-alumina | 30 | SC-0505K | (1) | 0.9 | Good | K-FLEX | (4) |
| | | | | | | | | | 148 | R2: Polyester |
| | | | | | | | | | | R3, R4: Hydroxyl group |
| | 144 | BMB-07 | Boehmite | 30 | SC-0505K | (1) | 0.9 | Good | K-FLEX | (4) |
| | | | | | | | | | 148 | R2: Polyester |
| | | | | | | | | | | R3, R4: Hydroxyl group |
| | 145 | BMB-07 | Boehmite | 30 | SC-0505K | (1) | 0.9 | Good | K-FLEX | (4) |
| | | | | | | | | | 148 | R2: Polyester |
| | | | | | | | | | | R3, R4: Hydroxyl group |
| | 146 | BMB-07 | Boehmite | 30 | SC-0505K | (1) | 0.9 | Good | K-FLEX | (4) |
| | | | | | | | | | 148 | R2: Polyester |
| | | | | | | | | | | R3, R4: Hydroxyl group |
| | 147 | BMB-07 | Boehmite | 30 | SC-0505K | (1) | 0.9 | Good | K-FLEX | (4) |
| | | | | | | | | | 148 | R2: Polyester |
| | | | | | | | | | | R3, R4: Hydroxyl group |
| | 148 | BMB-07 | Boehmite | 30 | SC-0505K | (1) | 0.9 | Good | K-FLEX | (4) |
| | | | | | | | | | 148 | R2: Polyester |
| | | | | | | | | | | R3, R4: Hydroxyl group |
| | 149 | CT3000LSSG | α-alumina | 30 | SC-0708A | (1) | 0.9 | Good | K-FLEX | (4) |
| | | | | | | | | | 148 | R2: Polyester |
| | | | | | | | | | | R3, R4: Hydroxyl group |
| | 150 | CT3000LSSG | α-alumina | 30 | SC-0708A | (1) | 0.9 | Good | K-FLEX | (4) |
| | | | | | | | | | 148 | R2: Polyester |
| | | | | | | | | | | R3, R4: Hydroxyl group |

| | | Insulating layer-forming liquid composition | | | | | | | |
|---|---|---|---|---|---|---|---|---|---|
| | | Crosslinking | | | | | | | |
| | | agent | Binder | | | | Dispersion medium | | |
| | | Content | | | Content | Dispersibility | | Content | Total |
| | | [% by | | | [% by | in electrolytic | | [% by | [% by |
| | | mass] | Material | Type | mass] | solution | Material | mass] | mass] |
| Example | 136 | 0.3 | CRX | PVDF-HFP:Acrylic IPN | 3.5 | Good | H₂O sol. | 64.7 | 100 |
| | | | | (PVDF:Acrylic = 7:3) | | | | | |
| | 137 | 0.3 | LBG-2200LX | PVDF-HFP | 5.6 | Good | H₂O sol. | 62.6 | 100 |
| | 138 | 0.3 | FE4300 | FEVE | 3.0 | Poor | H₂O sol. | 65.2 | 100 |
| | 139 | 0.3 | ARC | PVDF-HFP:Acrylic IPN | 3.5 | Good | EL | 65.3 | 100 |
| | | | | (PVDF:Acrylic = 7:3) | | | | | |
| | 140 | 0.3 | CRX | PVDF-HFP:Acrylic IPN | 3.5 | Good | EL | 65.3 | 100 |
| | | | | (PVDF:Acrylic = 7:3) | | | | | |
| | 141 | 0.3 | LBG-2200LX | PVDF-HFP | 5.6 | Good | EL | 63.2 | 100 |
| | 142 | 0.3 | FE4300 | FEVE | 3.0 | Poor | EL | 65.8 | 100 |
| | 143 | 0.3 | MPT-N8 | PTFE | 3.5 | Poor | EL | 65.3 | 100 |
| | 144 | 0.3 | ARC | PVDF-HFP:Acrylic IPN | 3.5 | Good | EL | 65.3 | 100 |
| | | | | (PVDF:Acrylic = 7:3) | | | | | |
| | 145 | 0.3 | CRX | PVDF-HFP:Acrylic IPN | 3.5 | Good | EL | 65.3 | 100 |
| | | | | (PVDF:Acrylic = 7:3) | | | | | |
| | 146 | 0.3 | LBG-2200LX | PVDF-HFP | 5.6 | Good | EL | 63.2 | 100 |
| | 147 | 0.3 | FE4300 | FEVE | 3.0 | Poor | EL | 65.8 | 100 |
| | 148 | 0.3 | MPT-N8 | PTFE | 3.5 | Poor | EL | 65.3 | 100 |
| | 149 | 0.3 | ARC | PVDF-HFP:Acrylic IPN | 3.5 | Good | EL | 65.3 | 100 |
| | | | | (PVDF:Acrylic = 7:3) | | | | | |
| | 150 | 0.3 | CRX | PVDF-HFP:Acrylic IPN | 3.5 | Good | EL | 65.3 | 100 |
| | | | | (PVDF:Acrylic = 7:3) | | | | | |

TABLE 11

| | | Insulating layer-forming liquid composition | | | | | | | | |
|---|---|---|---|---|---|---|---|---|---|---|
| | | Insulating inorganic | | | Dispersant | | | | | |
| | | particles | | | | | | Solubility in | Crosslinking | |
| | | | | Content | | Structural | Content | electrolytic | agent | |
| | | | | [% by | | unit | [% by | solution when | | Structural |
| | | Material | Type | mass] | Material | included | mass] | dried | Material | unit included |
| Example | 151 | CT3000LSSG | α-alumina | 30 | SC-0708A | (1) | 0.9 | Good | K-FLEX 148 | (4) |
| | | | | | | | | | | R2: Polyester |
| | | | | | | | | | | R3, R4: Hydroxyl group |
| | 152 | CT3000LSSG | α-alumina | 30 | SC-0708A | (1) | 0.9 | Good | K-FLEX 148 | (4) |
| | | | | | | | | | | R2: Polyester |
| | | | | | | | | | | R3, R4: Hydroxyl group |
| | 153 | CT3000LSSG | α-alumina | 30 | SC-0708A | (1) | 0.9 | Good | K-FLEX 148 | (4) |
| | | | | | | | | | | R2: Polyester |
| | | | | | | | | | | R3, R4: Hydroxyl group |
| | 154 | BMB-07 | Boehmite | 30 | SC-0708A | (1) | 0.9 | Good | K-FLEX 148 | (4) |
| | | | | | | | | | | R2: Polyester |
| | | | | | | | | | | R3, R4: Hydroxyl group |
| | 155 | BMB-07 | Boehmite | 30 | SC-0708A | (1) | 0.9 | Good | K-FLEX 148 | (4) |
| | | | | | | | | | | R2: Polyester |
| | | | | | | | | | | R3, R4: Hydroxyl group |
| | 156 | BMB-07 | Boehmite | 30 | SC-0708A | (1) | 0.9 | Good | K-FLEX 148 | (4) |
| | | | | | | | | | | R2: Polyester |
| | | | | | | | | | | R3, R4: Hydroxyl group |
| | 157 | BMB-07 | Boehmite | 30 | SC-0708A | (1) | 0.9 | Good | K-FLEX 148 | (4) |
| | | | | | | | | | | R2: Polyester |
| | | | | | | | | | | R3, R4: Hydroxyl group |
| | 158 | BMB-07 | Boehmite | 30 | SC-0708A | (1) | 0.9 | Good | K-FLEX 148 | (4) |
| | | | | | | | | | | R2: Polyester |
| | | | | | | | | | | R3, R4: Hydroxyl group |
| | 159 | CT3000LSSG | α-alumina | 30 | AKM-0531 | (1) | 0.9 | Good | K-FLEX 148 | (4) |
| | | | | | | | | | | R2: Polyester |
| | | | | | | | | | | R3, R4: Hydroxyl group |
| | 160 | CT3000LSSG | α-alumina | 30 | AKM-0531 | (1) | 0.9 | Good | K-FLEX 148 | (4) |
| | | | | | | | | | | R2: Polyester |
| | | | | | | | | | | R3, R4: Hydroxyl group |
| | 161 | CT3000LSSG | α-alumina | 30 | AKM-0531 | (1) | 0.9 | Good | K-FLEX 148 | (4) |
| | | | | | | | | | | R2: Polyester |
| | | | | | | | | | | R3, R4: Hydroxyl group |
| | 162 | CT3000LSSG | α-alumina | 30 | AKM-0531 | (1) | 0.9 | Good | K-FLEX 148 | (4) |
| | | | | | | | | | | R2: Polyester |
| | | | | | | | | | | R3, R4: Hydroxyl group |
| | 163 | CT3000LSSG | α-alumina | 30 | AKM-0531 | (1) | 0.9 | Good | K-FLEX 148 | (4) |
| | | | | | | | | | | R2: Polyester |
| | | | | | | | | | | R3, R4: Hydroxyl group |
| | 164 | BMB-07 | Boehmite | 30 | AKM-0531 | (1) | 0.9 | Good | K-FLEX 148 | (4) |
| | | | | | | | | | | R2: Polyester |
| | | | | | | | | | | R3, R4: Hydroxyl group |
| | 165 | BMB-07 | Boehmite | 30 | AKM-0531 | (1) | 0.9 | Good | K-FLEX 148 | (4) |
| | | | | | | | | | | R2: Polyester |
| | | | | | | | | | | R3, R4: Hydroxyl group |

| | | Insulating layer-forming liquid composition | | | | | | | |
|---|---|---|---|---|---|---|---|---|---|
| | | Crosslinking | | | | | | | |
| | | agent | Binder | | | | Dispersion medium | | |
| | | Content | | | Content | Dispersibility | | Content | Total |
| | | [% by | | | [% by | in electrolytic | | [% by | [% by |
| | | mass] | Material | Type | mass] | solution | Material | mass] | mass] |
| Example | 151 | 0.3 | LBG-2200LX | PVDF-HFP | 5.6 | Good | EL | 63.2 | 100 |
| | 152 | 0.3 | FE4300 | FEVE | 3.0 | Poor | EL | 65.8 | 100 |
| | 153 | 0.3 | MPT-N8 | PTFE | 3.5 | Poor | EL | 65.3 | 100 |
| | 154 | 0.3 | ARC | PVDF-HFP:Acrylic IPN | 3.5 | Good | EL | 65.3 | 100 |
| | | | | (PVDF:Acrylic = 7:3) | | | | | |
| | 155 | 0.3 | CRX | PVDF-HFP:Acrylic IPN | 3.5 | Good | EL | 65.3 | 100 |
| | | | | (PVDF:Acrylic = 7:3) | | | | | |
| | 156 | 0.3 | LBG-2200LX | PVDF-HFP | 5.6 | Good | EL | 63.2 | 100 |
| | 157 | 0.3 | FE4300 | FEVE | 3.0 | Poor | EL | 65.8 | 100 |
| | 158 | 0.3 | MPT-N8 | PTFE | 3.5 | Poor | EL | 65.3 | 100 |
| | 159 | 0.3 | ARC | PVDF-HFP:Acrylic IPN | 3.5 | Good | EL | 65.3 | 100 |
| | | | | (PVDF:Acrylic = 7:3) | | | | | |
| | 160 | 0.3 | CRX | PVDF-HFP:Acrylic IPN | 3.5 | Good | EL | 65.3 | 100 |
| | | | | (PVDF:Acrylic = 7:3) | | | | | |
| | 161 | 0.3 | LBG-2200LX | PVDF-HFP | 5.6 | Good | EL | 63.2 | 100 |
| | 162 | 0.3 | FE4300 | FEVE | 3.0 | Poor | EL | 65.8 | 100 |
| | 163 | 0.3 | MPT-N8 | PTFE | 3.5 | Poor | EL | 65.3 | 100 |
| | 164 | 0.3 | ARC | PVDF-HFP:Acrylic IPN | 3.5 | Good | EL | 65.3 | 100 |
| | | | | (PVDF:Acrylic = 7:3) | | | | | |
| | 165 | 0.3 | CRX | PVDF-HFP:Acrylic IPN | 3.5 | Good | EL | 65.3 | 100 |
| | | | | (PVDF:Acrylic = 7:3) | | | | | |

TABLE 12

| | | Insulating layer-forming liquid composition | | | | | | | | |
|---|---|---|---|---|---|---|---|---|---|---|
| | | Insulating inorganic | | | Dispersant | | | | | |
| | | particles | | | | | | Solubility in | Crosslinking | |
| | | | | Content | | Structural | Content | electrolytic | agent | |
| | | | | [% by | | unit | [% by | solution when | | Structural |
| | | Material | Type | mass] | Material | included | mass] | dried | Material | unit included |
| Example | 166 | BMB-07 | Boehmite | 30 | AKM-0531 | (1) | 0.9 | Good | K-FLEX 148 | (4) |
| | | | | | | | | | | R2: Polyester |
| | | | | | | | | | | R3, R4: Hydroxyl group |
| | 167 | BMB-07 | Boehmite | 30 | AKM-0531 | (1) | 0.9 | Good | K-FLEX 148 | (4) |
| | | | | | | | | | | R2: Polyester |
| | | | | | | | | | | R3, R4: Hydroxyl group |
| | 168 | BMB-07 | Boehmite | 30 | AKM-0531 | (1) | 0.9 | Good | K-FLEX 148 | (4) |
| | | | | | | | | | | R2: Polyester |
| | | | | | | | | | | R3, R4: Hydroxyl group |
| | 169 | CT3000LSSG | α-alumina | 30 | SC-0505K | (1) | 0.9 | Good | ED-2003 | (4) |
| | | | | | | | | | | R2: Polyethylene oxide |
| | | | | | | | | | | R3, R4: Amino group |
| | 170 | CT3000LSSG | α-alumina | 30 | SC-0505K | (1) | 0.9 | Good | ED-2003 | (4) |
| | | | | | | | | | | R2: Polyethylene oxide |
| | | | | | | | | | | R3, R4: Amino group |
| | 171 | CT3000LSSG | α-alumina | 30 | SC-0505K | (1) | 0.9 | Good | ED-2003 | (4) |
| | | | | | | | | | | R2: Polyethylene oxide |
| | | | | | | | | | | R3, R4: Amino group |
| | 172 | CT3000LSSG | α-alumina | 30 | SC-0505K | (1) | 0.9 | Good | ED-2003 | (4) |
| | | | | | | | | | | R2: Polyethylene oxide |
| | | | | | | | | | | R3, R4: Amino group |
| | 173 | CT3000LSSG | α-alumina | 30 | SC-0505K | (1) | 0.9 | Good | ED-2003 | (4) |
| | | | | | | | | | | R2: Polyethylene oxide |
| | | | | | | | | | | R3, R4: Amino group |
| | 174 | BMB-07 | Boehmite | 30 | SC-0505K | (1) | 0.9 | Good | ED-2003 | (4) |
| | | | | | | | | | | R2: Polyethylene oxide |
| | | | | | | | | | | R3, R4: Amino group |
| | 175 | BMB-07 | Boehmite | 30 | SC-0505K | (1) | 0.9 | Good | ED-2003 | (4) |
| | | | | | | | | | | R2: Polyethylene oxide |
| | | | | | | | | | | R3, R4: Amino group |
| | 176 | BMB-07 | Boehmite | 30 | SC-0505K | (1) | 0.9 | Good | ED-2003 | (4) |
| | | | | | | | | | | R2: Polyethylene oxide |
| | | | | | | | | | | R3, R4: Amino group |
| | 177 | BMB-07 | Boehmite | 30 | SC-0505K | (1) | 0.9 | Good | ED-2003 | (4) |
| | | | | | | | | | | R2: Polyethylene oxide |
| | | | | | | | | | | R3, R4: Amino group |
| | 178 | BMB-07 | Boehmite | 30 | SC-0505K | (1) | 0.9 | Good | ED-2003 | (4) |
| | | | | | | | | | | R2: Polyethylene oxide |
| | | | | | | | | | | R3, R4: Amino group |
| | 179 | CT3000LSSG | α-alumina | 30 | SC-0708A | (1) | 0.9 | Good | ED-2003 | (4) |
| | | | | | | | | | | R2: Polyethylene oxide |
| | | | | | | | | | | R3, R4: Amino group |
| | 180 | CT3000LSSG | α-alumina | 30 | SC-0708A | (1) | 0.9 | Good | ED-2003 | (4) |
| | | | | | | | | | | R2: Polyethylene oxide |
| | | | | | | | | | | R3, R4: Amino group |

| | | Insulating layer-forming liquid composition | | | | | | | |
|---|---|---|---|---|---|---|---|---|---|
| | | Crosslinking | | | | | | | |
| | | agent | Binder | | | | Dispersion medium | | |
| | | Content | | | Content | Dispersibility | | Content | Total |
| | | [% by | | | [% by | in electrolytic | | [% by | [% by |
| | | mass] | Material | Type | mass] | solution | Material | mass] | mass] |
| Example | 166 | 0.3 | LBG-2200LX | PVDF-HFP | 5.6 | Good | EL | 63.2 | 100 |
| | 167 | 0.3 | FE4300 | FEVE | 3.0 | Poor | EL | 65.8 | 100 |
| | 168 | 0.3 | MPT-N8 | PTFE | 3.5 | Poor | EL | 65.3 | 100 |
| | 169 | 0.3 | ARC | PVDF-HFP:Acrylic IPN | 3.5 | Good | EL | 65.3 | 100 |
| | | | | (PVDF:Acrylic = 7:3) | | | | | |
| | 170 | 0.3 | CRX | PVDF-HFP:Acrylic IPN | 3.5 | Good | EL | 65.3 | 100 |
| | | | | (PVDF:Acrylic = 7:3) | | | | | |
| | 171 | 0.3 | LBG-2200LX | PVDF-HFP | 5.6 | Good | EL | 63.2 | 100 |
| | 172 | 0.3 | FE4300 | FEVE | 3.0 | Poor | EL | 65.8 | 100 |
| | 173 | 0.3 | MPT-N8 | PTFE | 3.5 | Poor | EL | 65.3 | 100 |
| | 174 | 0.3 | ARC | PVDF-HFP:Acrylic IPN | 3.5 | Good | EL | 65.3 | 100 |
| | | | | (PVDF:Acrylic = 7:3) | | | | | |
| | 175 | 0.3 | CRX | PVDF-HFP:Acrylic IPN | 3.5 | Good | EL | 65.3 | 100 |
| | | | | (PVDF:Acrylic = 7:3) | | | | | |
| | 176 | 0.3 | LBG-2200LX | PVDF-HFP | 5.6 | Good | EL | 63.2 | 100 |
| | 177 | 0.3 | FE4300 | FEVE | 3.0 | Poor | EL | 65.8 | 100 |
| | 178 | 0.3 | MPT-N8 | PTFE | 3.5 | Poor | EL | 65.3 | 100 |
| | 179 | 0.3 | ARC | PVDF-HFP:Acrylic IPN | 3.5 | Good | EL | 65.3 | 100 |
| | | | | (PVDF:Acrylic = 7:3) | | | | | |
| | 180 | 0.3 | CRX | PVDF-HFP:Acrylic IPN | 3.5 | Good | EL | 65.3 | 100 |
| | | | | (PVDF:Acrylic = 7:3) | | | | | |

TABLE 13

| | | Insulating layer-forming liquid composition | | | | | | | | |
|---|---|---|---|---|---|---|---|---|---|---|
| | | Insulating inorganic | | | Dispersant | | | | | |
| | | particles | | | | | | Solubility in | Crosslinking | |
| | | | | Content | | Structural | Content | electrolytic | agent | |
| | | | | [% by | | unit | [% by | solution when | | Structural |
| | | Material | Type | mass] | Material | included | mass] | dried | Material | unit included |
| Example | 181 | CT3000LSSG | α-alumina | 30 | SC-0708A | (1) | 0.9 | Good | ED-2003 | (4) |
| | | | | | | | | | | R2: Polyethylene oxide |
| | | | | | | | | | | R3, R4: Amino group |
| | 182 | CT3000LSSG | α-alumina | 30 | SC-0708A | (1) | 0.9 | Good | ED-2003 | (4) |
| | | | | | | | | | | R2: Polyethylene oxide |
| | | | | | | | | | | R3, R4: Amino group |
| | 183 | CT3000LSSG | α-alumina | 30 | SC-0708A | (1) | 0.9 | Good | ED-2003 | (4) |
| | | | | | | | | | | R2: Polyethylene oxide |
| | | | | | | | | | | R3, R4: Amino group |
| | 184 | BMB-07 | Boehmite | 30 | SC-0708A | (1) | 0.9 | Good | ED-2003 | (4) |
| | | | | | | | | | | R2: Polyethylene oxide |
| | | | | | | | | | | R3, R4: Amino group |
| | 185 | BMB-07 | Boehmite | 30 | SC-0708A | (1) | 0.9 | Good | ED-2003 | (4) |
| | | | | | | | | | | R2: Polyethylene oxide |
| | | | | | | | | | | R3, R4: Amino group |
| | 186 | BMB-07 | Boehmite | 30 | SC-0708A | (1) | 0.9 | Good | ED-2003 | (4) |
| | | | | | | | | | | R2: Polyethylene oxide |
| | | | | | | | | | | R3, R4: Amino group |
| | 187 | BMB-07 | Boehmite | 30 | SC-0708A | (1) | 0.9 | Good | ED-2003 | (4) |
| | | | | | | | | | | R2: Polyethylene oxide |
| | | | | | | | | | | R3, R4: Amino group |
| | 188 | BMB-07 | Boehmite | 30 | SC-0708A | (1) | 0.9 | Good | ED-2003 | (4) |
| | | | | | | | | | | R2: Polyethylene oxide |
| | | | | | | | | | | R3, R4: Amino group |
| | 189 | CT3000LSSG | α-alumina | 30 | AKM-0531 | (1) | 0.9 | Good | ED-2003 | (4) |
| | | | | | | | | | | R2: Polyethylene oxide |
| | | | | | | | | | | R3, R4: Amino group |
| | 190 | CT3000LSSG | α-alumina | 30 | AKM-0531 | (1) | 0.9 | Good | ED-2003 | (4) |
| | | | | | | | | | | R2: Polyethylene oxide |
| | | | | | | | | | | R3, R4: Amino group |
| | 191 | CT3000LSSG | α-alumina | 30 | AKM-0531 | (1) | 0.9 | Good | ED-2003 | (4) |
| | | | | | | | | | | R2: Polyethylene oxide |
| | | | | | | | | | | R3, R4: Amino group |
| | 192 | CT3000LSSG | α-alumina | 30 | AKM-0531 | (1) | 0.9 | Good | ED-2003 | (4) |
| | | | | | | | | | | R2: Polyethylene oxide |
| | | | | | | | | | | R3, R4: Amino group |
| | 193 | CT3000LSSG | α-alumina | 30 | AKM-0531 | (1) | 0.9 | Good | ED-2003 | (4) |
| | | | | | | | | | | R2: Polyethylene oxide |
| | | | | | | | | | | R3, R4: Amino group |
| | 194 | BMB-07 | Boehmite | 30 | AKM-0531 | (1) | 0.9 | Good | ED-2003 | (4) |
| | | | | | | | | | | R2: Polyethylene oxide |
| | | | | | | | | | | R3, R4: Amino group |
| | 195 | BMB-07 | Boehmite | 30 | AKM-0531 | (1) | 0.9 | Good | ED-2003 | (4) |
| | | | | | | | | | | R2: Polyethylene oxide |
| | | | | | | | | | | R3, R4: Amino group |

| | | Insulating layer-forming liquid composition | | | | | | | |
|---|---|---|---|---|---|---|---|---|---|
| | | Crosslinking | | | | | | | |
| | | agent | Binder | | | | Dispersion medium | | |
| | | Content | | | Content | Dispersibility | | Content | Total |
| | | [% by | | | [% by | in electrolytic | | [% by | [% by |
| | | mass] | Material | Type | mass] | solution | Material | mass] | mass] |
| Example | 181 | 0.3 | LBG-2200LX | PVDF-HFP | 5.6 | Good | EL | 63.2 | 100 |
| | 182 | 0.3 | FE4300 | FEVE | 3.0 | Poor | EL | 65.8 | 100 |
| | 183 | 0.3 | MPT-N8 | PTFE | 3.5 | Poor | EL | 65.3 | 100 |
| | 184 | 0.3 | ARC | PVDF-HFP:Acrylic IPN | 3.5 | Good | EL | 65.3 | 100 |
| | | | | (PVDF:Acrylic = 7:3) | | | | | |
| | 185 | 0.3 | CRX | PVDF-HFP:Acrylic IPN | 3.5 | Good | EL | 65.3 | 100 |
| | | | | (PVDF:Acrylic = 7:3) | | | | | |
| | 186 | 0.3 | LBG-2200LX | PVDF-HFP | 5.6 | Good | EL | 63.2 | 100 |
| | 187 | 0.3 | FE4300 | FEVE | 3.0 | Poor | EL | 65.8 | 100 |
| | 188 | 0.3 | MPT-N8 | PTFE | 3.5 | Poor | EL | 65.3 | 100 |
| | 189 | 0.3 | ARC | PVDF-HFP:Acrylic IPN | 3.5 | Good | EL | 65.3 | 100 |
| | | | | (PVDF:Acrylic = 7:3) | | | | | |
| | 190 | 0.3 | CRX | PVDF-HFP:Acrylic IPN | 3.5 | Good | EL | 65.3 | 100 |
| | | | | (PVDF:Acrylic = 7:3) | | | | | |
| | 191 | 0.3 | LBG-2200LX | PVDF-HFP | 5.6 | Good | EL | 63.2 | 100 |
| | 192 | 0.3 | FE4300 | FEVE | 3.0 | Poor | EL | 65.8 | 100 |
| | 193 | 0.3 | MPT-N8 | PTFE | 3.5 | Poor | EL | 65.3 | 100 |
| | 194 | 0.3 | ARC | PVDF-HFP:Acrylic IPN | 3.5 | Good | EL | 65.3 | 100 |
| | | | | (PVDF:Acrylic = 7:3) | | | | | |
| | 195 | 0.3 | CRX | PVDF-HFP:Acrylic IPN | 3.5 | Good | EL | 65.3 | 100 |
| | | | | (PVDF:Acrylic = 7:3) | | | | | |

TABLE 14

| | | Insulating layer-forming liquid composition | | | | | | | | |
|---|---|---|---|---|---|---|---|---|---|---|
| | | Insulating inorganic | | | Dispersant | | | | | |
| | | particles | | | | | | Solubility in | Crosslinking | |
| | | | | Content | | Structural | Content | electrolytic | agent | |
| | | | | [% by | | unit | [% by | solution when | | Structural |
| | | Material | Type | mass] | Material | included | mass] | dried | Material | unit included |
| Example | 196 | BMB-07 | Boehmite | 30 | AKM-0531 | (1) | 0.9 | Good | ED-2003 | (4) |
| | | | | | | | | | | R2: Polyethylene oxide |
| | | | | | | | | | | R3, R4: Amino group |
| | 197 | BMB-07 | Boehmite | 30 | AKM-0531 | (1) | 0.9 | Good | ED-2003 | (4) |
| | | | | | | | | | | R2: Polyethylene oxide |
| | | | | | | | | | | R3, R4: Amino group |
| | 198 | BMB-07 | Boehmite | 30 | AKM-0531 | (1) | 0.9 | Good | ED-2003 | (4) |
| | | | | | | | | | | R2: Polyethylene oxide |
| | | | | | | | | | | R3, R4: Amino group |
| | 199 | CT3000LSSG | α-alumina | 30 | SC-0505K | (1) | 0.9 | Good | DBE-C25 | (4) |
| | | | | | | | | | | R2: Silicone |
| | | | | | | | | | | R3, R4: Hydroxyl group |

| | | Insulating layer-forming liquid composition | | | | | | | |
|---|---|---|---|---|---|---|---|---|---|
| | | Crosslinking | | | | | | | |
| | | agent | Binder | | | | Dispersion medium | | |
| | | Content | | | Content | Dispersibility | | Content | Total |
| | | [% by | | | [% by | in electrolytic | | [% by | [% by |
| | | mass] | Material | Type | mass] | solution | Material | mass] | mass] |
| Example | 196 | 0.3 | LBG-2200LX | PVDF-HFP | 5.6 | Good | EL | 63.2 | 100 |
| | 197 | 0.3 | FE4300 | FEVE | 3.0 | Poor | EL | 65.8 | 100 |
| | 198 | 0.3 | MPT-N8 | PTFE | 3.5 | Poor | EL | 65.3 | 100 |
| | 199 | 0.3 | FMA-12 | PVDF-HFP:Acrylic IPN | 3.5 | Poor | EL | 65.3 | 100 |
| | | | | (PVDF:Acrylic = 5:5) | | | | | |

TABLE 15

| | | Insulating layer-forming liquid composition | | | | | | | | |
|---|---|---|---|---|---|---|---|---|---|---|
| | | Insulating inorganic | | | Dispersant | | | | | |
| | | particles | | | | | | Solubility in | Crosslinking | |
| | | | | Content | | Structural | Content | electrolytic | agent | |
| | | | | [% by | | unit | [% by | solution when | | Structural |
| | | Material | Type | mass] | Material | included | mass] | dried | Material | unit included |
| Comparative | 1 | CT3000LSSG | α-alumina | 30 | SC-0505K | (1) | 0.9 | Good | DBE-C25 | (4) |
| Example | | | | | | | | | | R2: Silicone |
| | | | | | | | | | | R3, R4: Hydroxyl group |
| | 2 | CT3000LSSG | α-alumina | 30 | SC-0505K | (1) | 0.9 | Good | DBE-C25 | 4) |
| | | | | | | | | | | R2: Silicone |
| | | | | | | | | | | R3, R4: Hydroxyl group |
| | 3 | CT3000LSSG | α-alumina | 30 | CMCNa | — | 0.9 | Poor | — | — |
| | 4 | CT3000LSSG | α-alumina | 30 | SC-0505K | (1) | 0.9 | Good | DBE-C25 | (4) |
| | | | | | | | | | | R2: Silicone |
| | | | | | | | | | | R3, R4: Hydroxyl group |
| | 5 | CT3000LSSG | α-alumina | 30 | SC-0505K | (1) | 0.9 | Good | DBE-C25 | (4) |
| | | | | | | | | | | R2: Silicone |
| | | | | | | | | | | R3, R4: Hydroxyl group |

Insulating layer-forming liquid composition

| Crosslinking | | |
|---|---|---|
| agent | Binder | Dispersion medium |

| | | Content | | | Content | Dispersibility | | Content | Total |
|---|---|---|---|---|---|---|---|---|---|
| | | [% by | | | [% by | in electrolytic | | [% by | [% by |
| | | mass] | Material | Type | mass] | solution | Material | mass] | mass] |
| Comparative | 1 | 0.3 | BM-900B | Acrylic rubber | 3.4 | — | EL | 65.4 | 100 |
| Example | 2 | 0.3 | — | — | | — | EL | 68.8 | 100 |
| | 3 | | — | — | | — | H₂O sol. | 69.1 | 100 |
| | 4 | 0.3 | Polymaron 1343S | Aqueous dispersion of | 7.5 | — | EL | 61.3 | 100 |
| | | | | styrene/acrylic acid-based resin | | | | | |
| | 5 | 0.3 | AC Polyethylene 629 | Polyethylene | 1.5 | — | EL | 67.3 | 100 |

The median diameter D50 and the viscosity were measured with respect to each of the obtained insulating layer-forming liquid compositions.

### [Measurement of Median Diameter D50]

The median diameter D50 of each insulating layer-forming liquid composition was measured using a concentrated particle size analyzer (manufactured by Otsuka Electronics Co., Ltd., FPAR-1000), and evaluated according to the following evaluation criteria. Note that the insulating layer-forming liquid composition was diluted as appropriate in cases where the D50 value did not stabilize. The results are presented in Tables 16 to 18.

### <Evaluation Criteria of Median Diameter D50>

Good: Median diameter D50 is 300 nm or more and less than 1,000 nm
Poor: Median diameter D50 is 1,000 nm or more

### [Measurement of Viscosity]

After stabilizing the temperature of each insulating layer-forming liquid composition at 25° C., the viscosity was measured using an E-type viscometer (manufactured by Toki Sangyo, TVE-25L) at a rotor rotation speed of 100 rpm, and evaluated according to the following evaluation criteria. The results are presented in Tables 16 to 18.

### <Evaluation Criteria of Viscosity>

Good: Viscosity is less than 12 mPa·s
Poor: Viscosity is 12 mPa·s or more

### [Evaluation of Ejection Properties]

The ejection properties of each insulating layer-forming liquid composition was evaluated based on the evaluation of the median diameter D50 and the evaluation of the viscosity. The results are presented in Tables 16 to 18.

### <Evaluation Criteria of Ejection Properties>

Good: “Good” evaluation for both the median diameter D50 and viscosity
Fair: “Poor” evaluation for either the median diameter D50 or viscosity
Poor: “Poor” evaluation for both the median diameter D50 and viscosity

The storage stability was evaluated with respect to each of the obtained insulating layer-forming liquid compositions.

### [Evaluation of Storage Stability]

The viscosity and particle size were evaluated after producing each of the insulating layer-forming liquid compositions, and were used as the initial physical properties. After one day of storage with stirring, the viscosity and particle size were evaluated again for each insulating layer-forming liquid composition, and were used as the post-storage physical properties. The initial physical properties and the post-storage physical properties were compared and evaluated based on the following evaluation criteria. Note that the evaluations of the viscosity and particle size were performed using the same methods as the methods described under the headings [Measurement of Viscosity] and [Measurement of Median Diameter D50]. The results are presented in Tables 16 to 18.

### <Evaluation Criteria of Storage Stability>

Good: No difference between initial physical properties and post-storage physical properties
Fair: “Poor” evaluation for either the median diameter D50 or viscosity of the post-storage physical properties
Poor: “Poor” evaluation for both the median diameter D50 and viscosity of the post-storage physical properties

TABLE 16

| | | Insulating layer-forming liquid composition | | | |
|---|---|---|---|---|---|
| | | Ejection properties | | | |
| | | | Median | Overall | Storage |
| | | Viscosity | diameter | evaluation | stability |
| Example | 1 | Good | Good | Good | Good |
| | 2 | Good | Good | Good | Good |
| | 3 | Good | Good | Good | Good |
| | 4 | Good | Good | Good | Good |
| | 5 | Good | Good | Good | Good |
| | 6 | Good | Good | Good | Good |
| | 7 | Good | Good | Good | Good |
| | 8 | Good | Good | Good | Good |
| | 9 | Good | Good | Good | Good |
| | 10 | Good | Good | Good | Good |
| | 11 | Good | Good | Good | Good |
| | 12 | Good | Good | Good | Good |
| | 13 | Good | Good | Good | Good |
| | 14 | Good | Good | Good | Good |
| | 15 | Good | Good | Good | Good |
| | 16 | Good | Good | Good | Good |
| | 17 | Good | Good | Good | Good |
| | 18 | Good | Good | Good | Good |
| | 19 | Good | Good | Good | Good |
| | 20 | Good | Good | Good | Good |
| | 21 | Good | Good | Good | Good |
| | 22 | Good | Good | Good | Good |
| | 23 | Good | Good | Good | Good |
| | 24 | Good | Good | Good | Good |
| | 25 | Good | Good | Good | Good |
| | 26 | Good | Good | Good | Good |
| | 27 | Good | Good | Good | Good |
| | 28 | Good | Good | Good | Good |
| | 29 | Good | Good | Good | Good |
| | 30 | Good | Good | Good | Good |
| Example | 31 | Good | Good | Good | Good |
| | 32 | Good | Good | Good | Good |
| | 33 | Good | Good | Good | Good |
| | 34 | Good | Good | Good | Good |
| | 35 | Good | Good | Good | Good |
| | 36 | Good | Good | Good | Good |
| | 37 | Good | Good | Good | Good |
| | 38 | Good | Good | Good | Good |
| | 39 | Good | Good | Good | Good |
| | 40 | Good | Good | Good | Good |
| | 41 | Good | Good | Good | Good |
| | 42 | Good | Good | Good | Good |
| | 43 | Good | Good | Good | Good |
| | 44 | Good | Good | Good | Good |
| | 45 | Good | Good | Good | Good |
| | 46 | Good | Good | Good | Good |
| | 47 | Good | Good | Good | Good |
| | 48 | Good | Good | Good | Good |
| | 49 | Good | Good | Good | Good |
| | 50 | Good | Good | Good | Good |
| | 51 | Good | Good | Good | Good |
| | 52 | Good | Good | Good | Good |
| | 53 | Good | Good | Good | Good |
| | 54 | Good | Good | Good | Good |
| | 55 | Good | Good | Good | Good |
| | 56 | Good | Good | Good | Good |
| | 57 | Good | Good | Good | Good |
| | 58 | Good | Good | Good | Good |
| | 59 | Good | Good | Good | Good |
| | 60 | Good | Good | Good | Good |
| Example | 61 | Good | Good | Good | Good |
| | 62 | Good | Good | Good | Good |
| | 63 | Good | Good | Good | Good |
| | 64 | Good | Good | Good | Good |
| | 65 | Good | Good | Good | Good |
| | 66 | Good | Good | Good | Good |
| | 67 | Good | Good | Good | Good |
| | 68 | Good | Good | Good | Good |
| | 69 | Good | Good | Good | Good |
| | 70 | Good | Good | Good | Good |
| | 71 | Good | Good | Good | Good |
| | 72 | Good | Good | Good | Good |
| | 73 | Good | Good | Good | Good |
| | 74 | Good | Good | Good | Good |
| | 75 | Good | Good | Good | Good |
| | 76 | Good | Good | Good | Good |
| | 77 | Good | Good | Good | Good |
| | 78 | Good | Good | Good | Good |
| | 79 | Good | Good | Good | Good |
| | 80 | Good | Good | Good | Good |
| | 81 | Good | Good | Good | Good |
| | 82 | Good | Good | Good | Good |
| | 83 | Good | Good | Good | Good |
| | 84 | Good | Good | Good | Good |
| | 85 | Good | Good | Good | Good |
| | 86 | Good | Good | Good | Good |
| | 87 | Good | Good | Good | Good |
| | 88 | Good | Good | Good | Good |
| | 89 | Good | Good | Good | Good |
| | 90 | Good | Good | Good | Good |

TABLE 17

| | | Insulating layer-forming liquid composition | | | |
|---|---|---|---|---|---|
| | | Ejection properties | | | |
| | | | Median | Overall | Storage |
| | | Viscosity | diameter | evaluation | stability |
| Example | 91 | Good | Good | Good | Good |
| | 92 | Good | Good | Good | Good |
| | 93 | Good | Good | Good | Good |
| | 94 | Good | Good | Good | Good |
| | 95 | Good | Good | Good | Good |
| | 96 | Good | Good | Good | Good |
| | 97 | Good | Good | Good | Good |
| | 98 | Good | Good | Good | Good |
| | 99 | Good | Good | Good | Good |
| | 100 | Good | Good | Good | Good |
| | 101 | Good | Good | Good | Good |
| | 102 | Good | Good | Good | Good |
| | 103 | Good | Good | Good | Good |
| | 104 | Good | Good | Good | Good |
| | 105 | Good | Good | Good | Good |
| | 106 | Good | Good | Good | Good |
| | 107 | Good | Good | Good | Good |
| | 108 | Good | Good | Good | Good |
| | 109 | Good | Good | Good | Good |
| | 110 | Good | Good | Good | Good |
| | 111 | Good | Good | Good | Good |
| | 112 | Good | Good | Good | Good |
| | 113 | Good | Good | Good | Good |
| | 114 | Good | Good | Good | Good |
| | 115 | Good | Good | Good | Good |
| | 116 | Good | Good | Good | Good |
| | 117 | Good | Good | Good | Good |
| | 118 | Good | Good | Good | Good |
| | 119 | Good | Good | Good | Good |
| | 120 | Good | Good | Good | Good |
| Example | 121 | Good | Good | Good | Good |
| | 122 | Good | Good | Good | Good |
| | 123 | Good | Good | Good | Good |
| | 124 | Good | Good | Good | Good |
| | 125 | Good | Good | Good | Good |
| | 126 | Good | Good | Good | Good |
| | 127 | Good | Good | Good | Good |
| | 128 | Good | Good | Good | Good |
| | 129 | Good | Good | Good | Good |
| | 130 | Good | Good | Good | Good |
| | 131 | Good | Good | Good | Good |
| | 132 | Good | Good | Good | Good |
| | 133 | Good | Good | Good | Good |
| | 134 | Good | Good | Good | Good |
| | 135 | Good | Good | Good | Good |
| | 136 | Good | Good | Good | Good |
| | 137 | Good | Good | Good | Good |
| | 138 | Good | Good | Good | Good |
| | 139 | Good | Good | Good | Good |
| | 140 | Good | Good | Good | Good |
| | 141 | Good | Good | Good | Good |
| | 142 | Good | Good | Good | Good |
| | 143 | Good | Good | Good | Good |
| | 144 | Good | Good | Good | Good |
| | 145 | Good | Good | Good | Good |
| | 146 | Good | Good | Good | Good |
| | 147 | Good | Good | Good | Good |
| | 148 | Good | Good | Good | Good |
| | 149 | Good | Good | Good | Good |
| | 150 | Good | Good | Good | Good |
| Example | 151 | Good | Good | Good | Good |
| | 152 | Good | Good | Good | Good |
| | 153 | Good | Good | Good | Good |
| | 154 | Good | Good | Good | Good |
| | 155 | Good | Good | Good | Good |
| | 156 | Good | Good | Good | Good |
| | 157 | Good | Good | Good | Good |
| | 158 | Good | Good | Good | Good |
| | 159 | Good | Good | Good | Good |
| | 160 | Good | Good | Good | Good |
| | 161 | Good | Good | Good | Good |
| | 162 | Good | Good | Good | Good |
| | 163 | Good | Good | Good | Good |
| | 164 | Good | Good | Good | Good |
| | 165 | Good | Good | Good | Good |
| | 166 | Good | Good | Good | Good |
| | 167 | Good | Good | Good | Good |
| | 168 | Good | Good | Good | Good |
| | 169 | Good | Good | Good | Good |
| | 170 | Good | Good | Good | Good |
| | 171 | Good | Good | Good | Good |
| | 172 | Good | Good | Good | Good |
| | 173 | Good | Good | Good | Good |
| | 174 | Good | Good | Good | Good |
| | 175 | Good | Good | Good | Good |
| | 176 | Good | Good | Good | Good |
| | 177 | Good | Good | Good | Good |
| | 178 | Good | Good | Good | Good |
| | 179 | Good | Good | Good | Good |
| | 180 | Good | Good | Good | Good |

TABLE 18

| | | Insulating layer-forming liquid composition | | | |
|---|---|---|---|---|---|
| | | Ejection properties | | | |
| | | | Median | Overall | Storage |
| | | Viscosity | diameter | evaluation | stability |
| Example | 181 | Good | Good | Good | Good |
| | 182 | Good | Good | Good | Good |
| | 183 | Good | Good | Good | Good |
| | 184 | Good | Good | Good | Good |
| | 185 | Good | Good | Good | Good |
| | 186 | Good | Good | Good | Good |
| | 187 | Good | Good | Good | Good |
| | 188 | Good | Good | Good | Good |
| | 189 | Good | Good | Good | Good |
| | 190 | Good | Good | Good | Good |
| | 191 | Good | Good | Good | Good |
| | 192 | Good | Good | Good | Good |
| | 193 | Good | Good | Good | Good |
| | 194 | Good | Good | Good | Good |
| | 195 | Good | Good | Good | Good |
| | 196 | Good | Good | Good | Good |
| | 197 | Good | Good | Good | Good |
| | 198 | Good | Good | Good | Good |
| | 199 | Poor | Good | Fair | Fair |
| Comparative | 1 | Poor | Poor | Poor | Poor |
| Example | 2 | Good | Good | Good | Good |
| | 3 | Poor | Poor | Poor | Poor |
| | 4 | Poor | Poor | Poor | Poor |
| | 5 | Poor | Poor | Poor | Poor |

The abrasion strength and the peel strength were measured with respect to each of the resulting insulating layers.

### [Abrasion Strength Evaluation of Insulating Layer]

After the primary drying of the insulating layer, it was confirmed whether or not particles adhere when rubber gloves (BioLab Fit Gloves (powder-free)) were worn and a finger was brought into contact over the surface of the insulating layer at a speed of 10 cm per second. The evaluations were performed based on the following evaluation criteria. The results are presented in Tables 19 to 22.

### <Evaluation Criteria of Abrasion Strength>

Good: Particles do not adhere to the rubber glove
Poor: Particles adhere to the rubber glove

### [Peel Strength Evaluation of Insulating Layer]

A light load-type adhesive/film peeling analyzer (manufactured by Kyowa Interface Science, Co., Ltd., VPA-3S) was used as the evaluation device, and a tape having a width of 18 mm (manufactured by Nittosha Co., Ltd., cellophane tape) was used. After attaching the tape onto the insulating layer, the average value of the load applied to the load cell when a peeling operation was performed at a peeling angle of 90 degrees and a speed of 30 mm/min was read. The insulating layer after the primary drying and the insulating layer after the secondary drying were each evaluated. The evaluations were performed based on the following evaluation criteria. The results are presented in Tables 19 to 22.

### <Evaluation Criteria of Peel Strength of Insulating Layer After Primary Drying>

Good: Peel strength is 30 N/m or more and less than 250 N/m
Poor: Peel strength is less than 30 N/m or 250 N/m or more

### <Evaluation Criteria of Peel Strength of Insulating Layer After Secondary Drying>

Good: Peel strength is 100 N/m or more
Poor: Peel strength is less than 100 N/m

TABLE 19

| | | Insulating layer | | | | | | | | |
|---|---|---|---|---|---|---|---|---|---|---|
| | | Positive electrode | | | | | | | | |
| | | active material | | | Substrate | | | PE separator | | |
| | | | Peeling of | Peeling of | | Peeling of | Peeling of | | Peeling of | Peeling of |
| | | | film after | film after | | film after | film after | | film after | film after |
| | | Film | primary | secondary | Film | primary | secondary | Film | primary | secondary |
| | | abrasion | drying | drying | abrasion | drying | drying | abrasion | drying | drying |
| Example | 1 | Good | Good | Good | Good | Good | Good | Good | Good | Good |
| | 2 | Good | Good | Good | Good | Good | Good | Good | Good | Good |
| | 3 | Poor | Good | Good | Poor | Good | Good | Poor | Good | Good |
| | 4 | Good | Good | Good | Good | Good | Good | Good | Good | Good |
| | 5 | Poor | Good | Good | Poor | Good | Good | Poor | Good | Good |
| | 6 | Good | Good | Good | Good | Good | Good | Good | Good | Good |
| | 7 | Good | Good | Good | Good | Good | Good | Good | Good | Good |
| | 8 | Poor | Good | Good | Poor | Good | Good | Poor | Good | Good |
| | 9 | Good | Good | Good | Good | Good | Good | Good | Good | Good |
| | 10 | Poor | Good | Good | Poor | Good | Good | Poor | Good | Good |
| | 11 | Good | Good | Good | Good | Good | Good | Good | Good | Good |
| | 12 | Good | Good | Good | Good | Good | Good | Good | Good | Good |
| | 13 | Poor | Good | Good | Poor | Good | Good | Poor | Good | Good |
| | 14 | Good | Good | Good | Good | Good | Good | Good | Good | Good |
| | 15 | Poor | Good | Good | Poor | Good | Good | Poor | Good | Good |
| | 16 | Good | Good | Good | Good | Good | Good | Good | Good | Good |
| | 17 | Good | Good | Good | Good | Good | Good | Good | Good | Good |
| | 18 | Poor | Good | Good | Poor | Good | Good | Poor | Good | Good |
| | 19 | Good | Good | Good | Good | Good | Good | Good | Good | Good |
| | 20 | Poor | Good | Good | Poor | Good | Good | Poor | Good | Good |
| | 21 | Good | Good | Good | Good | Good | Good | Good | Good | Good |
| | 22 | Good | Good | Good | Good | Good | Good | Good | Good | Good |
| | 23 | Poor | Good | Good | Poor | Good | Good | Poor | Good | Good |
| | 24 | Good | Good | Good | Good | Good | Good | Good | Good | Good |
| | 25 | Poor | Good | Good | Poor | Good | Good | Poor | Good | Good |
| | 26 | Good | Good | Good | Good | Good | Good | Good | Good | Good |
| | 27 | Good | Good | Good | Good | Good | Good | Good | Good | Good |
| | 28 | Poor | Good | Good | Poor | Good | Good | Poor | Good | Good |
| | 29 | Good | Good | Good | Good | Good | Good | Good | Good | Good |
| | 30 | Poor | Good | Good | Poor | Good | Good | Poor | Good | Good |
| | 31 | Good | Good | Good | Good | Good | Good | Good | Good | Good |
| | 32 | Good | Good | Good | Good | Good | Good | Good | Good | Good |
| | 33 | Poor | Good | Good | Poor | Good | Good | Poor | Good | Good |
| | 34 | Good | Good | Good | Good | Good | Good | Good | Good | Good |
| | 35 | Good | Good | Good | Good | Good | Good | Good | Good | Good |
| | 36 | Good | Good | Good | Good | Good | Good | Good | Good | Good |
| | 37 | Poor | Good | Good | Poor | Good | Good | Poor | Good | Good |
| | 38 | Good | Good | Good | Good | Good | Good | Good | Good | Good |
| | 39 | Good | Good | Good | Good | Good | Good | Good | Good | Good |
| | 40 | Good | Good | Good | Good | Good | Good | Good | Good | Good |
| | 41 | Poor | Good | Good | Poor | Good | Good | Poor | Good | Good |
| | 42 | Good | Good | Good | Good | Good | Good | Good | Good | Good |
| | 43 | Good | Good | Good | Good | Good | Good | Good | Good | Good |
| | 44 | Good | Good | Good | Good | Good | Good | Good | Good | Good |
| | 45 | Poor | Good | Good | Poor | Good | Good | Poor | Good | Good |
| | 46 | Good | Good | Good | Good | Good | Good | Good | Good | Good |
| | 47 | Good | Good | Good | Good | Good | Good | Good | Good | Good |
| | 48 | Good | Good | Good | Good | Good | Good | Good | Good | Good |
| | 49 | Poor | Good | Good | Poor | Good | Good | Poor | Good | Good |
| | 50 | Good | Good | Good | Good | Good | Good | Good | Good | Good |
| | 51 | Poor | Good | Good | Poor | Good | Good | Poor | Good | Good |
| | 52 | Good | Good | Good | Good | Good | Good | Good | Good | Good |
| | 53 | Good | Good | Good | Good | Good | Good | Good | Good | Good |
| | 54 | Poor | Good | Good | Poor | Good | Good | Poor | Good | Good |
| | 55 | Good | Good | Good | Good | Good | Good | Good | Good | Good |
| | 56 | Poor | Good | Good | Poor | Good | Good | Poor | Good | Good |
| | 57 | Good | Good | Good | Good | Good | Good | Good | Good | Good |
| | 58 | Good | Good | Good | Good | Good | Good | Good | Good | Good |
| | 59 | Poor | Good | Good | Poor | Good | Good | Poor | Good | Good |
| | 60 | Good | Good | Good | Good | Good | Good | Good | Good | Good |

TABLE 20

| | | Insulating layer | | | | | | | | |
|---|---|---|---|---|---|---|---|---|---|---|
| | | Positive electrode | | | | | | | | |
| | | active material | | | Substrate | | | PE separator | | |
| | | | Peeling of | Peeling of | | Peeling of | Peeling of | | Peeling of | Peeling of |
| | | | film after | film after | | film after | film after | | film after | film after |
| | | Film | primary | secondary | Film | primary | secondary | Film | primary | secondary |
| | | abrasion | drying | drying | abrasion | drying | drying | abrasion | drying | drying |
| Example | 61 | Poor | Good | Good | Poor | Good | Good | Poor | Good | Good |
| | 62 | Good | Good | Good | Good | Good | Good | Good | Good | Good |
| | 63 | Good | Good | Good | Good | Good | Good | Good | Good | Good |
| | 64 | Poor | Good | Good | Poor | Good | Good | Poor | Good | Good |
| | 65 | Good | Good | Good | Good | Good | Good | Good | Good | Good |
| | 66 | Poor | Good | Good | Poor | Good | Good | Poor | Good | Good |
| | 67 | Good | Good | Good | Good | Good | Good | Good | Good | Good |
| | 68 | Good | Good | Good | Good | Good | Good | Good | Good | Good |
| | 69 | Poor | Good | Good | Poor | Good | Good | Poor | Good | Good |
| | 70 | Good | Good | Good | Good | Good | Good | Good | Good | Good |
| | 71 | Poor | Good | Good | Poor | Good | Good | Poor | Good | Good |
| | 72 | Good | Good | Good | Good | Good | Good | Good | Good | Good |
| | 73 | Good | Good | Good | Good | Good | Good | Good | Good | Good |
| | 74 | Poor | Good | Good | Poor | Good | Good | Poor | Good | Good |
| | 75 | Good | Good | Good | Good | Good | Good | Good | Good | Good |
| | 76 | Poor | Good | Good | Poor | Good | Good | Poor | Good | Good |
| | 77 | Good | Good | Good | Good | Good | Good | Good | Good | Good |
| | 78 | Good | Good | Good | Good | Good | Good | Good | Good | Good |
| | 79 | Poor | Good | Good | Poor | Good | Good | Poor | Good | Good |
| | 80 | Good | Good | Good | Good | Good | Good | Good | Good | Good |
| | 81 | Good | Good | Good | Good | Good | Good | Good | Good | Good |
| | 82 | Good | Good | Good | Good | Good | Good | Good | Good | Good |
| | 83 | Poor | Good | Good | Poor | Good | Good | Poor | Good | Good |
| | 84 | Good | Good | Good | Good | Good | Good | Good | Good | Good |
| | 85 | Good | Good | Good | Good | Good | Good | Good | Good | Good |
| | 86 | Good | Good | Good | Good | Good | Good | Good | Good | Good |
| | 87 | Poor | Good | Good | Poor | Good | Good | Poor | Good | Good |
| | 88 | Good | Good | Good | Good | Good | Good | Good | Good | Good |
| | 89 | Good | Good | Good | Good | Good | Good | Good | Good | Good |
| | 90 | Good | Good | Good | Good | Good | Good | Good | Good | Good |
| | 91 | Poor | Good | Good | Poor | Good | Good | Poor | Good | Good |
| | 92 | Good | Good | Good | Good | Good | Good | Good | Good | Good |
| | 93 | Good | Good | Good | Good | Good | Good | Good | Good | Good |
| | 94 | Good | Good | Good | Good | Good | Good | Good | Good | Good |
| | 95 | Poor | Good | Good | Poor | Good | Good | Poor | Good | Good |
| | 96 | Good | Good | Good | Good | Good | Good | Good | Good | Good |
| | 97 | Poor | Good | Good | Poor | Good | Good | Poor | Good | Good |
| | 98 | Good | Good | Good | Good | Good | Good | Good | Good | Good |
| | 99 | Good | Good | Good | Good | Good | Good | Good | Good | Good |
| | 100 | Poor | Good | Good | Poor | Good | Good | Poor | Good | Good |
| | 101 | Good | Good | Good | Good | Good | Good | Good | Good | Good |
| | 102 | Poor | Good | Good | Poor | Good | Good | Poor | Good | Good |
| | 103 | Good | Good | Good | Good | Good | Good | Good | Good | Good |
| | 104 | Good | Good | Good | Good | Good | Good | Good | Good | Good |
| | 105 | Poor | Good | Good | Poor | Good | Good | Poor | Good | Good |
| | 106 | Good | Good | Good | Good | Good | Good | Good | Good | Good |
| | 107 | Poor | Good | Good | Poor | Good | Good | Poor | Good | Good |
| | 108 | Good | Good | Good | Good | Good | Good | Good | Good | Good |
| | 109 | Good | Good | Good | Good | Good | Good | Good | Good | Good |
| | 110 | Poor | Good | Good | Poor | Good | Good | Poor | Good | Good |
| | 111 | Good | Good | Good | Good | Good | Good | Good | Good | Good |
| | 112 | Poor | Good | Good | Poor | Good | Good | Poor | Good | Good |
| | 113 | Good | Good | Good | Good | Good | Good | Good | Good | Good |
| | 114 | Good | Good | Good | Good | Good | Good | Good | Good | Good |
| | 115 | Poor | Good | Good | Poor | Good | Good | Poor | Good | Good |
| | 116 | Good | Good | Good | Good | Good | Good | Good | Good | Good |
| | 117 | Poor | Good | Good | Poor | Good | Good | Poor | Good | Good |
| | 118 | Good | Good | Good | Good | Good | Good | Good | Good | Good |
| | 119 | Good | Good | Good | Good | Good | Good | Good | Good | Good |
| | 120 | Poor | Good | Good | Poor | Good | Good | Poor | Good | Good |

TABLE 21

| | | Insulating layer | | | | | | | | |
|---|---|---|---|---|---|---|---|---|---|---|
| | | Positive electrode | | | | | | | | |
| | | active material | | | Substrate | | | PE separator | | |
| | | | Peeling of | Peeling of | | Peeling of | Peeling of | | Peeling of | Peeling of |
| | | | film after | film after | | film after | film after | | film after | film after |
| | | Film | primary | secondary | Film | primary | secondary | Film | primary | secondary |
| | | abrasion | drying | drying | abrasion | drying | drying | abrasion | drying | drying |
| Example | 121 | Good | Good | Good | Good | Good | Good | Good | Good | Good |
| | 122 | Poor | Good | Good | Poor | Good | Good | Poor | Good | Good |
| | 123 | Good | Good | Good | Good | Good | Good | Good | Good | Good |
| | 124 | Good | Good | Good | Good | Good | Good | Good | Good | Good |
| | 125 | Poor | Good | Good | Poor | Good | Good | Poor | Good | Good |
| | 126 | Good | Good | Good | Good | Good | Good | Good | Good | Good |
| | 127 | Good | Good | Good | Good | Good | Good | Good | Good | Good |
| | 128 | Good | Good | Good | Good | Good | Good | Good | Good | Good |
| | 129 | Poor | Good | Good | Poor | Good | Good | Poor | Good | Good |
| | 130 | Good | Good | Good | Good | Good | Good | Good | Good | Good |
| | 131 | Good | Good | Good | Good | Good | Good | Good | Good | Good |
| | 132 | Good | Good | Good | Good | Good | Good | Good | Good | Good |
| | 133 | Poor | Good | Good | Poor | Good | Good | Poor | Good | Good |
| | 134 | Good | Good | Good | Good | Good | Good | Good | Good | Good |
| | 135 | Good | Good | Good | Good | Good | Good | Good | Good | Good |
| | 136 | Good | Good | Good | Good | Good | Good | Good | Good | Good |
| | 137 | Poor | Good | Good | Poor | Good | Good | Poor | Good | Good |
| | 138 | Good | Good | Good | Good | Good | Good | Good | Good | Good |
| | 139 | Good | Good | Good | Good | Good | Good | Good | Good | Good |
| | 140 | Good | Good | Good | Good | Good | Good | Good | Good | Good |
| | 141 | Poor | Good | Good | Poor | Good | Good | Poor | Good | Good |
| | 142 | Good | Good | Good | Good | Good | Good | Good | Good | Good |
| | 143 | Poor | Good | Good | Poor | Good | Good | Poor | Good | Good |
| | 144 | Good | Good | Good | Good | Good | Good | Good | Good | Good |
| | 145 | Good | Good | Good | Good | Good | Good | Good | Good | Good |
| | 146 | Poor | Good | Good | Poor | Good | Good | Poor | Good | Good |
| | 147 | Good | Good | Good | Good | Good | Good | Good | Good | Good |
| | 148 | Poor | Good | Good | Poor | Good | Good | Poor | Good | Good |
| | 149 | Good | Good | Good | Good | Good | Good | Good | Good | Good |
| | 150 | Good | Good | Good | Good | Good | Good | Good | Good | Good |
| | 151 | Poor | Good | Good | Poor | Good | Good | Poor | Good | Good |
| | 152 | Good | Good | Good | Good | Good | Good | Good | Good | Good |
| | 153 | Poor | Good | Good | Poor | Good | Good | Poor | Good | Good |
| | 154 | Good | Good | Good | Good | Good | Good | Good | Good | Good |
| | 155 | Good | Good | Good | Good | Good | Good | Good | Good | Good |
| | 156 | Poor | Good | Good | Poor | Good | Good | Poor | Good | Good |
| | 157 | Good | Good | Good | Good | Good | Good | Good | Good | Good |
| | 158 | Poor | Good | Good | Poor | Good | Good | Poor | Good | Good |
| | 159 | Good | Good | Good | Good | Good | Good | Good | Good | Good |
| | 160 | Good | Good | Good | Good | Good | Good | Good | Good | Good |
| | 161 | Poor | Good | Good | Poor | Good | Good | Poor | Good | Good |
| | 162 | Good | Good | Good | Good | Good | Good | Good | Good | Good |
| | 163 | Poor | Good | Good | Poor | Good | Good | Poor | Good | Good |
| | 164 | Good | Good | Good | Good | Good | Good | Good | Good | Good |
| | 165 | Good | Good | Good | Good | Good | Good | Good | Good | Good |
| | 166 | Poor | Good | Good | Poor | Good | Good | Poor | Good | Good |
| | 167 | Good | Good | Good | Good | Good | Good | Good | Good | Good |
| | 168 | Poor | Good | Good | Poor | Good | Good | Poor | Good | Good |
| | 169 | Good | Good | Good | Good | Good | Good | Good | Good | Good |
| | 170 | Good | Good | Good | Good | Good | Good | Good | Good | Good |
| | 171 | Poor | Good | Good | Poor | Good | Good | Poor | Good | Good |
| | 172 | Good | Good | Good | Good | Good | Good | Good | Good | Good |
| | 173 | Poor | Good | Good | Poor | Good | Good | Poor | Good | Good |
| | 174 | Good | Good | Good | Good | Good | Good | Good | Good | Good |
| | 175 | Good | Good | Good | Good | Good | Good | Good | Good | Good |
| | 176 | Poor | Good | Good | Poor | Good | Good | Poor | Good | Good |
| | 177 | Good | Good | Good | Good | Good | Good | Good | Good | Good |
| | 178 | Poor | Good | Good | Poor | Good | Good | Poor | Good | Good |
| | 179 | Good | Good | Good | Good | Good | Good | Good | Good | Good |
| | 180 | Good | Good | Good | Good | Good | Good | Good | Good | Good |

TABLE 22

| | | Insulating layer | | | | | | | | |
|---|---|---|---|---|---|---|---|---|---|---|
| | | Positive electrode | | | | | | | | |
| | | active material | | | Substrate | | | PE separator | | |
| | | | Peeling of | Peeling of | | Peeling of | Peeling of | | Peeling of | Peeling of |
| | | | film after | film after | | film after | film after | | film after | film after |
| | | Film | primary | secondary | Film | primary | secondary | Film | primary | secondary |
| | | abrasion | drying | drying | abrasion | drying | drying | abrasion | drying | drying |
| Example | 181 | Poor | Good | Good | Poor | Good | Good | Poor | Good | Good |
| | 182 | Good | Good | Good | Good | Good | Good | Good | Good | Good |
| | 183 | Poor | Good | Good | Poor | Good | Good | Poor | Good | Good |
| | 184 | Good | Good | Good | Good | Good | Good | Good | Good | Good |
| | 185 | Good | Good | Good | Good | Good | Good | Good | Good | Good |
| | 186 | Poor | Good | Good | Poor | Good | Good | Poor | Good | Good |
| | 187 | Good | Good | Good | Good | Good | Good | Good | Good | Good |
| | 188 | Poor | Good | Good | Poor | Good | Good | Poor | Good | Good |
| | 189 | Good | Good | Good | Good | Good | Good | Good | Good | Good |
| | 190 | Good | Good | Good | Good | Good | Good | Good | Good | Good |
| | 191 | Poor | Good | Good | Poor | Good | Good | Poor | Good | Good |
| | 192 | Good | Good | Good | Good | Good | Good | Good | Good | Good |
| | 193 | Poor | Good | Good | Poor | Good | Good | Poor | Good | Good |
| | 194 | Good | Good | Good | Good | Good | Good | Good | Good | Good |
| | 195 | Good | Good | Good | Good | Good | Good | Good | Good | Good |
| | 196 | Poor | Good | Good | Poor | Good | Good | Poor | Good | Good |
| | 197 | Good | Good | Good | Good | Good | Good | Good | Good | Good |
| | 198 | Poor | Good | Good | Poor | Good | Good | Poor | Good | Good |
| | 199 | Good | Good | Good | Good | Good | Good | Good | Good | Good |
| Comparative | 1 | — | — | — | — | — | — | — | — | — |
| Example | 2 | Poor | Poor | Good | Poor | Poor | Good | Poor | Poor | Good |
| | 3 | — | — | — | — | — | — | — | — | — |
| | 4 | — | — | — | — | — | — | — | — | — |
| | 5 | — | — | — | — | — | — | — | — | — |

The insulating layer-forming liquid compositions of Examples 1 to 198 each displayed a good viscosity, median diameter, and ejection properties.

In the insulating layer-forming liquid composition of Example 199, the binder did not disperse in the non-aqueous electrolytic solution, and the viscosity of the insulating layer-forming liquid composition was high. In addition, because the content of the acrylic resin was high relative to the insulating inorganic particles, the particles tended to aggregate, and the storage stability was reduced.

The insulating layers of Examples 1 to 199 exhibited reduced abrasion strength when LBG-2200LX and MPT-N8 were used as the binder, but were otherwise satisfactory.

Because the insulating layer-forming liquid composition of Comparative Example 1 used a binder that did not contain fluorine atoms, aggregation occurred, which did not allow the measurements and evaluations to be carried out.

In Comparative Example 2, because no binder was added, the abrasion strength after primary drying and the peel strength after primary drying did not satisfy the standards.

In Comparative Example 3, because the dispersant did not contain a structural unit represented by general formulas (1) to (3), dissolution in the non-aqueous electrolytic solution was not possible, and further evaluation was not possible because the insulating layer-forming liquid composition became thicker, and the particle size distribution deteriorated.

In Comparative Examples 4 and 5, because a binder not including fluorine was used, further evaluation was not possible because the insulating layer-forming liquid composition became thicker, and the particle size distribution deteriorated.

### Examples 200 to 222 and Comparative Examples 6 to 12

### <Production of Lithium Ion Battery>

The insulating layer-forming liquid compositions were produced in the same manner as in Example 1, except for changes to the composition presented in Tables 23 and 24.

TABLE 23

| | | Insulating layer-forming liquid composition | | | | | | | | |
|---|---|---|---|---|---|---|---|---|---|---|
| | | Insulating inorganic | | | Dispersant | | | | | |
| | | particles | | | | | | Solubility in | Crosslinking | |
| | | | | Content | | Structural | Content | electrolytic | agent | |
| | | | | [% by | | unit | [% by | solution when | | Structural |
| | | Material | Type | mass] | Material | included | mass] | dried | Material | unit included |
| Example | 200 | CT3000LSSG | α-alumina | 30 | SC-0505K | (1) | 1 | Good | DBE-C25 | (4) |
| | 201 | CT3000LSSG | α-alumina | 30 | SC-0505K | (1) | 1.5 | Good | DBE-C25 | (4) |
| | 202 | CT3000LSSG | α-alumina | 30 | SC-0505K | (1) | 2 | Good | DBE-C25 | (4) |
| | 203 | CT3000LSSG | α-alumina | 30 | SC-0505K | (1) | 3 | Good | DBE-C25 | (4) |
| | 204 | CT3000LSSG | α-alumina | 30 | SC-0505K | (1) | 6 | Good | DBE-C25 | (4) |
| | 205 | CT3000LSSG | α-alumina | 30 | SC-0505K | (1) | 8 | Good | DBE-C25 | (4) |
| | 206 | CT3000LSSG | α-alumina | 30 | SC-0505K | (1) | 10 | Good | DBE-C25 | (4) |
| | 207 | CT3000LSSG | α-alumina | 30 | SC-0505K | (1) | 4 | Good | DBE-C25 | (4) |
| | 208 | CT3000LSSG | α-alumina | 30 | SC-0505K | (1) | 4 | Good | DBE-C25 | (4) |
| | 209 | CT3000LSSG | α-alumina | 30 | SC-0505K | (1) | 4 | Good | DBE-C25 | (4) |
| | 210 | CT3000LSSG | α-alumina | 30 | SC-0505K | (1) | 4 | Good | DBE-C25 | (4) |
| | 211 | CT3000LSSG | α-alumina | 30 | SC-0505K | (1) | 4 | Good | DBE-C25 | (4) |
| | 212 | CT3000LSSG | α-alumina | 30 | SC-0505K | (1) | 4 | Good | DBE-C25 | (4) |
| | 213 | CT3000LSSG | α-alumina | 30 | SC-0505K | (1) | 4 | Good | DBE-C25 | (4) |
| | 214 | CT3000LSSG | α-alumina | 30 | SC-0505K | (1) | 4 | Good | DBE-C25 | (4) |
| | 215 | CT3000LSSG | α-alumina | 30 | SC-0505K | (1) | 4 | Good | DBE-C25 | (4) |
| | 216 | CT3000LSSG | α-alumina | 30 | SC-0505K | (1) | 4 | Good | DBE-C25 | (4) |
| | 217 | CT3000LSSG | α-alumina | 30 | SC-0505K | (1) | 4 | Good | DBE-C25 | (4) |
| | 218 | CT3000LSSG | α-alumina | 30 | SC-0505K | (1) | 4 | Good | DBE-C25 | (4) |
| | 219 | CT3000LSSG | α-alumina | 30 | SC-0505K | (1) | 4 | Good | DBE-C25 | (4) |
| | 220 | CT3000LSSG | α-alumina | 30 | SC-0505K | (1) | 4 | Good | DBE-C25 | (4) |
| | 221 | CT3000LSSG | α-alumina | 30 | SC-0505K | (1) | 4 | Good | DBE-C25 | (4) |
| | 222 | CT3000LSSG | α-alumina | 30 | SC-0505K | (1) | 4 | Good | DBE-C25 | (4) |

| | | Insulating layer-forming liquid composition | | | | | | | |
|---|---|---|---|---|---|---|---|---|---|
| | | Crosslinking | | | | | | | |
| | | agent | Binder | | | | Dispersion medium | | |
| | | Content | | | Content | Dispersibility | | Content | Total |
| | | [% by | | | [% by | in electrolytic | | [% by | [% by |
| | | mass] | Material | Type | mass] | solution | Material | mass] | mass] |
| Example | 200 | 1 | ARC | PVDF-HFP:AcrylicIPN | 3 | Good | EL | 65.0 | 100 |
| | | | | (PVDF:Acrylic = 7:3) | | | | | |
| | 201 | 1 | ARC | PVDF-HFP:AcrylicIPN | 3 | Good | EL | 64.5 | 100 |
| | | | | (PVDF:Acrylic = 7:3) | | | | | |
| | 202 | 1 | ARC | PVDF-HFP:AcrylicIPN | 3 | Good | EL | 64.0 | 100 |
| | | | | (PVDF:Acrylic = 7:3) | | | | | |
| | 203 | 1 | ARC | PVDF-HFP:AcrylicIPN | 3 | Good | EL | 63.0 | 100 |
| | | | | (PVDF:Acrylic = 7:3) | | | | | |
| | 204 | 1 | ARC | PVDF-HFP:AcrylicIPN | 3 | Good | EL | 60.0 | 100 |
| | | | | (PVDF:Acrylic = 7:3) | | | | | |
| | 205 | 1 | ARC | PVDF-HFP:AcrylicIPN | 3 | Good | EL | 58.0 | 100 |
| | | | | (PVDF:Acrylic = 7:3) | | | | | |
| | 206 | 1 | ARC | PVDF-HFP:AcrylicIPN | 3 | Good | EL | 56.0 | 100 |
| | | | | (PVDF:Acrylic = 7:3) | | | | | |
| | 207 | 0.1 | ARC | PVDF-HFP:AcrylicIPN | 3 | Good | EL | 62.9 | 100 |
| | | | | (PVDF:Acrylic = 7:3) | | | | | |
| | 208 | 0.3 | ARC | PVDF-HFP:AcrylicIPN | 3 | Good | EL | 62.7 | 100 |
| | | | | (PVDF:Acrylic = 7:3) | | | | | |
| | 209 | 0.5 | ARC | PVDF-HFP:AcrylicIPN | 3 | Good | EL | 62.5 | 100 |
| | | | | (PVDF:Acrylic = 7:3) | | | | | |
| | 210 | 1 | ARC | PVDF-HFP:AcrylicIPN | 3 | Good | EL | 62.0 | 100 |
| | | | | (PVDF:Acrylic = 7:3) | | | | | |
| | 211 | 2 | ARC | PVDF-HFP:AcrylicIPN | 3 | Good | EL | 61.0 | 100 |
| | | | | (PVDF:Acrylic = 7:3) | | | | | |
| | 212 | 3 | ARC | PVDF-HFP:AcrylicIPN | 3 | Good | EL | 60.0 | 100 |
| | | | | (PVDF:Acrylic = 7:3) | | | | | |
| | 213 | 4 | ARC | PVDF-HFP:AcrylicIPN | 3 | Good | EL | 59.0 | 100 |
| | | | | (PVDF:Acrylic = 7:3) | | | | | |
| | 214 | 5 | ARC | PVDF-HFP:AcrylicIPN | 3 | Good | EL | 58.0 | 100 |
| | | | | (PVDF:Acrylic = 7:3) | | | | | |
| | 215 | 1 | ARC | PVDF-HFP:AcrylicIPN | 1 | Good | EL | 64.0 | 100 |
| | | | | (PVDF:Acrylic = 7:3) | | | | | |
| | 216 | 1 | ARC | PVDF-HFP:AcrylicIPN | 2 | Good | EL | 63.0 | 100 |
| | | | | (PVDF:Acrylic = 7:3) | | | | | |
| | 217 | 1 | ARC | PVDF-HFP:AcrylicIPN | 3 | Good | EL | 62.0 | 100 |
| | | | | (PVDF:Acrylic = 7:3) | | | | | |
| | 218 | 1 | ARC | PVDF-HFP:AcrylicIPN | 4 | Good | EL | 61.0 | 100 |
| | | | | (PVDF:Acrylic = 7:3) | | | | | |
| | 219 | 1 | ARC | PVDF-HFP:AcrylicIPN | 5 | Good | EL | 60.0 | 100 |
| | | | | (PVDF:Acrylic = 7:3) | | | | | |
| | 220 | 1 | ARC | PVDF-HFP:AcrylicIPN | 6 | Good | EL | 59.0 | 100 |
| | | | | (PVDF:Acrylic = 7:3) | | | | | |
| | 221 | 1 | ARC | PVDF-HFP:AcrylicIPN | 7 | Good | EL | 58.0 | 100 |
| | | | | (PVDF:Acrylic = 7:3) | | | | | |
| | 222 | 1 | ARC | PVDF-HFP:AcrylicIPN | 8 | Good | EL | 57.0 | 100 |
| | | | | (PVDF:Acrylic = 7:3) | | | | | |

TABLE 24

| | | Insulating layer-forming liquid composition | | | | | | | | |
|---|---|---|---|---|---|---|---|---|---|---|
| | | Insulating inorganic | | | Dispersant | | | | | |
| | | particles | | | | | | Solubility in | Crosslinking | |
| | | | | Content | | Structural | Content | electrolytic | agent | |
| | | | | [% by | | unit | [% by | solution when | | Structural |
| | | Material | Type | mass] | Material | included | mass] | dried | Material | unit included |
| Comparative | 6 | CT3000LSSG | α-alumina | 30 | SC-0505K | (1) | 0.1 | Good | DBE-C25 | (4) |
| Example | 7 | CT3000LSSG | α-alumina | 30 | SC-0505K | (1) | 11 | Good | DBE-C25 | (4) |
| | 8 | CT3000LSSG | α-alumina | 30 | SC-0505K | (1) | 4 | Good | DBE-C25 | (4) |
| | 9 | CT3000LSSG | α-alumina | 30 | SC-0505K | (1) | 4 | Good | DBE-C25 | (4) |
| | 10 | CT3000LSSG | α-alumina | 30 | SC-0505K | (1) | 4 | Good | DBE-C25 | (4) |
| | 11 | CT3000LSSG | α-alumina | 30 | SC-0505K | (1) | 4 | Good | DBE-C25 | (4) |
| | 12 | — | — | — | — | — | — | — | — | — |

| | | Insulating layer-forming liquid composition | | | | | | | |
|---|---|---|---|---|---|---|---|---|---|
| | | Crosslinking | | | | | | | |
| | | agent | Binder | | | | Dispersion medium | | |
| | | Content | | | Content | Dispersibility | | Content | Total |
| | | [% by | | | [% by | in electrolytic | | [% by | [% by |
| | | mass] | Material | Type | mass] | solution | Material | mass] | mass] |
| Comparative | 6 | 1 | ARC | PVDF-HFP:AcrylicIPN | 3 | Good | EL | 65.9 | 100 |
| Example | | | | (PVDF:Acrylic = 7:3) | | | | | |
| | 7 | 1 | ARC | PVDF-HFP:AcrylicIPN | 3 | Good | EL | 55.0 | 100 |
| | | | | (PVDF:Acrylic = 7:3) | | | | | |
| | 8 | 0.05 | ARC | PVDF-HFP:AcrylicIPN | 3 | Good | EL | 63.0 | 100 |
| | | | | (PVDF:Acrylic = 7:3) | | | | | |
| | 9 | 6 | ARC | PVDF-HFP:AcrylicIPN | 3 | Good | EL | 57.0 | 100 |
| | | | | (PVDF:Acrylic = 7:3) | | | | | |
| | 10 | 1 | ARC | PVDF-HFP:AcrylicIPN | 0.5 | Good | EL | 64.5 | 100 |
| | | | | (PVDF:Acrylic = 7:3) | | | | | |
| | 11 | 1 | ARC | PVDF-HFP:AcrylicIPN | 9 | Good | EL | 56.0 | 100 |
| | | | | (PVDF:Acrylic = 7:3) | | | | | |
| | 12 | — | — | — | — | — | — | — | — |

For each of the insulating layer-forming liquid compositions, the median diameter D50, viscosity, ejection properties, and storage stability were measured and evaluated in the same manner as in Example 1. The results are presented in Table 25.

An electrode having an insulating layer formed using each insulating layer-forming liquid composition and an electrode having the opposite polarity were alternately laminated with a separator interposed therebetween to obtain an electrode laminate. The electrode laminate was mounted on a laminate, and an electrolytic solution (EC: DMC: EC=1%: 1%: 1%, LiPF₆ 1.5 mol/L, vinylene carbonate (VC) 1%) was poured into the laminate, and the interior was vacuum sealed to prepare each lithium ion secondary battery.

In a case where a separator formed having an insulating layer was used, the separator formed having the insulating layer interposed between the negative electrode and the positive electrode, and the electrode laminate was obtained by alternately laminating the components.

Note that, in Comparative Example 12, a lithium ion secondary battery was obtained without forming an insulating layer.

To evaluate the battery characteristics of the obtained lithium ion batteries, a power output characteristic test, a float test, and a temperature rise test were carried out.

A positive electrode lead wire and a negative electrode lead wire of the obtained lithium ion batteries were connected to a charge/discharge test device, and the batteries were charged at a constant current and constant voltage with a maximum voltage of 4.2 V and a current rate of 0.2 C for 5 hours. After charging was completed, the batteries were left to stand in a constant temperature bath at 40° C. for 5 days. Then, the the batteries were discharged at a constant current of 2.5 V at a current rate of 0.2 C. Next, the batteries were charged at a constant current and constant voltage with a maximum voltage of 4.2 V and a current rate of 0.2 C for 5 hours, and after a 10 minute pause, were discharged at a constant current to 2.5 V at a current rate of 0.2 C. The discharge capacity at that time was defined as the initial capacity.

### [Evaluation of Output Characteristics]

The positive electrode lead wire and the negative electrode lead wire of the battery whose initial capacity had been measured were connected to a charge/discharge test device, and the battery was charged at a maximum voltage of 4.2 V and a current rate of 0.2 C for 5 hours. After a 10 minute pause, the lithium ion battery was discharged at a constant current rate of 0.2 C for 2.5 hours until the depth of charge of the lithium ion battery reached 50%. Next, a pulse discharge was performed at a current rate of 1 C to 10 C for 10 seconds, and the power to reach a cutoff voltage of 2.5 V was calculated from a correlation line between the post-pulse voltage and the current value, and the output density was calculated by dividing by the cell weight.

The output characteristics of each lithium ion battery were evaluated according to the following evaluation criteria by comparing the output density ratio with that of a lithium ion battery having no insulating layer applied on the electrode. The results are presented in Table 25.

### <Evaluation Criteria of Output Characteristics>

Good: 97% or more relative to lithium ion battery formed without an insulating layer
Fair: 95% or more and less than 97% relative to lithium ion battery formed without an insulating layer
Poor: Less than 95% relative to lithium ion battery formed without an insulating layer

### [Float Test]

The fully charged lithium ion secondary battery was placed in a thermostatic chamber set at 60° C., and charged at a constant voltage of 4.2 V for 10 days. The integrated charge capacity [mAh] during the constant voltage charging at this time was calculated. The float characteristics were evaluated according to the following criteria. The results are presented in Table 25.

### <Evaluation Criteria of Float Test>

Good: Integrated charge capacity 20 mAh or less
Poor: Integrated charge capacity exceeds 20 mAh

### [Temperature Rise Test]

A lithium ion secondary battery fully charged to 4.2 V was placed in a thermostatic chamber and left at 30° C. for 30 minutes. Then, the battery was heated to 140° C. at a temperature ramp rate of 5° C. per minute. Once the temperature reached 140° C., the temperature was held constant for 30 minutes before being cooling. The voltage of the lithium ion secondary battery was measured during the test, and a cell whose cell voltage fell below 1 V was determined to be short-circuited. The evaluation was performed according to the following criteria. The results are presented in Table 25.

### <Evaluation Criteria of Temperature Rise Test>

Good: Less than 50% of cells short-circuited
Poor: 50% or more of cells short-circuited

TABLE 25

| | | Insulating layer-forming | | | | | | | |
|---|---|---|---|---|---|---|---|---|---|
| | | liquid composition | | | | Battery | | | |
| | | Ejection properties | | | | Peel test | | | |
| | | | Median | Overall | Storage | after primary | Output | Float | Temperature |
| | | Viscosity | diameter | evaluation | Stability | drying | characteristics | test | rise test |
| Example | 200 | Good | Good | Good | Good | Good | Fair | Good | Good |
| | 201 | Good | Good | Good | Good | Good | Fair | Good | Good |
| | 202 | Good | Good | Good | Good | Good | Good | Good | Good |
| | 203 | Good | Good | Good | Good | Good | Good | Good | Good |
| | 204 | Good | Good | Good | Good | Good | Good | Good | Good |
| | 205 | Good | Good | Good | Good | Good | Fair | Good | Good |
| | 206 | Good | Good | Good | Good | Good | Fair | Good | Good |
| | 207 | Good | Good | Good | Good | Good | Fair | Good | Good |
| | 208 | Good | Good | Good | Good | Good | Fair | Good | Good |
| | 209 | Good | Good | Good | Good | Good | Good | Good | Good |
| | 210 | Good | Good | Good | Good | Good | Good | Good | Good |
| | 211 | Good | Good | Good | Good | Good | Good | Good | Good |
| | 212 | Good | Good | Good | Good | Good | Good | Good | Good |
| | 213 | Good | Good | Good | Good | Good | Fair | Good | Good |
| | 214 | Good | Good | Good | Good | Good | Fair | Good | Good |
| | 215 | Good | Good | Good | Good | Good | Fair | Good | Good |
| | 216 | Good | Good | Good | Good | Good | Fair | Good | Good |
| | 217 | Good | Good | Good | Good | Good | Good | Good | Good |
| | 218 | Good | Good | Good | Good | Good | Good | Good | Good |
| | 219 | Good | Good | Good | Good | Good | Good | Good | Good |
| | 220 | Good | Good | Good | Good | Good | Good | Good | Good |
| | 221 | Good | Good | Good | Good | Good | Fair | Good | Good |
| | 222 | Good | Good | Good | Good | Good | Fair | Good | Good |
| Comparative | 6 | Poor | Poor | Poor | Poor | — | — | — | — |
| Example | 7 | Good | Good | Good | Good | Good | Poor | Good | Good |
| | 8 | Good | Good | Good | Good | Good | Good | Good | Poor |
| | 9 | Good | Good | Good | Good | Good | Poor | Good | Good |
| | 10 | Good | Good | Good | Good | Poor | Good | Good | Poor |
| | | | | | | (Insufficient | | | |
| | | | | | | strength) | | | |
| | 11 | Poor | Good | Fair | Good | Poor | Poor | Good | Good |
| | | | | | | (Excessive | | | |
| | | | | | | strength) | | | |
| | 12 | — | — | — | — | — | Fair | Poor | Poor |

It can be understood that the batteries obtained using the insulating layer-forming liquid compositions of Examples 200 to 201, Examples 205 to 208, Examples 213 to 216, and Examples 221 and 222 have insufficient ionic conductivity and poor output characteristics because the content of each material is outside the preferred numerical range.

The insulating layer-forming liquid composition of Comparative Example 6 had a low dispersant content, and the insulating layer-forming liquid composition was poorly dispersed, which did not allow measurements and evaluations to be carried out.

The insulating layer-forming liquid composition of Comparative Example 7 had a high dispersant content, and the output characteristics deteriorated and the standards were not met.

The insulating layer-forming liquid composition of Comparative Example 8 had a low content of the crosslinking agent. Therefore, it was not possible to sufficiently form the crosslinked resin, and film peeling occurred during the temperature rise test and the standards were not met.

The insulating layer-forming liquid composition of Comparative Example 9 had a high crosslinking agent content, and the output characteristics deteriorated and the standards were not met.

The insulating layer-forming liquid composition of Comparative Example 10 had a low binder content. Therefore, the peel strength after primary drying was low, and the film became chipped during the cell production step and the standards of the temperature rise test were not met.

The insulating layer-forming liquid composition of Comparative Example 11 had a high binder content. Therefore, the peel strength after primary drying was excessive, and the output characteristics deteriorated and the standards were not met.

In Comparative Example 12, because no insulating layer was formed, the standards for the float test and the temperature rise test were not met.

Aspects of the present invention include, but are not limited to, the following.

A first aspect is an insulating layer-forming liquid composition including: insulating inorganic particles;
a resin including at least one of a structural unit represented by general formula (1) below, a structural unit represented by general formula (2) below, or a structural unit represented by general formula (3) below, in an amount of 0.1% by mass or more and 5% by mass or less of the insulating inorganic particles;
a resin including a structural unit represented by general formula (4) below, in an amount of 0.1% by mass or more and 5% by mass or less of the insulating inorganic particles; and
a resin including fluorine atoms:

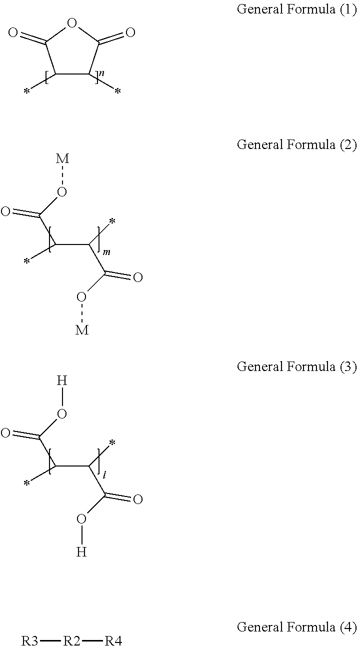

where, in general formulas (1) to (4), * represents a bonding site with an adjacent main chain structural unit, R2 represents at least one of polyurethane, polyester, polyethylene oxide, polypropylene oxide, poloxamer, polycarbonate, silicone, polybutadiene, or hydrogenated polybutadiene butane, R3 and R4 each independently represent a hydroxyl group or an amino group, M represents an ammonium salt, and n, m, and l each independently represent an integer from 2 to 500.

A second aspect is the insulating layer-forming liquid composition according to the first aspect, wherein
the resin including at least one of the structural unit represented by general formula (1), the structural unit represented by general formula (2), or the structural unit represented by general formula (3), and the resin including the structural unit represented by general formula (4) independently dissolve in an electrolytic solvent.

A third aspect is the insulating layer-forming liquid composition according to the first or second aspect, wherein
the resin including fluorine atoms independently disperses in an electrolytic solvent.

A fourth aspect is the insulating layer-forming liquid composition according to any one of the first to third aspects, wherein
the resin including fluorine atoms contains a fluororesin including at least one of PVDF, PVDF-HFP, PTFE, or PEVE.

A fifth aspect is the insulating layer-forming liquid composition according to any one of the first to third aspects, wherein
the resin including fluorine atoms contains a fluororesin including PVDF-HFP.

A sixth aspect is the insulating layer-forming liquid composition according to any one of the first to fifth aspects, wherein
the resin including fluorine atoms further contains an acrylic resin.

A seventh aspect is the insulating layer-forming liquid composition according to the sixth aspect,
wherein the fluororesin and the acrylic resin each include an interpenetrated polymer network structure.

An eighth aspect is the insulating layer-forming liquid composition according to the sixth or seventh aspects, wherein
the fluororesin accounts for 65% by mass or more of the resin including fluorine atoms, and
the acrylic resin accounts for 35% by mass or less of the resin including fluorine atoms.

A ninth aspect is the insulating layer-forming liquid composition according to any one of the first to eighth aspects, wherein
the amount of the resin including at least one of the structural unit represented by general formula (1), the structural unit represented by general formula (2), or the structural unit represented by general formula (3) is 1.5% by mass or more and 8% by mass or less of the insulating inorganic particles,
the amount of the resin including the structural unit represented by general formula (4) is 0.3% by mass or more and 4% by mass or less of the insulating inorganic particles, and
the amount of the resin including fluorine atoms is 1.5% by mass or more and 7% by mass or less of the insulating inorganic particles.

A tenth aspect is the insulating layer-forming liquid composition according to any one of the first to ninth aspects, wherein
R2 in general formula (4) represents a poloxamer.

An eleventh aspect is the insulating layer-forming liquid composition according to any one of the first to tenth aspects, wherein
the insulating inorganic particles comprise α-alumina or boehmite.

A twelfth aspect is an electrode comprising:
a substrate;
an electrode composite layer on a portion of the substrate; and
an insulating layer covering an interface portion between an exposed portion, in which the substrate is exposed, and the electrode composite layer, the insulating layer including:
   insulating inorganic particles;
   a resin including fluorine atoms; and
   a crosslinked resin including at least one of a structural unit represented by general formula (5) below or a structural unit represented by general formula (6) below:

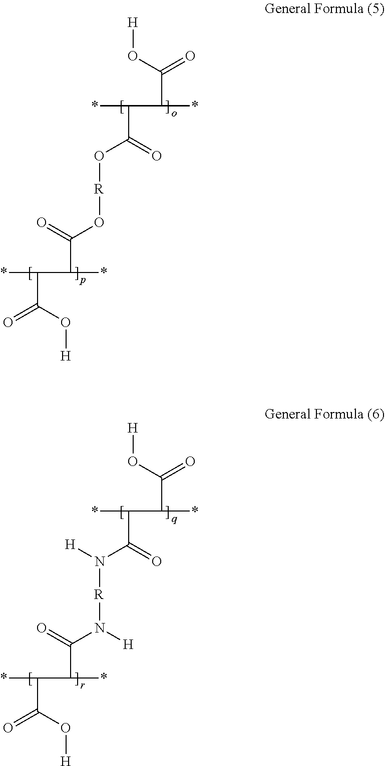

where, in general formulas (5) and (6), * represents a bonding site with an adjacent main chain structural unit, R represents a structure of at least one of polyethylene oxide, polypropylene oxide, polycarbonate, silicone, polybutadiene, or hydrogenated polybutadiene butane, and o, p, q, and r each independently represent an integer from 2 to 500.

A thirteenth aspect is the electrode according to the twelfth aspect, wherein
the crosslinked resin is formed by a reaction between a resin including at least one of a structural unit represented by general formula (1) below, a structural unit represented by general formula (2) below, or a structural unit represented by general formula (3) below, and a resin including a structural unit represented by general formula (4) below:

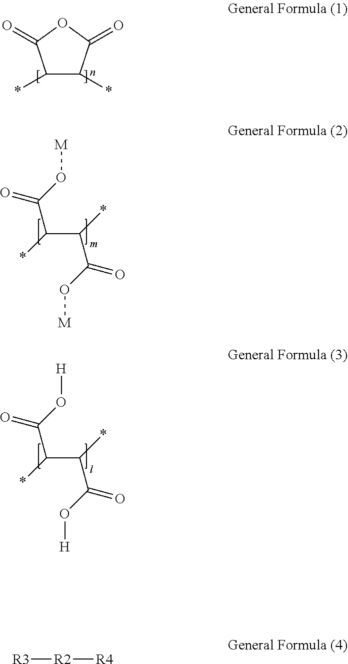

where, in general formulas (1) to (4), * represents a bonding site with an adjacent main chain structural unit, R2 represents at least one of polyurethane, polyester, polyethylene oxide, polypropylene oxide, poloxamer, polycarbonate, silicone, polybutadiene, or hydrogenated polybutadiene butane, R3 and R4 each independently represent a hydroxyl group or an amino group, M represents an ammonium salt, and n, m, and l each independently represent an integer from 2 to 500.

A fourteenth aspect is the electrode according to the twelfth or thirteenth aspect, wherein
the resin including fluorine atoms includes:
a fluororesin including PVDF-HFP; and
an acrylic resin.

A fifteenth aspect is the electrode according to the fourteenth aspect, wherein
the fluororesin and the acrylic resin each include an interpenetrated polymer network structure,
the fluororesin accounts for 65% by mass or more of the resin including fluorine atoms,
the acrylic resin accounts for 35% by mass or less of the resin including fluorine atoms, and
the crosslinked resin is unevenly distributed on a surface of the insulating layer.

A sixteenth aspect is the electrode according any one of the twelfth to fifteenth aspects, wherein the crosslinked resin is unevenly distributed on a surface of the insulating layer.

A seventeenth aspect is the electrode according to any one of the twelfth to sixteenth aspects, wherein
the insulating inorganic particles comprise α-alumina or boehmite.

An eighteenth aspect is a method for producing an electrode, the method including:
forming an insulating layer, the forming including:
applying, to a substrate and an electrode composite layer provided on a portion of the substrate, the insulating layer-forming liquid composition according to any one of the first to eleventh aspects to cover an interface portion between a substrate-exposed portion, in which the substrate is exposed, and the electrode composite layer.

A nineteenth aspect is an electrochemical element including the electrode according to any one of the twelfth to seventeenth aspects.

A twentieth aspect is a separator including:
a separator substrate; and
an insulating layer on the separator substrate; the insulating layer including:
   insulating inorganic particles;
   a resin including fluorine atoms; and
   a crosslinked resin including at least one of a structural unit represented by general formula (5) below or a structural unit represented by general formula (6) below:

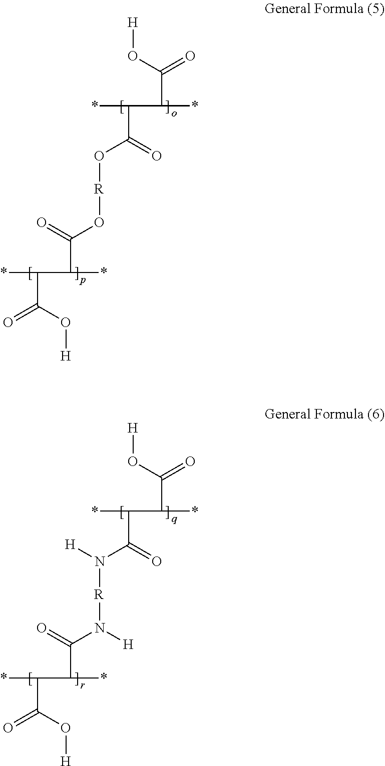

where, in general formulas (5) and (6), * represents a bonding site with an adjacent main chain structural unit, R represents a structure of at least one of polyurethane, polyester, polyethylene oxide, polypropylene oxide, poloxamer, polycarbonate, silicone, polybutadiene, or hydrogenated polybutadiene butane, and o, p, q, and r each independently represent an integer from 2 to 500.

A twenty-first aspect is the separator according to the twentieth aspect, wherein
the crosslinked resin is formed by a reaction between a resin including at least one of a structural unit represented by general formula (1) below, a structural unit represented by general formula (2) below, or a structural unit represented by general formula (3) below, and a resin including a structural unit represented by general formula (4) below.

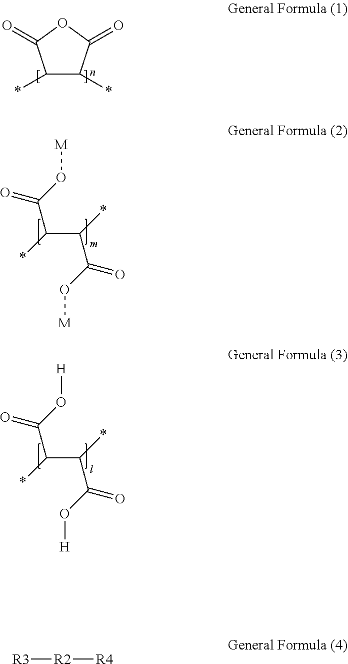

where, in general formulas (1) to (4), * represents a bonding site with an adjacent main chain structural unit, R2 represents at least one of polyurethane, polyester, polyethylene oxide, polypropylene oxide, poloxamer, polycarbonate, silicone, polybutadiene, or hydrogenated polybutadiene butane, R3 and R4 each independently represent a hydroxyl group or an amino group, M represents an ammonium salt, and n, m, and l each independently represent an integer from 2 to 500.

A twenty-second aspect is a method for producing a separator, the method including:
forming an insulating layer, the forming including:
applying the insulating layer-forming liquid composition according to any one of the first to eleventh aspects onto a separator substrate.

The insulating layer-forming liquid composition according to any one of the first to eleventh aspects, the electrode according to any one of the twelfth to seventeenth aspects, the production method for an electrode according to the eighteenth aspect, the electrochemical element according to the nineteenth aspect, the separator according to the twentieth or twenty-first aspect, and the production method of a separator according to the twenty-second aspect solve the conventional problems, and are capable of achieving the object of the present invention.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An insulating layer-forming liquid composition comprising:
insulating inorganic particles;
a resin including at least one of a structural unit represented by general formula (1) below, a structural unit represented by general formula (2) below, or a structural unit represented by general formula (3) below, in an amount of 0.1% by mass or more and 5% by mass or less of the insulating inorganic particles;
a resin including a structural unit represented by general formula (4) below, in an amount of 0.1% by mass or more and 5% by mass or less of the insulating inorganic particles; and
a resin including fluorine atoms, in an amount of 1% by mass or more and 8% by mass or less of the insulating inorganic particles: 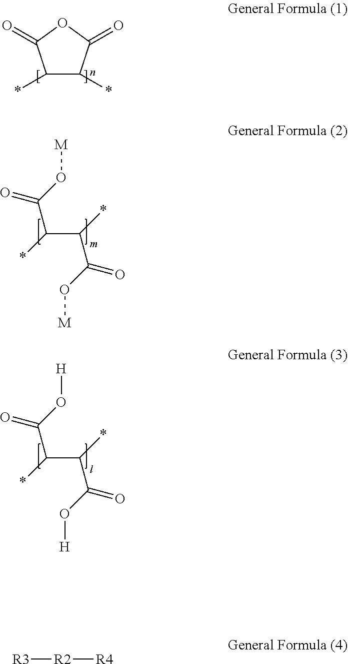
where, in general formulas (1) to (4), * represents a bonding site with an adjacent main chain structural unit, R2 represents at least one of polyurethane, polyester, polyethylene oxide, polypropylene oxide, poloxamer, polycarbonate, silicone, polybutadiene, or hydrogenated polybutadiene butane, R3 and R4 each independently represent a hydroxyl group or an amino group, M represents an ammonium salt, and n, m, and l each independently represent an integer from 2 to 500.

2. The insulating layer-forming liquid composition according to claim 1, wherein
the resin including at least one of the structural unit represented by general formula (1), the structural unit represented by general formula (2), or the structural unit represented by general formula (3), and the resin including the structural unit represented by general formula (4) independently dissolve in an electrolytic solvent.

3. The insulating layer-forming liquid composition according to claim 1, wherein
the resin including fluorine atoms independently disperses in an electrolytic solvent.

4. The insulating layer-forming liquid composition according to claim 1, wherein
the resin including fluorine atoms contains a fluororesin including at least one of PVDF, PVDF-HFP, PTFE, or PEVE.

5. The insulating layer-forming liquid composition according to claim 1, wherein
the resin including fluorine atoms contains a fluororesin including PVDF-HFP.

6. The insulating layer-forming liquid composition according to claim 4, wherein
the resin including fluorine atoms further contains an acrylic resin.

7. The insulating layer-forming liquid composition according to claim 6, wherein
the fluororesin and the acrylic resin each include an interpenetrated polymer network structure.

8. The insulating layer-forming liquid composition according to claim 6, wherein
the fluororesin accounts for 65% by mass or more of the resin including fluorine atoms, and
the acrylic resin accounts for 35% by mass or less of the resin including fluorine atoms.

9. The insulating layer-forming liquid composition according to claim 1, wherein
the amount of the resin including at least one of the structural unit represented by general formula (1), the structural unit represented by general formula (2), or the structural unit represented by general formula (3) is 1.5% by mass or more and 8% by mass or less of the insulating inorganic particles,
the amount of the resin including the structural unit represented by general formula (4) is 0.3% by mass or more and 4% by mass or less of the insulating inorganic particles, and
the amount of the resin including fluorine atoms is 1.5% by mass or more and 7% by mass or less of the insulating inorganic particles.

10. The insulating layer-forming liquid composition according to claim 1, wherein
R2 in general formula (4) represents a poloxamer.

11. The insulating layer-forming liquid composition according to claim 1, wherein
the insulating inorganic particles comprise α-alumina or boehmite.

12. An electrode comprising:
a substrate;
an electrode composite layer on a portion of the substrate; and
an insulating layer covering an interface portion between an exposed portion, in which the substrate is exposed, and the electrode composite layer, the insulating layer including:
insulating inorganic particles;
a resin including fluorine atoms; and
a crosslinked resin including at least one of a structural unit represented by general formula (5) below or a structural unit represented by general formula (6) below: 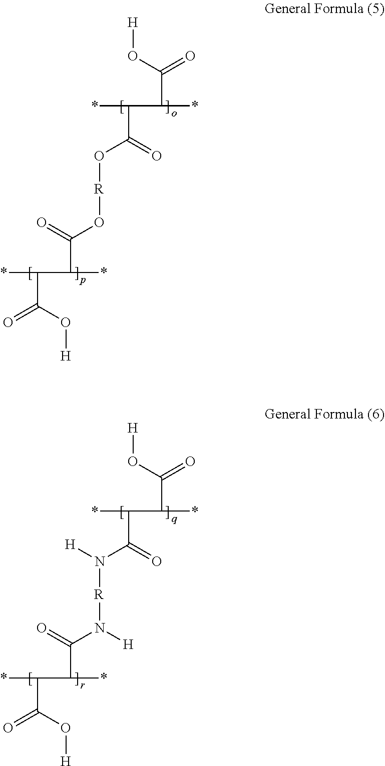
where, in general formulas (5) and (6), * represents a bonding site with an adjacent main chain structural unit, R represents a structure of at least one of polyurethane, polyester, polyethylene oxide, polypropylene oxide, poloxamer, polycarbonate, silicone, polybutadiene, or hydrogenated polybutadiene butane, and o, p, q, and r each independently represent an integer from 2 to 500.

13. The electrode according to claim 12, wherein
the crosslinked resin is formed by a reaction between a resin including at least one of a structural unit represented by general formula (1) below, a structural unit represented by general formula (2) below, or a structural unit represented by general formula (3) below, and a resin including a structural unit represented by general formula (4) below: 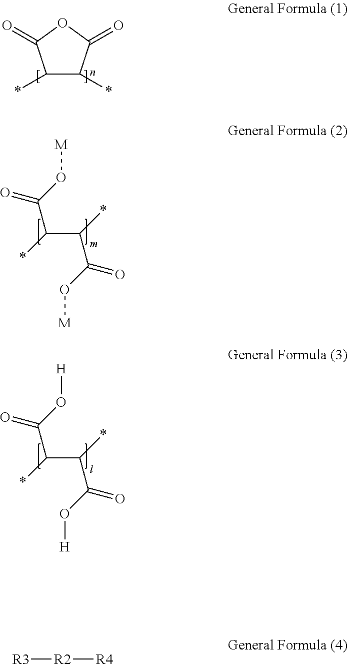
where, in general formulas (1) to (4), * represents a bonding site with an adjacent main chain structural unit, R2 represents at least one of polyurethane, polyester, polyethylene oxide, polypropylene oxide, poloxamer, polycarbonate, silicone, polybutadiene, or hydrogenated polybutadiene butane, R3 and R4 each independently represent a hydroxyl group or an amino group, M represents an ammonium salt, and n, m, and l each independently represent an integer from 2 to 500.

14. The electrode according to claim 12, wherein
the resin including fluorine atoms includes:
a fluororesin including PVDF-HFP; and
an acrylic resin.

15. The electrode according to claim 14, wherein
the fluororesin and the acrylic resin each include an interpenetrated polymer network structure,
the fluororesin accounts for 65% by mass or more of the resin including fluorine atoms,
the acrylic resin accounts for 35% by mass or less of the resin including fluorine atoms, and
the crosslinked resin is unevenly distributed on a surface of the insulating layer.

16. The electrode according to claim 12, wherein the crosslinked resin is unevenly distributed on a surface of the insulating layer.

17. A method for producing an electrode, the method comprising:
forming an insulating layer, the forming including:
applying, to a substrate and an electrode composite layer on a portion of the substrate, the insulating layer-forming liquid composition according to claim 1 to cover an interface portion between a substrate-exposed portion, in which the substrate is exposed, and the electrode composite layer.

18. A separator comprising:
a separator substrate; and
an insulating layer on the separator substrate, the insulating layer including:
insulating inorganic particles;
a resin including fluorine atoms; and
a crosslinked resin including at least one of a structural unit represented by general formula (5) below or a structural unit represented by general formula (6) below: 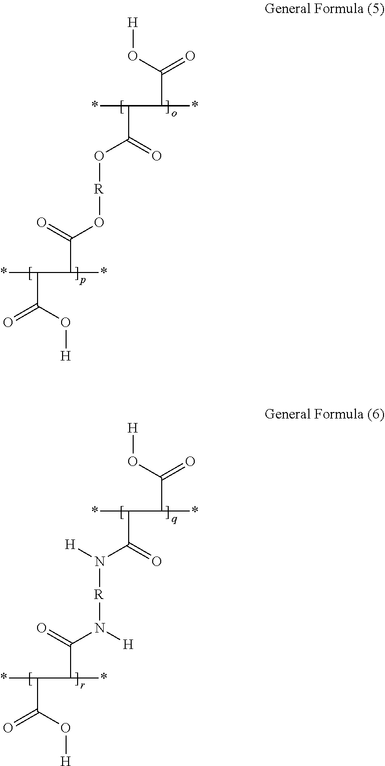
where, in general formulas (5) and (6), * represents a bonding site with an adjacent main chain structural unit, R represents a structure of at least one of polyurethane, polyester, polyethylene oxide, polypropylene oxide, poloxamer, polycarbonate, silicone, polybutadiene, or hydrogenated polybutadiene butane, and o, p, q, and r each independently represent an integer from 2 to 500.

19. The separator according to claim 18, wherein
the crosslinked resin is formed by a reaction between a resin including at least one of a structural unit represented by general formula (1) below, a structural unit represented by general formula (2) below, or a structural unit represented by general formula (3) below, and a resin including a structural unit represented by general formula (4) below: 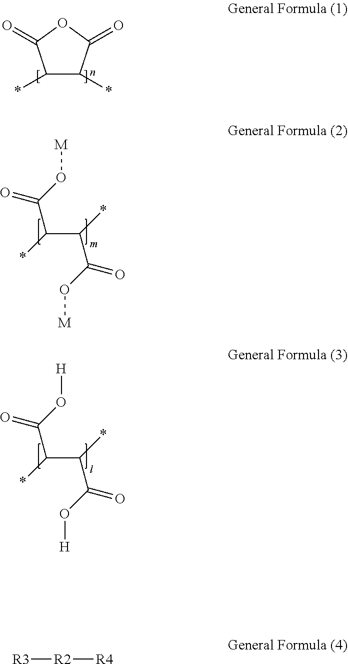
where, in general formulas (1) to (4), * represents a bonding site with an adjacent main chain structural unit, R2 represents at least one of polyurethane, polyester, polyethylene oxide, polypropylene oxide, poloxamer, polycarbonate, silicone, polybutadiene, or hydrogenated polybutadiene butane, R3 and R4 each independently represent a hydroxyl group or an amino group, M represents an ammonium salt, and n, m, and l each independently represent an integer from 2 to 500.

20. A method for producing a separator, the method comprising:
forming an insulating layer, the forming including:
applying the insulating layer-forming liquid composition according to claim 1 onto a separator substrate.
